(19) United States
(12) Patent Application Publication
(10) Pub. No.: US 2018/0290297 A1
(43) Pub. Date: Oct. 11, 2018

(54) SYSTEM AND METHOD FOR AUTONOMOUSLY TEACHING WORKING POINTS IN A ROBOTIC DISK TEST APPARATUS

(71) Applicant: Verselus, LLC, Pleasanton, CA (US)

(72) Inventor: Neil BRUMBERGER, Saratoga, CA (US)

(21) Appl. No.: 15/763,686

(22) PCT Filed: Sep. 30, 2016
(86) PCT No.: PCT/US2016/054667

§ 371 Date: Mar. 27, 2018

Related U.S. Application Data
(60) Provisional application No. 62/236,611, filed on Oct. 2, 2015.
(60) Provisional application No. 62/265,032, filed on Dec. 9, 2015.

(51) Int. Cl. B25J 9/16; G05B 19/418; B25J 17/00

(52) U.S. Cl. CPC B25J 9/163; G05B 2219/36448; B25J 17/00; G05B 19/4189

(57) ABSTRACT

A system is disclosed for autonomously teaching one or more working points in an apparatus configured to process disks during manufacture. The apparatus including an end effector with a gripper for holding a disk and a robotic unit configured to move the end effector between working points throughout the apparatus. The system comprises one or more servers configured to execute method steps. The steps comprise leveling the gripper in a first position with respect to a first fixture; determining a location of the gripper in the first position, and determining a location of a center of the disk in the first position with respect to the first fixture.

### CROSS REFERENCE TO RELATED APPLICATIONS

This application claims priority to U.S. provisional application No. 62/265,032, filed on Dec. 9, 2015, entitled “SYSTEM AND METHOD FOR AUTONOMOUSLY TEACHING WORKING POINTS IN A ROBOTIC DISK TEST APPARATUS” and U.S. provisional application No. 62/236,611, filed on Oct. 2, 2015 entitled “SYSTEM AND METHOD FOR AUTONOMOUSLY TEACHING WORKING POINTS IN A ROBOTIC DISK TEST APPARATUS” which are incorporated by reference herein.

### FIELD OF THE INVENTION

The present invention relates to a system and method for autonomously teaching working points in a robotic disk test apparatus.

### BACKGROUND OF THE INVENTION

The industry has developed a variety of robot mounted and controlled end effectors for the purpose of handling and transporting objects such as rigid disks (e.g., media, substrates, wafers and other round flat objects) in the various parts of the manufacturing process. In a majority of manufacturing process steps, the robot/end effector transports the disks to various locations within a manufacturing environment such as a workcell. These locations include one or more working points where the disks are tested or stored. A table typically supports the working point structure as known to those skilled in the art.

In this testing environment, a human technician or operator (user) manually moves the robot and its attached end effector to each of the desired locations and manually adjusts and records the precise location for each required pick and place operation. Unfortunately, manual intervention introduces significant problems. First, each workcell suffers significant down-time and loss of productivity while a human takes control of the robot and guides it to each point. Second, human error introduced during the point-teaching process is major cause of equipment collisions, damage and repair.

### SUMMARY OF THE INVENTION

Embodiments of a system and method for autonomously teaching working points in a robotic disk test apparatus are disclosed.

In accordance with an embodiment of this disclosure, a system is disclosed for autonomously teaching one or more working points in an apparatus configured to process disks during manufacture, the apparatus including an end effector with a gripper for holding a disk and a robotic unit configured to move the end effector between working points throughout the apparatus, the system comprising one or more servers configured to execute method steps, the method steps comprising: leveling the gripper in a first position with respect to a first fixture; determining a location of the gripper in the first position; and determining a location of a center of the disk in the first position with respect to the first fixture.

In accordance with another embodiment of this disclosure, a system is disclosed for autonomously teaching one or more working points in an apparatus configured to process disks during manufacture, the apparatus including an end effector with a first gripper for holding a disk and a robotic unit configured to move the end effector between working points, the system comprising one or more servers comprising one or more processors and memory coupled to the one or more processors, the memory storing computer executable instructions to be executed by the one or more processors to cause the apparatus to: level the gripper in a first position with respect to a first fixture; move the gripper to a plurality of positions with respect to the first fixture; sense the gripper at the plurality of positions to determine one or more orientations of the disk with respect to the first fixture; and sense the disk at the plurality of positions to determine a center of the disk.

In accordance with yet another embodiment of the disclosure, a method is disclosed for autonomously teaching one or more working points in an apparatus configured to process disks during manufacture, the apparatus including an end effector with a first gripper for holding a disk and a robotic unit configured to move the end effector between working points, the method comprising the steps of: leveling the gripper to a first position with respect to a first fixture; moving the gripper to a plurality of positions with respect to the first fixture; sensing the gripper at the plurality of positions to determine one or more orientations of the disk with respect to the first fixture; and sensing the disk at the plurality of positions to determine a center of the disk.

In accordance with yet another embodiment of the disclosure, a system is disclosed for autonomously teaching one or more working points in an apparatus configured to process a disk during manufacture, the apparatus comprising: (a) first and second working points upon which the disk may be tested or stored: (b) an end effector with a gripper for holding a disk and a robotic unit configured to move the end effector between the first and second working points; (c) a fixture mounted to the third working point and including a plurality of posts; and (d) a plurality of sensors supported by the plurality of posts, the plurality of sensors configured to sense the location of the disk with respect to the fixture as the disk moves with the gripper.

In accordance with yet another embodiment of the disclosure, a fixture is disclosed for use in calibrating a location of disk as it is moved between working points within an apparatus for testing or storing the disk during manufacture, the apparatus including an end effector and gripper supported by the end effector for holding the disk as it is moved between the working points, the fixture comprising: a first wall fixed to a working point within the apparatus, the first wall including a plurality of posts; a plurality of sensors supported by the plurality of posts, the plurality of sensors configured to sense the disk in a plurality of positions with respect to the first wall to establish a location of the disk with respect to the first wall.

In accordance with yet another embodiment of the disclosure, a fixture is disclosed for use in calibrating a location of disk as it is moved between working points within an apparatus for testing or storing the disk during manufacture, the apparatus including an end effector and gripper supported by the end effector for holding the disk as it is moved between the working points, the fixture comprising: a first wall fixed to a working point within the apparatus, the first wall configured to sense the disk in a plurality of positions with respect to the first wall to establish a location of the disk with respect to the first wall.

In accordance with another embodiment of the disclosure, a method is disclosed for autonomously teaching one or more working points in an apparatus configured to process disks during manufacture, the apparatus including an end effector with a gripper for holding a disk and a robotic unit configured to move the end effector between working points, the method comprising the steps of: moving the gripper to a plurality of positions with respect to a fixture; sensing a location of the gripper at the plurality of positions to determine one or more orientations of the gripper with respect to the fixture; and calibrating the location of the gripper with respect to the fixture based on orientations of the gripper with respect to the fixture.

### BRIEF DESCRIPTION OF THE DRAWINGS

Embodiments of the present disclosure are described herein with reference to the drawing figures.

FIG. 1 depicts a perspective view of example system in which the method for autonomously teaching working points in robotic disk test apparatus operates.

FIGS. 2A-2D depict high-level example method steps for autonomously teaching working points in a robotic disk test apparatus.

FIGS. 3A-3E depict detailed-level example method steps for autonomously teaching working points in a robotic disk test apparatus.

FIGS. 4-10 depict various views of a horizontal fixed reference frame for use with the method of FIGS. 2A-2D.

FIGS. 11-16 depict various views of a vertical fixed reference frame for use with the method of FIGS. 2A-2D.

FIG. 17 depicts a horizontal working point reference frame at working point in the robotic disk test apparatus.

FIG. 18 depicts is an extension for supporting the horizontal working point reference frame in FIG. 17.

FIGS. 19-22 depict various views of the horizontal working point reference frame in FIG. 17.

FIGS. 23-26 depict various views of a vertical working point reference frame in the robotic disk test apparatus.

FIG. 27 depicts a perspective view of another example system in which the method for autonomously teaching working points in robotic disk test apparatus operates.

FIGS. 28A-28E depict another high-level example method steps for autonomously teaching working points in a robotic disk test apparatus.

FIGS. 29A-29G depict another detailed-level example method steps for autonomously teaching working points in a robotic disk test apparatus.

FIGS. 30-41 depict various views of a fixed reference frame for use with the method of FIGS. 28A-28E.

FIG. 42 depicts a horizontal working point (on a test machine) in the robotic disk test apparatus.

FIGS. 43-48 depict various views of the horizontal working point in FIG. 42.

FIG. 49 depicts a vertical working point in the robotic disk test apparatus.

FIGS. 50-52 depict various views of the vertical working point in FIG. 49.

### DETAILED DESCRIPTION OF THE INVENTION

Embodiments of the present disclosure are described herein with reference to the drawing figures.

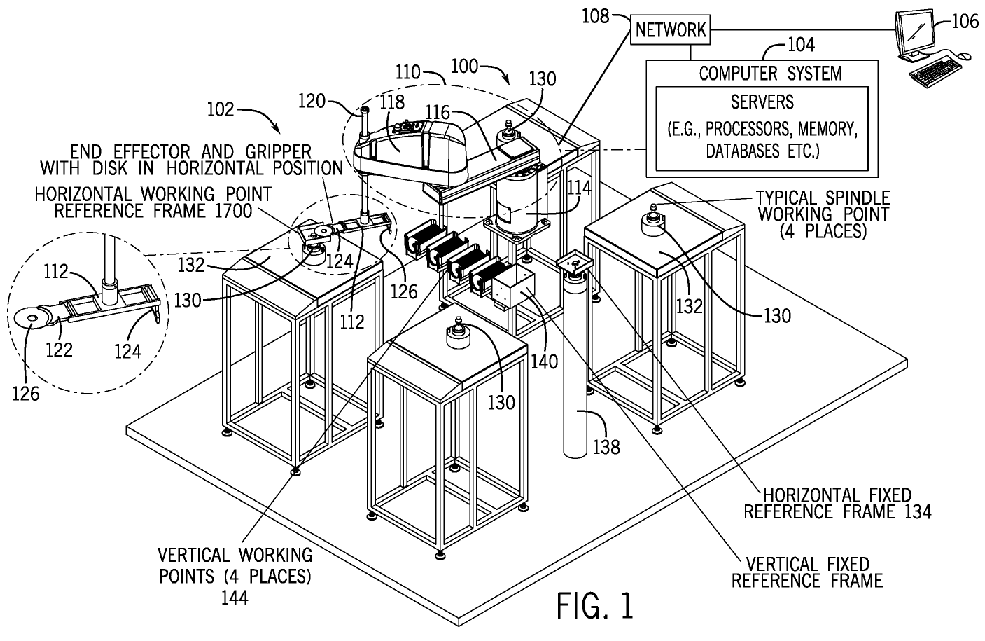

FIG. 1 depicts a perspective view of example system 100 in which the method for autonomously teaching working points in robotic disk test apparatus 102 operates. Robot disk test apparatus 102 is a workcell (hereinafter workcell 102) that is configured for processing disks during manufacture. That is, workcell 102 is designed to handle or transport the disks to and from several working points (described below) within workcell 102. Workcell 102 is described in more detail below. As known to those skilled in the art, disks are storage mechanisms where data are recorded (e.g., hard disk drives or HDD). Disks may also be referred to as disk media, media or substrates.

The method for autonomously teaching working points in workcell 102 may be employed during initial setup and commissioning of apparatus 102, repair or replacement of one or more components of workcell 102 which changes disk pick or place locations and point drift in which one or more components in apparatus 102 suffers wear or degradation which changes one or more disk pick or place locations.

System 100 includes robotic disk test workcell 102, computer system 104 and client 106. Computer system 104 and client 106 may communicate with workcell 102 components directly (line) or via network 106 (dashed line). This is described in more detail below. Network 108 may be a LAN and/or Internet as known to those skilled in the art. The communication may be wired or wireless via WIFI or other wireless protocol.

Computer system 104 comprises a robot control computer and a cell control computer. The robot control computer is typically provided with a commercially available robot unit (described below) and it is designed to communicate with the robot unit (described below) directly or over network 108 (as described above) to control motion and manipulate the robot unit for tasks as known to those skilled in the art. The robot control computer may be a dedicated box or a server incorporating a processor, memory, storage, operating system (e.g., Microsoft Windows, Unix or QNX), databases, interfaces and other components similar to a computer as known to those skilled in the art. The cell control computer is a high level computer that may be employed for controlling the robot control computer and/or performing other operations as known to those skilled in the art. The cell control computer comprises one or one or more servers, each of which typically includes one or more processors, memory, storage, databases, video cards, interfaces, operating systems such as Microsoft Windows, Apple OS, Linux etc. and other components as known to those skilled in the art. The method for autonomously teaching working points in a robotic disk test workcell 102 may be implemented by the robot control computer and/or the cell control unit. For simplicity, computer system 104 will be used hereinafter to refer to robot control computer and/or the cell control computer.

Client 106 may be a personal computer and a monitor or mobile devices such as smartphones, cellular telephones, tablets, PDAs, or other devices equipped with industry standard (e.g., HTML, HTTP etc.) browsers or any other application having wired (e.g., Ethernet) or wireless access (e.g., cellular, Bluetooth, RF, WIFI such as IEEE 802.11b etc.) via networking (e.g., TCP/IP) to nearby and/or remote computers, peripherals, and appliances, etc. TCP/IP (transfer control protocol/Internet protocol) is the most common means of communication today between clients or between clients and systems (servers), each client having an internal TCP/IP/hardware protocol stack, where the “hardware” portion of the protocol stack could be Ethernet, Token Ring, Bluetooth, IEEE 802.11b, or whatever software protocol is needed to facilitate the transfer of IP packets over a local area network. Each client typically includes a processor, memory, storage, interface, operating systems (e.g., Microsoft Windows, Apple OS, Linux etc. for the personal computer or iOS, Android etc. for a mobile device) and other components as known to those skilled in the art. Client 106 also includes a display.

A user may control the operation of a robot unit 110 (described below) of workcell 102 via client 106 and computer system 104 to move a disk to and from various points in workcell 102. The method for autonomously teaching working points in a robotic disk test workcell 102 is implemented by computer system 104.

Workcell 102 comprises robot unit 110 that is configured to move end effector 112 to various locations around workcell 102. In brief, robot unit 110 includes fixed base 114, (rotary drive shaft within base 114), upper drive arm 116, outer drive arm 118 and drive rod 120 (also known as a quill). Base 114 is supported by a stand or other framework as known to those skilled in the art (not shown). Upper drive arm 116, at one end thereof, is mounted to rotary drive shaft (at the shoulder of base 116) to enable upper drive arm 116 to move within a large rotation as known to those skilled in the art. Outer drive arm 118 is mounted to the other end of upper drive arm 116. Outer drive arm 118 is configured to move within a large rotation with respect to drive arm 116 as known to those skilled in the art. Drive rod 120 is mounted within a bore or channel in outer drive arm 118 and configured to rotate (roll axis) as well as move vertically (Z axis) with respect to outer drive arm 118 to move end effector 112 in multiple positions and directions. (The measurement from the center of rod 114 and center of disk 126 is known as describe in more detail below.) Robot unit 110 is typically a commercially available robot known as a selective compliance assembly robot arm (SCARA) as known to those skilled in the art. However, those skilled in the art know that any robot unit may be employed to achieve desired results.

As indicated above, workcell 102 further comprises end effector 112 that is used to manipulate and control movement of grippers 122, 124 (e.g., paddle or any other mechanical grasping mechanism) as known to those skilled in the art. Grippers 122, 124 are attached at the distal ends of end effector 112 and are each adapted to pivot from a horizontal position to a vertical (pitch down) position. As shown in FIG. 1, gripper 122 extends in a horizontal position (with disk) and gripper 124 extends in a vertical (pitch down) position. As discussed below, end effector may include a pitch axis controller (not shown) as known to those skilled in the art. For purposes of this disclosure, any commercially end effector may be employed in workcell 102. Examples include Vacuum End-Effector previously marketed and sold by Applied Robotic Technologies, Inc.

As indicated above, end effector 112 includes grippers 122 124. Grippers 122, 124 are each configured to grasp a disk so it can be transported to various points in workcell 102 as known to those skilled in the art. Grippers 122, 124 each comprise opposing gripper elements adapted to grasp an individual disk as known to those skilled in the art. Vacuum functionality may also be employed to ensure that the disk does not dislodge from the gripper itself as known to those skilled in the art. For purposes of implementing the method for autonomously teaching working points in a robotic disk test workcell 102, any gripper ((e.g., mechanical or vacuum, including paddles or other grasping (holding) mechanisms) known to those skilled in the art may be employed. Examples include Vacuum Paddle previously marketed and sold by Applied Robotic Technologies, Inc. Each gripper 122, 124 includes one or more sensors as known to those skilled in the art (and described below).

Workcell 102 further comprises several horizontal working points 130 at various locations in the workcell 102 space. Several tables 132 typically support the horizontal working point 130 structures as known to those skilled in the art. In operation, disks are processed and tested at these horizontal working points 130 as known to those skilled in the art. In brief, a typical horizontal working point 130 is a spindle that is sized to snugly fit within a hole in disk 126 for subsequent testing. In the embodiment shown in FIG. 1, there are four horizontal working points 130. However, those skilled in the art know that workcell 102 may incorporate any number of working points (locations) for disk transport and testing.

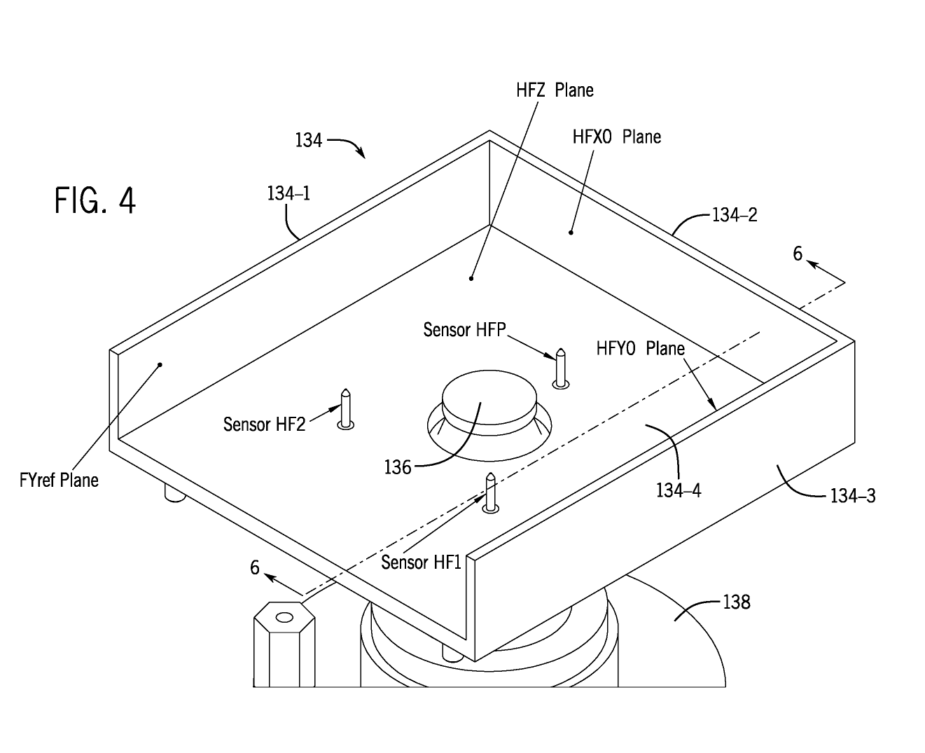

Workcell 102 further comprises horizontal fixed reference frame 134 that is mounted (i.e., fixed) on model spindle 136 positioned in a horizontal plane. As described in more detail below, horizontal fixed reference frame 134 is used for implementing the method for autonomously teaching points in robotic disk test workcell 102 disclosed herein. The model spindle 136 is mounted to pole 138 at a working level. Horizontal fixed reference frame 134 is shaped similar to a box (in part) in which three sections or sides 134-1, 134-2, 134-3 (FIG. 4) are molded or mounted to (or manufactured as an integral component) the edges of one another perpendicularly to define upper side boundaries of the box shape. Sides 134-1, 134-2, 134-3 are also mounted or molded perpendicularly to the edges of horizontal side 134-4. A fourth edge, however, is unencumbered to enable end effector 112 to position disk 126 to extend within the box (unimpeded) as described in more detail below with respect to FIG. 4.

The horizontal side 134-4 includes an opening or hole drilled out of the bottom face to enable a spindle to protrude therethrough. Horizontal fixed reference frame 134 is designed so that the distances from each of the three sides 134-1, 134-2, and 134-3 (planes) to the hole drilled out of the bottom face are precisely known. The spindle is sized to fit snugly within a hole in disk 126. Sides 134-1, 134-2, 134-3, and 134-4 (FIG. 4) together act as a boundary and as a method of detection for a disk 126 during calibration as described in more detail below. (Method of detection could be accomplished using contact detection as described herein or touch sensitive panels, proximity sensors, light curtains or similar means.) Horizontal fixed reference frame 134 also includes several sensors (and position as described in detail below) that extend through openings in side 134-4. These sensors are configured to sense the movement and position of disk 126. The sensors are connected (wired) to computer system 104 (directly or via network 108) through a commercially available digital I/O board as known to those skilled in the art. In the example shown in FIG. 1 (and other figures), there are three sensors, but those skilled in the art know that any number of sensors may be used to achieve the desired results. The sensors communicate with computer system 104 to transmit sensor signals as known to those skilled in the art.

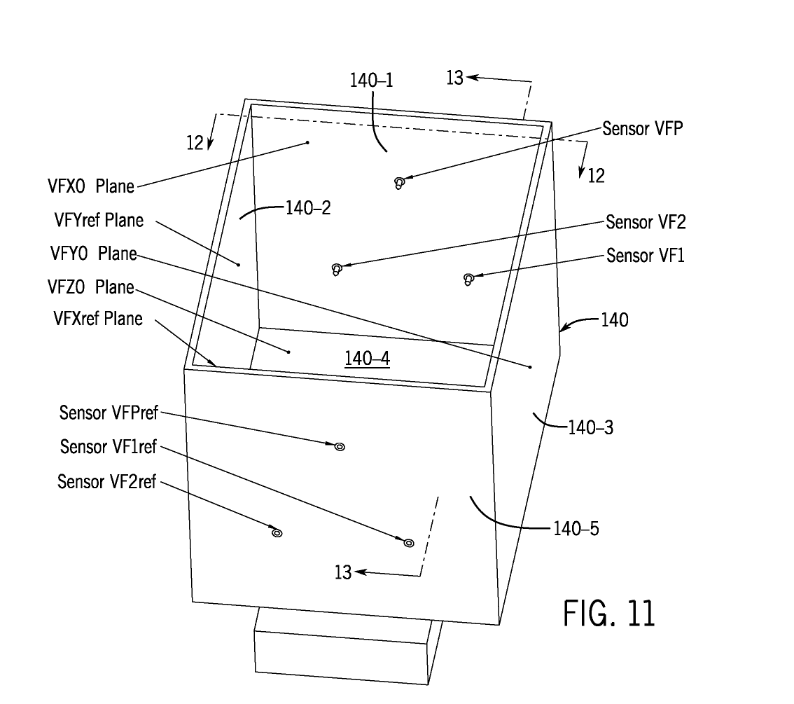

As seen in FIG. 1, workcell 102 further includes vertical fixed reference frame 140 that is mounted to a table or frame below robot unit 110. Frame 140 is shaped as a cassette box used as a vertical fixed reference frame to calibrate end effector 112 with disk in a vertical position (plane). Vertical fixed reference frame 140 includes five sides 140-1, 140-2, 140-3, 140-4 and 140-5 (FIG. 11) with several sensors (as described in detail below) on sides 140-1, 140-5 that extend through openings in these sides. These sensors are configured to sense the movement and position of a disk. The sensors are connected (wired) to computer system 104 (directly or via network 108) through a commercially available digital I/O board or other means as known to those skilled in the art. In the example shown in FIG. 1 (and other figures), there are three sensors per side, but those skilled in the art know that any number of sensors may be used to achieve the desired results. The sensors communicate with computer system 104 to transmit sensor signals as known to those skilled in the art. This is described in more detail below.

Workcell 102 further includes vertical working points 144 at various locations in the workcell 102 space. Vertical working points 144 are typically cassettes, each storing one or more disks as known to those skilled in the art. In the example system shown, these vertical working points 144 are positioned adjacent to vertical fixed reference frame 140 and fixed to a stand or other structure (not shown) as known those skilled in the art. In operation, a disk is retrieved from one of the vertical working points 144 (cassettes), processed and tested and returned to the same or different working point 144 (cassette). In the example, there are four working points 144. However, those skilled in the art know that workcell 102 may incorporate any number of vertical working points (locations) for disk storage and retrieval.

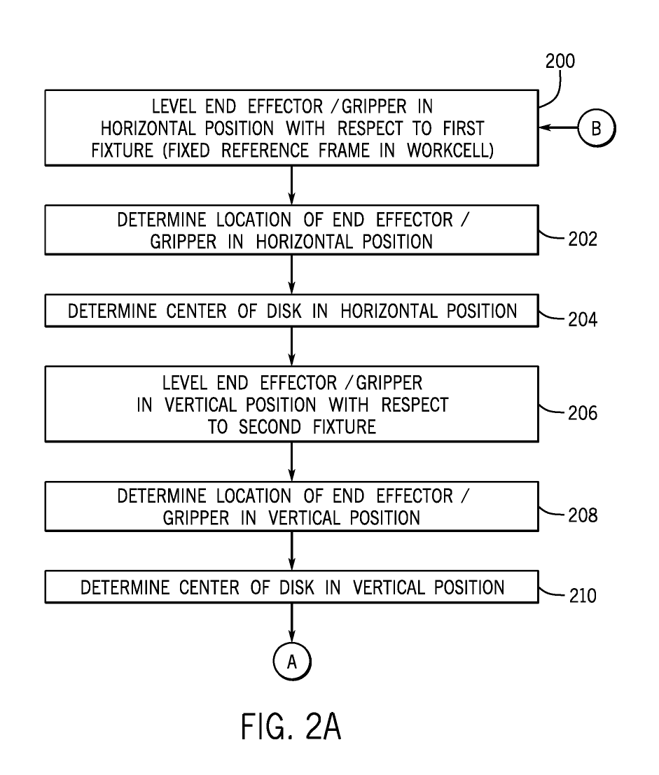

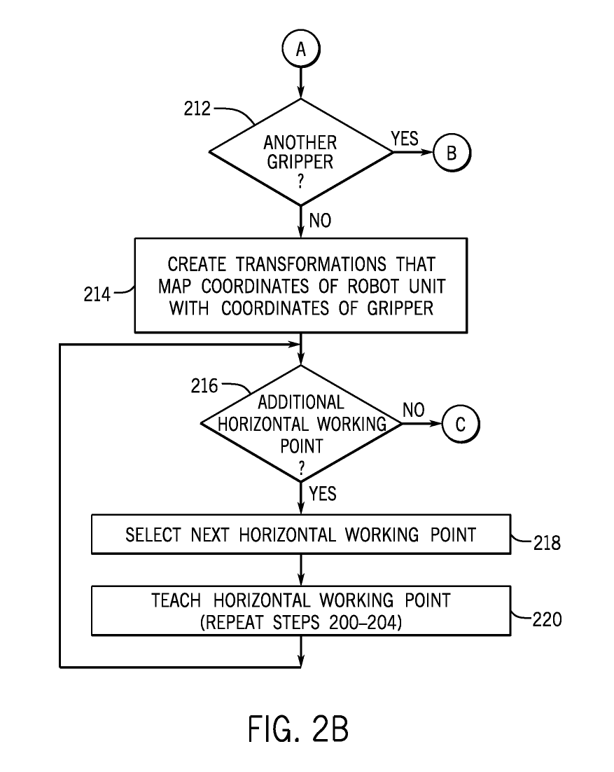

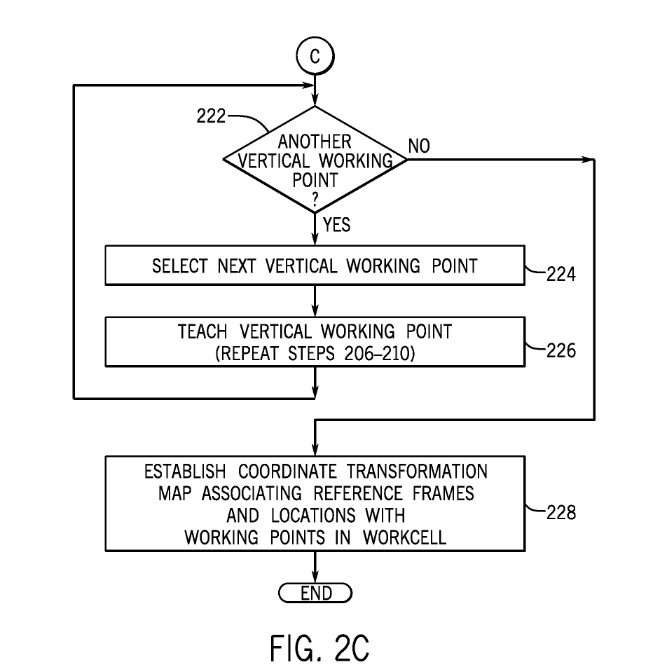

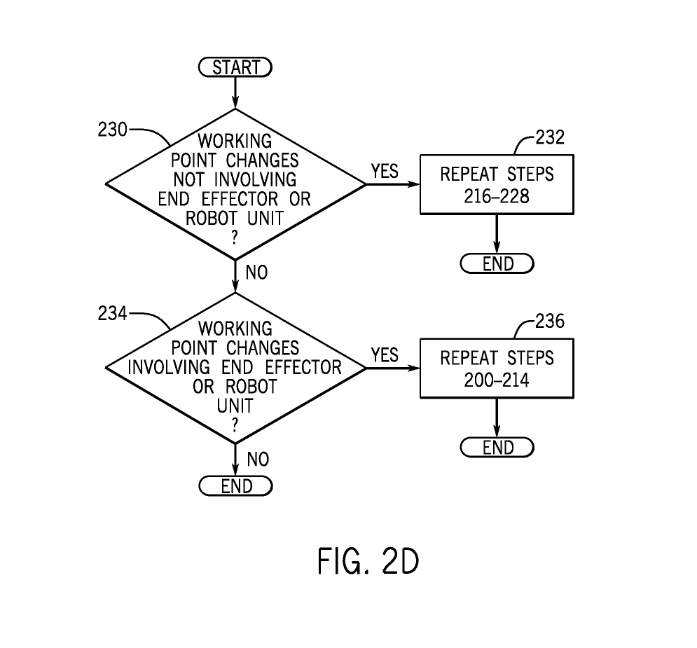

Reference is made to FIGS. 2A-2D. FIGS. 2A-2D depict high-level example method steps for autonomously teaching working points in a robotic disk test apparatus 102.

Execution begins at step 200 wherein end effector 112 (gripper 122) in a horizontal position with respect to a first fixture is leveled (true-up). The first fixture is fixed frame of reference 134 as shown in FIG. 1. In short, end effector 112 is trued up for disk 126 in the horizontal position. The roll, pitch and yaw angles of disk in end effector 112 (gripper 122) are made plumb and level.

Execution proceeds to step 202 wherein the location of end effector 112 (gripper 122) in the horizontal position is determined. In short, the true X, Y and Z axes for disk 126 (gripper 122) in the horizontal plane are uncovered.

Execution proceeds to step 204 wherein the center of disk 126 in the horizontal position is determined. At this juncture in the method, robot unit 110 is directed to “feel around” for the right, left and front sensors (or planes created by these sensors). As indicated above, horizontal (fixed) reference frame 134 is designed so that the distances from each of the three sensors (i.e., vertical planes) to the hole drilled out of the bottom face are precisely known. With everything plumb, level and aligned, feeling for the three sensors (i.e., vertical planes) enables robot unit 110 to precisely calculate the exact center of the hole in the fixture and the exact center of disk 126 in end effector 112.

In sum, steps 200-204 trues up end effector 112, has the robot unit 110 “feel around” until it knows the directions (i.e., orientations) and origins of the X, Y and Z axes and then finds the exact center of disk 126 held by end effector 112 and disk's 126 precise location relative to a reference spindle in workcell 102.

Execution proceeds to step 206 wherein end effector 112 (gripper 122) is leveled in the vertical position with respect to a second fixed figure. The second fixture is vertical fixed reference frame 140. In short, the true X, Y and Z axes for disk 126 in the vertical, pitch down position are uncovered. That is, this step trues up disk 126 in a pitch down position in end effector 112. This makes sure the face of disk 126 is pointing in the correct direction and is truly vertical. (As described in more detail below, robot unit 110 moves disk 126 around until it is parallel to certain sensors within vertical fixed reference frame 140.)

Execution proceeds to step 208 wherein the location of end effector 112 (gripper 122) in the vertical position is determined. In short, the true X, Y and Z axes for disk 126 in the vertical, pitch down position are uncovered.

Execution proceeds to step 210 wherein the center of disk 126 in the vertical position is determined (similar to step 204). In this step, the coordinates of the disk are established in the vertical plane.

Execution then proceeds to decision step 212 wherein it is determined if there is another gripper (with disk), i.e., a second gripper 124. At this stage, second gripper 124 of end effector 112 requires calibration similar to the first gripper. If the answer is yes, execution returns to step 200. If no, execution proceeds to step 214 wherein transformations are created that map coordinates of robot unit 110 with the coordinates of grippers 122, 124. That is, the step creates the coordinate transformation that relates to the coordinates in the native robot unit 110 of the coordinate system to the coordinates of the reference frames for grippers 122 and 124 created in the prior steps.

Execution proceeds to decision step 216 wherein it is determined if there are any additional horizontal working points 130. In this respect, a first horizontal working point 130 is selected at step 218 since system 100 has completed calibration for the horizontal fixed reference frame 134.

Then execution proceeds to step 220 wherein end effector 112 in a horizontal position at the first working point 130 is taught. This is a repeat of steps 200-204 with respect to a horizontal working point reference frame 1700 (discussed in detail below) that is attached over the first working point 130. (This reference frame may be either the same as horizontal fixed reference frame 134 or a different one that has the exact same dimensions. The application and attachment are described in more detail below.) The only difference is that if a spindle at a working point 130 lies outside the tolerances established during the design of workcell 102, no adjustment is made to end effector 112. Rather, a user is notified that the working point is out of tolerance and the corresponding spindle requires adjustment, either in its X, Y or Z coordinates or in its angular orientations.

Execution returns to step 216 where it is determined if there are any additional horizontal working points 130. If there are, steps 218 and 220 are repeated.

If there are no more horizontal working points to be taught, execution proceeds to step 222 it is determined if there are any vertical working points to be taught. In this respect, a first vertical working point 144 is selected at step 224.

Execution proceeds to step 226 wherein end effector 112 in a vertical, pitch down position is taught. Steps 206-210 are repeated at vertical working point 144 where a disk is in the pitch down position. Again, if a working point lies outside the tolerances established during the design of workcell 102, no adjustment is made. Rather, a user is notified that an adjustment to the cassette location or orientation is required. Execution then returns to decision step 222 once step 226 has been completed. These steps will be repeated until there are no more vertical working points 144.

Now, if there are no additional vertical working points 144, execution proceeds to step 228 wherein a coordinate transformation map (table) is established that associates the fixed reference frames and locations with working points 130 and 144 in workcell 102. That is, coordinate system transformations between the reference frames/locations established in step 214 to various working points 130 and 144 coordinates established in steps 220 and 226. Robot unit 110 knows the exact six degree of freedom vectors (i.e., X, Y, Z, theta, pitch and roll) between each working point 130 and 144 location and its corresponding reference frame location.

This completes the initial setup of workcell 102 in which all reference frame 134, 140 locations and all working point 130, 144 locations are taught.

During the course of operation or maintenance of workcell 102, one or more locations or calibrations used in workcell 102 may change. If so, the next steps (in FIG. 2D) are executed as follows. Execution begins at decision step 230 wherein it is determined if one or more working point locations changes, but not to end effector 112 or robot unit 110. If yes, then execution proceeds to step 232 wherein steps 216-228 are repeated and then execution ends. If those changes do not involve changes to either end effector 112 or robot unit 110, then execution proceeds to step 234 where it is determined if something on end effector 112 or robot unit 110 has changed. If yes, execution proceeds to step 236 wherein steps 200-214 are repeated. That is, if something on robot unit 110 or end effector 112 changes, steps 200-214 are repeated. During step 214, robot unit 110 compares the new coordinate transformations to the initial transformations and establishes a set of offsets. The differences represent what changed or moved on robot unit 110 or end effector 112. Since the actual reference locations and working locations did not move, the new offsets are used to update native robot unit 110 coordinates for each of the working points 130 and 144, thus eliminating the need to re-teach every working point. Then execution ends.

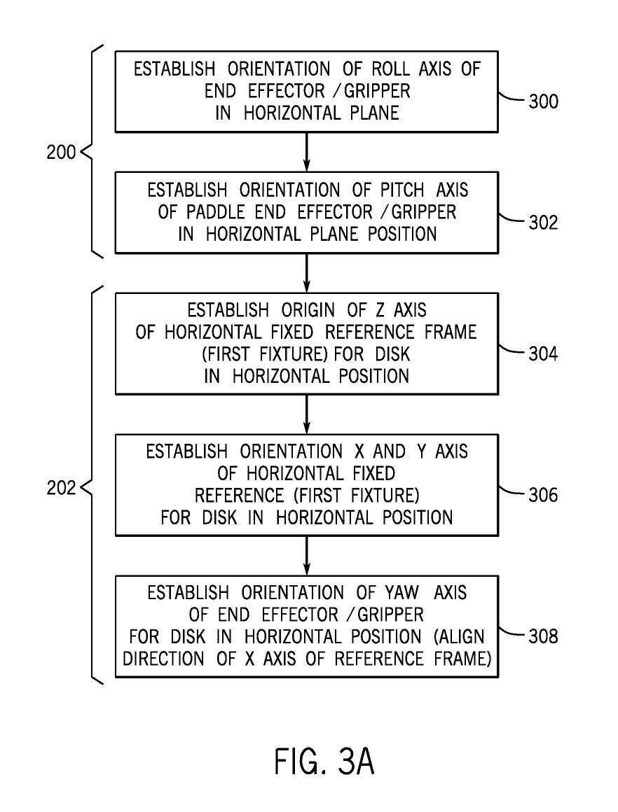

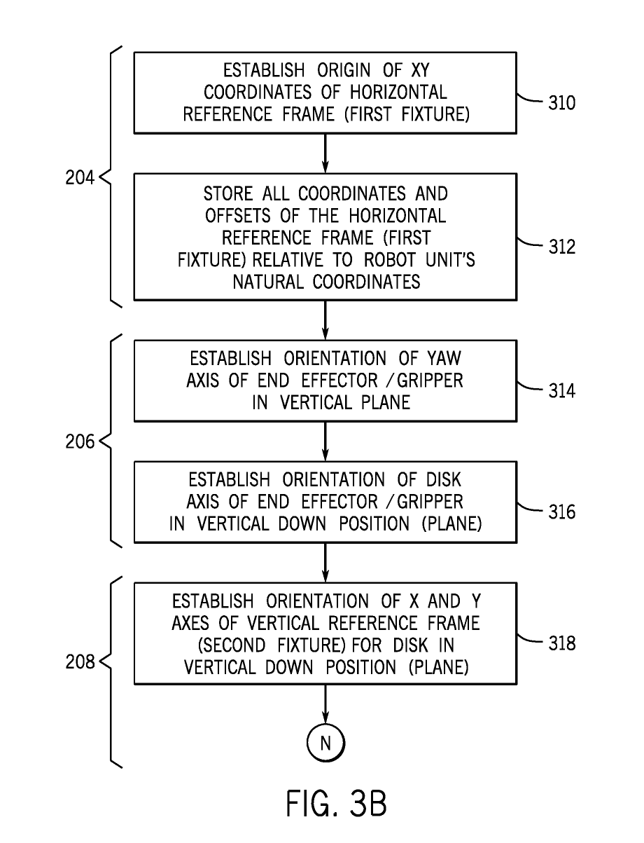

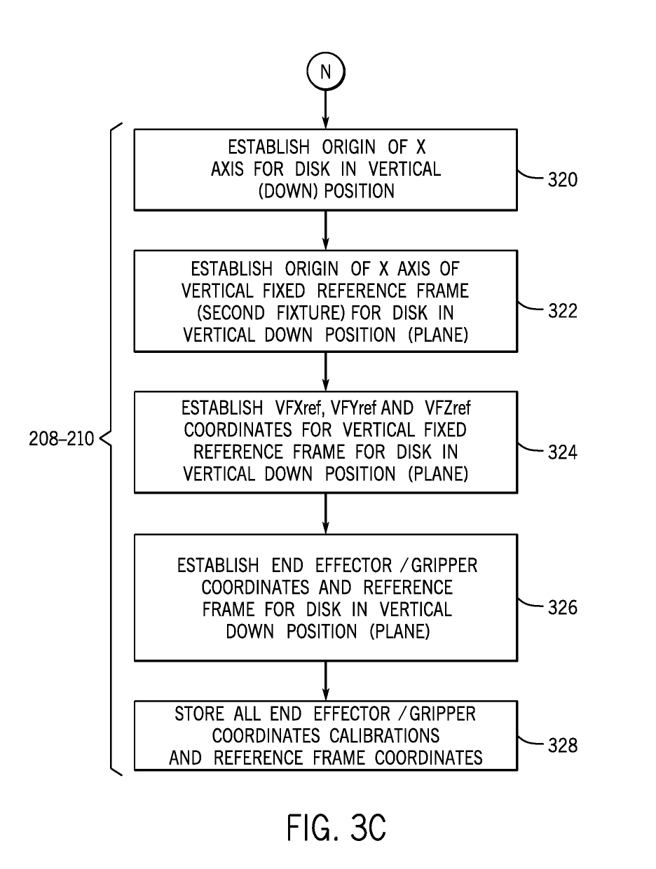

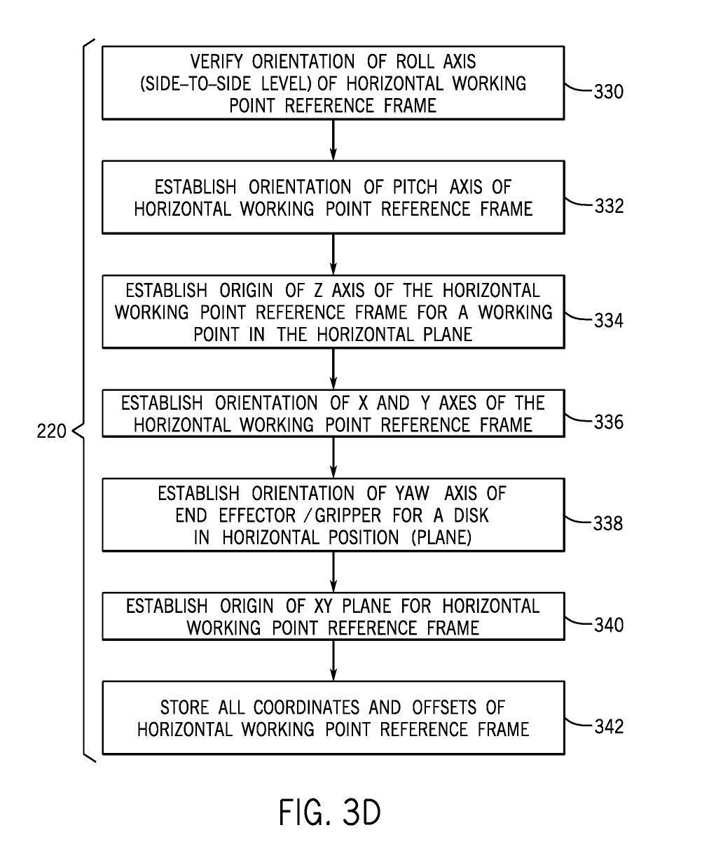

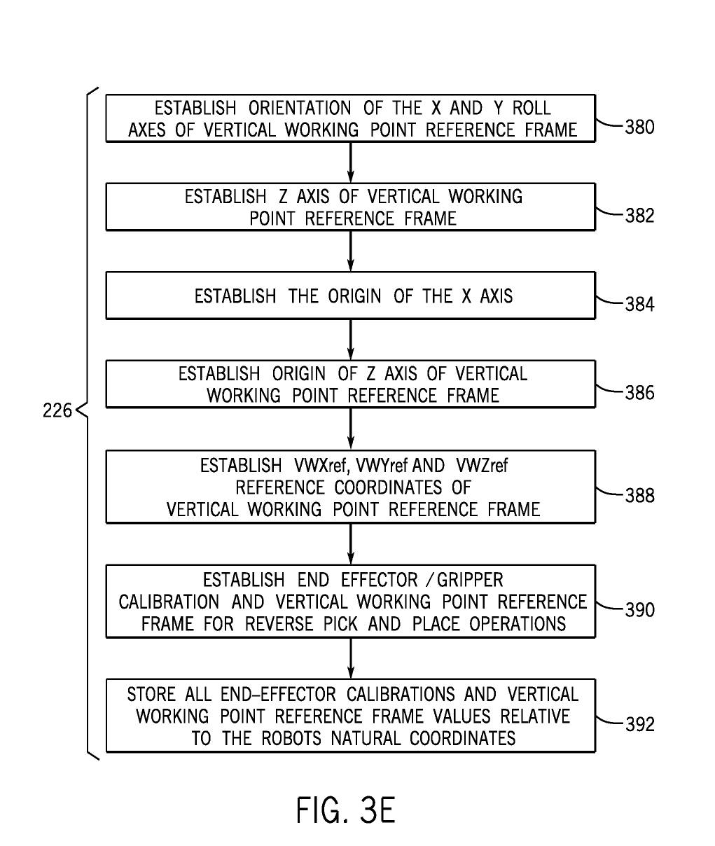

FIGS. 3A-3E depict detailed-level example method steps for autonomously teaching horizontal working points 130 and vertical working points 144 in robotic disk test workcell 102. (Note that these steps are details steps for (most of) the steps in FIGS. 2A-2D. Therefore, the high level steps in FIGS. 2A-2D will be identified as they correspond to the detailed steps in FIGS. 3A-3E.) Initially, calibration and horizontal fixed reference frame 134 coordinates for disk 126 are established. This action (generally refer to steps 200-204 in FIG. 2A) is performed during initial workcell 102 setup and commissioning and may be repeated any time a change or repair is made to robot unit 110 or end effector 112 which changes any of the adjustments and calibrations made below. Horizontal fixed reference frame 134 (first fixture) is shown in detail in FIG. 4. Frame 134 has four sides 134-1, 134-2, 134-3, 134-4 that define four planes HYref, HFZ, HFXO and HFYO, respectively, at right angles to each other. FIG. 4 identifies the fixed reference planes for the X, Y and Z and θ coordinate systems of the horizontal fixed reference frame 134 for disk 126 (in the horizontal position). Horizontal fixed reference frame 134 is mounted over model spindle 136 that is mounted to pole 138.

Reference is now made to steps 300 and 302 which correspond to step 200 in FIG. 2A.

In detail, execution begins at step 300 wherein the precise orientation of the roll axis of end effector 112 in the horizontal position (plane) is established. This is a mechanical adjustment performed on gripper 122 (disk 126 holding mechanism) of an end effector 112 to level it in the left/right direction. (In brief, the gripper is translated side to side, the disk detected by opposing sensors (side to side) and the gripper is moved/adjusted until the sensors detect the disk simultaneously.)

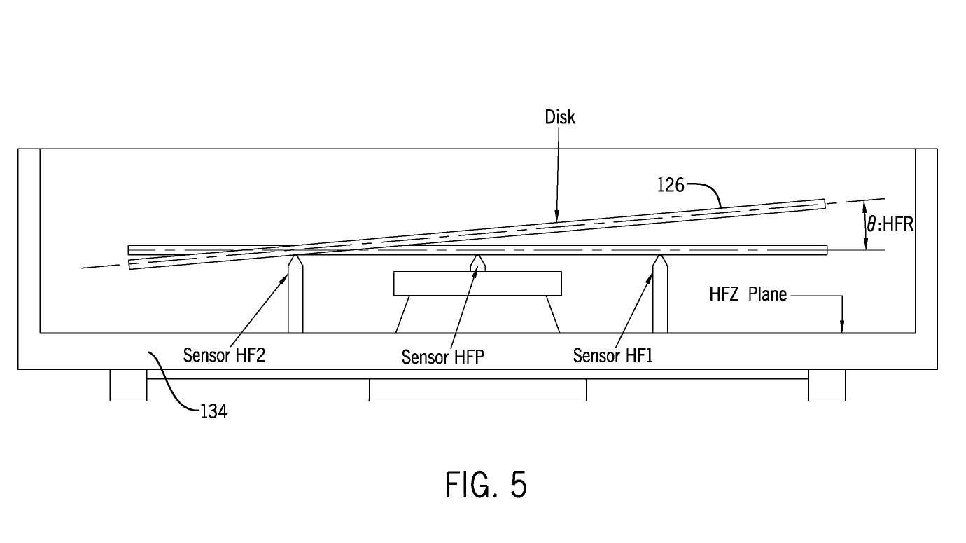

FIG. 5 depicts a front view of horizontal fixed reference frame 134 with three sensors HFP, HF1 and HF2 located on posts in the HFZ plane, which is precisely level in the horizontal plane. Sensors HF1 and HF2 are located precisely along the Y axis of the horizontal fixed reference frame 134 and establish the horizontal reference for the roll axes for end effector 112. Sensor HFP together with sensors HF1 and HF2 establish the horizontal reference of the pitch axis of end effector 112 in the horizontal fixed reference frame 134. Sensors HFP, HF1 and HF2 may be a contact or non-contact sensor as known to those skilled in the art. For example, the sensors may be proximity sensors, capacitive, inductive, optical, photo or reflective sensors (to name a few). The same applies to all sensors disclosed in this disclosure.

FIG. 5 also depicts disk 126 held in end effector 112 in the horizontal plane above the HFZ plane. The precise distance between sensors HF1 and HF2 is known. FIG. 5 deliberately depicts the plane of disk 126 as being at an angle θ HFR to true horizontal. Except for robot unit 110 with an independent rotating axis in this plane, this operation is typically a manual, mechanical adjustment to end effector 112. Robot unit 110 moves above the two sensors HF1 and HF2 and then down until one or both sensors detects disk 126. Robot unit 110 then moves back up and robot unit 110, under control by computer system 104, displays on client 106 which sensor first detects disk 126 and directs a user to make an adjustment to end effector 112 in a particular direction. In the case where the sensors are direct electrical or mechanical contact or binary optical detection, only the direction of the adjustment is known. In the case where proximity detection or camera pixel detection is used, both the direction and magnitude of the adjustment are known and displayed. In the case of a robot unit 110 with an independent rotating axis in this plane, the control computer simply commands robot unit 110 to rotate that axis accordingly. The process is repeated until both sensors HF1 and HF2 detect the disk simultaneously. In the manual case no further adjustment is necessary. In the case of a robot unit 110 with an independent rotating axis in this plane, the offset coordinate is stored in the robot unit 110's control computer and becomes one of end effector calibration values.

Execution moves to step 302 wherein the precise orientation of the pitch axis of end effector 112 in the horizontal position (plane) is established. (In brief, the gripper is translated front to back, the disk is detected by opposing sensors and the gripper is moved/adjusted until the disk is level front to back.)

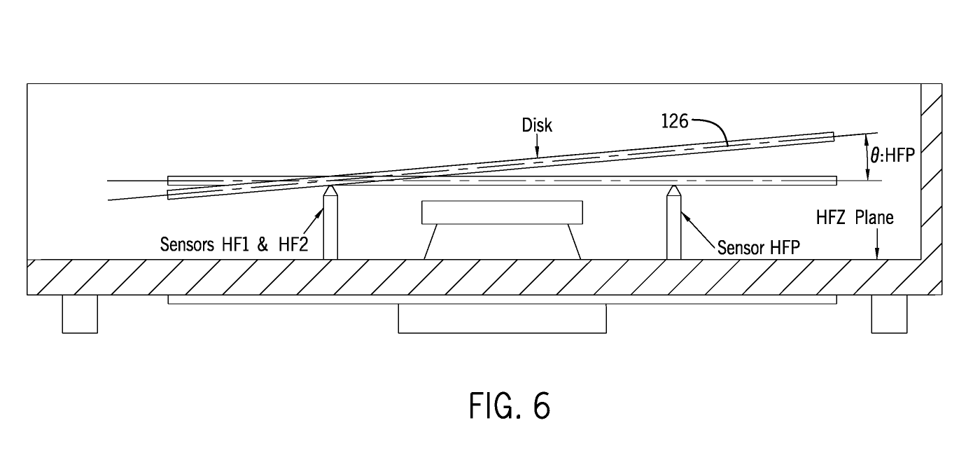

FIG. 6 depicts a cross-sectional view of horizontal fixed reference frame 134 along line 6-6 in FIG. 4 wherein a side view of disk 126 is shown held in an end effector 112 in the horizontal position (plane) above sensor HFP and both sensors HF1 and HF2. The precise distance between Sensor HFP and the line connecting sensors HF1 and HF2 is known. The robot unit 110 moves above two sensors and then down until one or both sensors detects disk 126. Robot unit 110 then moves back and the robot unit 110 under control of computer system 104, displays which sensor first detects disk 126. In the case of end effector 112 with mechanical stops, the robot unit 110 under control of computer system 104, directs a user to make an adjustment to end effector 112 in a particular direction. In the case of end effector 112 with a pitch axis controller (on end effector 112, as discussed above), the computer system 104 simply commands end effector 112 to rotate that axis accordingly. In the case where the sensors are direct electrical or mechanical contact or binary optical detection, only the direction of the adjustment is known. In the case where proximity detection or camera pixel detection is used both the direction and magnitude of the adjustment are known and displayed. The process is repeated until all three sensors detect the disk simultaneously. In the manual case by the human, no further adjustment is necessary. In the case of end effector 112 with a pitch axis controller, the offset coordinate is stored in the pitch axis controller (above) and becomes one of end effector 112 calibration values.

Steps 304-308 correspond to step 202 in FIG. 2A.

In detail, execution proceeds to step 304 where the origin of the Z axis of horizontal fixed reference frame 134 for disk 126 in the horizontal position (plane) is established. (In brief, the elevation of the disk in the gripper is calculated.)

This is an outcome or result of completing steps 300 and 302. The Z coordinate of robot unit 110, when all three sensors HF1, HF2 and HFP detect disk 126 simultaneously, establishes the orientation of the Z axis of horizontal fixed reference frame 134 for disk 126 in the horizontal plane and is labeled HFZ0.

Execution proceeds to step 306 wherein the precise orientation of the X and Y axes of horizontal fixed reference frame 134 for disk 126 in the horizontal position (plane) is established. (In brief, the gripper is translated to (sense) determine two places at right angles.)

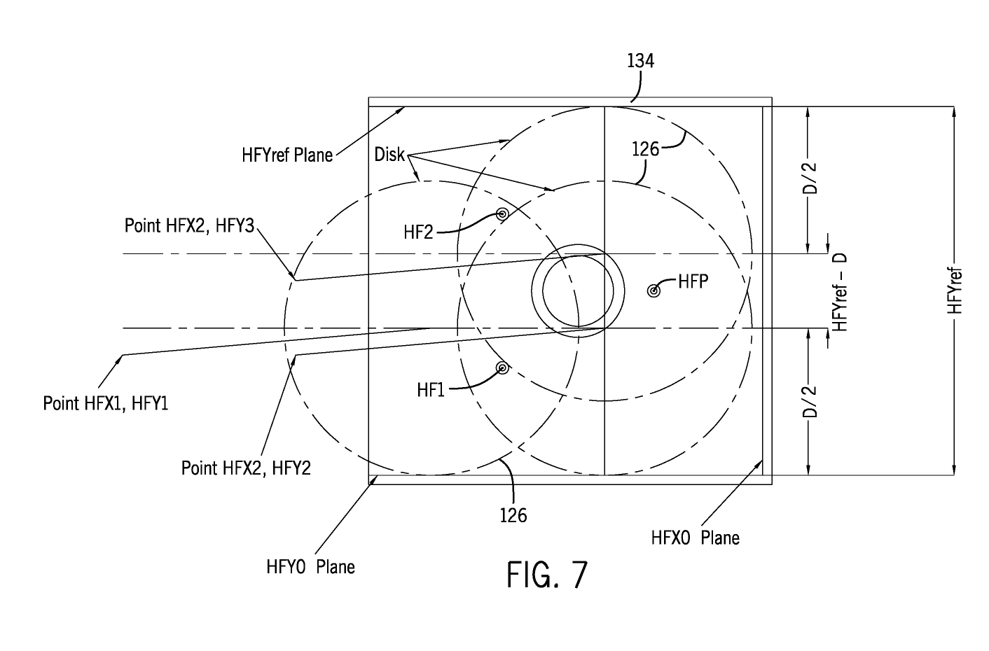

FIG. 7 depicts a top view of horizontal fixed reference frame 134 wherein disk 126 held in end effector 112 is shown in the horizontal plane in three locations. The robot unit 110 moves end effector 112 and disk 126 into the central region of horizontal fixed reference frame 134 and moves disk 126 right until it is detected by sensors HF1, HF2 at the HFY0 plane. This is point HFX1, HFY1. The robot unit 110 moves left by a small amount and then moves up to coordinate HFX2. It moves right until disk 126 is detected by sensors along the HFY0 plane. This establishes points HFX2 and HFY2. Points HFX1, HFY1 and HFX2, HFY2 are stored in computer system 104. The vector difference between these points establishes the true X axis of horizontal fixed reference frame 134 relative to robot unit 110's native coordinates for a disk in the horizontal plane.

By knowing the orientation of the X axis of horizontal fixed reference frame 134, the orientation of the Y axis of horizontal fixed reference frame 134 is known as well. Robot unit 110 moves along the Y axis until it is detected by sensors at the HFYref plane. This establishes point HFX2 and HFY3. The precise distance between the HFY0 plane and the HFYref plane is known and is HFYref. The difference between points HFX2, HFY2 and HFX2, HFY3 is the distance HFYref−D where D is the diameter of the disk in end effector 112. Thus, the orientation of the X and Y axes of horizontal fixed reference frame 134 for disk 126 in the horizontal plane relative to the native robot unit 110 coordinates as well as the measured value of D are determined and are stored in the computer system 104. This data (values) as well as all data described in this disclosure may be stored in any structure including a database within the computer system 104 or separately from it. For example, the coordinates described herein may be stored in a coordinate database.

Execution proceeds to step 308 wherein the precise orientation of the yaw axis of end effector 112 for a disk in the horizontal position (plane). (In brief, the gripper is aligned to X axis of the reference frame.)

The yaw axis of end effector 112 is also the roll axis of a typical SCARA robot unit 110. For the most accurate calculation of working points, the precise angular orientation of end effector 112 relative to the X axis of horizontal fixed reference frame 134 must be known.

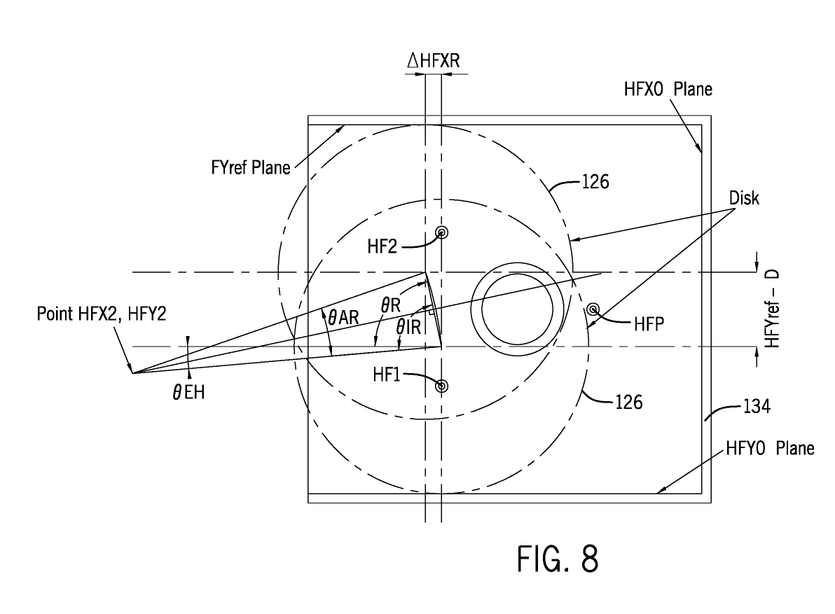

FIG. 8 depicts a top view of horizontal fixed reference frame 134 shown in FIG. 6. Disk 126 is in end effector 112 where the line connecting the center of drive rod 120 (z shaft) of robot unit 110 with the center of disk 126 is offset from the X axis of horizontal fixed reference frame 134 by the angle θEH. Robot unit 110 moves to point HFX2, HFY2, which is the same point as depicted in FIG. 7. At this location, disk 126 is detected at the HFY0 plane. Robot unit 110 moves a small distance in the +Y direction and then moves in the +X direction until the disk is detected at the HFX0 plane. The magnitude of the distance moved along the X axis is HFXR1.

Robot unit 110 moves back to point HFX2, HFY2 and holding this location, the robot unit 110 rotates its roll axis until the disk is detected at the HFYref plane. The roll angle experienced by the robot unit 110 in this move is θAR. The robot unit 110 moves a small distance in the −Y direction and then moves in the +X direction until the disk is detected at the HFX0 plane. The magnitude of the distance moved along the X axis is HFXR2. The difference between HFXR2 and HFXR1 is labeled ΔHFXR.

Based on the geometry of right triangles and isosceles triangles it can be shown that angle θIR is equal to 90−θAR/2. It can also be shown that angle θR is equal to Tan-1((HFYref−D)/ΔHFXR). From this, it can be shown that θEH=θIR−θR and θEH=90−θAR/2−Tan-1((HFYref−D)/ΔHFXR.

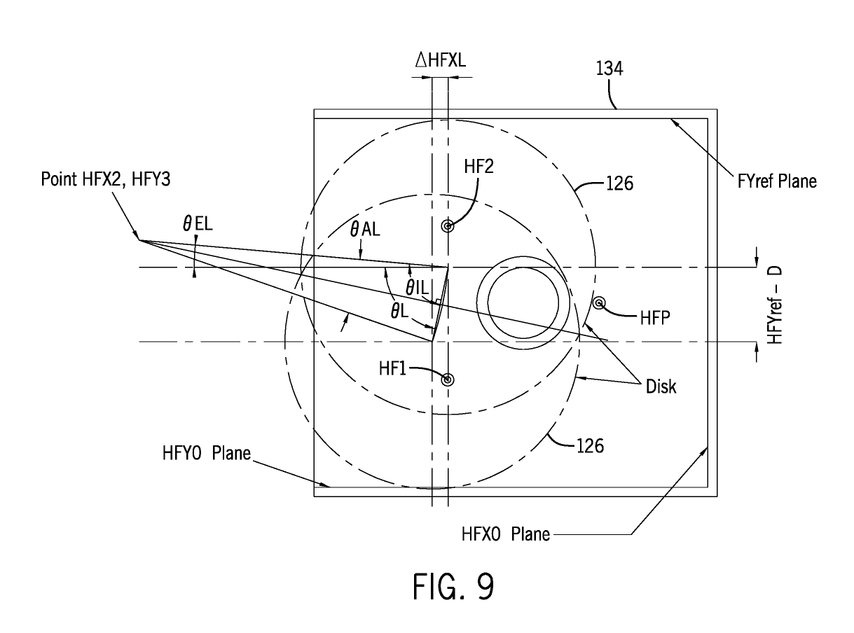

As can be seen from this equation, θEH is very sensitive to ΔHFXR, especially when ΔHFXR is very small. Therefore, it is valuable to repeat this procedure according to FIG. 9 (top view of horizontal fixed reference frame 134). In this case, the initial location is point HFX2, HFY3 as shown in FIG. 7 and the roll axis is rotated until the disk is detected at the HFY0 plane. Angle θAL and distance ΔHFXL are measured and from this it can be proven that: θEH=90−θAL/2−Tan-1((HFYref−D)/ΔHFXL.

The preferred set of measurements with which to determine θEH are the ones in which the ΔHFX is the greatest. This minimizes the uncertainties in the computed θEH. In this example, measurements θAR and ΔHFXR are used. The value of θEH is stored in computer system 104.

Execution proceeds to step 310 wherein the origin of the XY coordinates of horizontal fixed reference frame 134 is established.

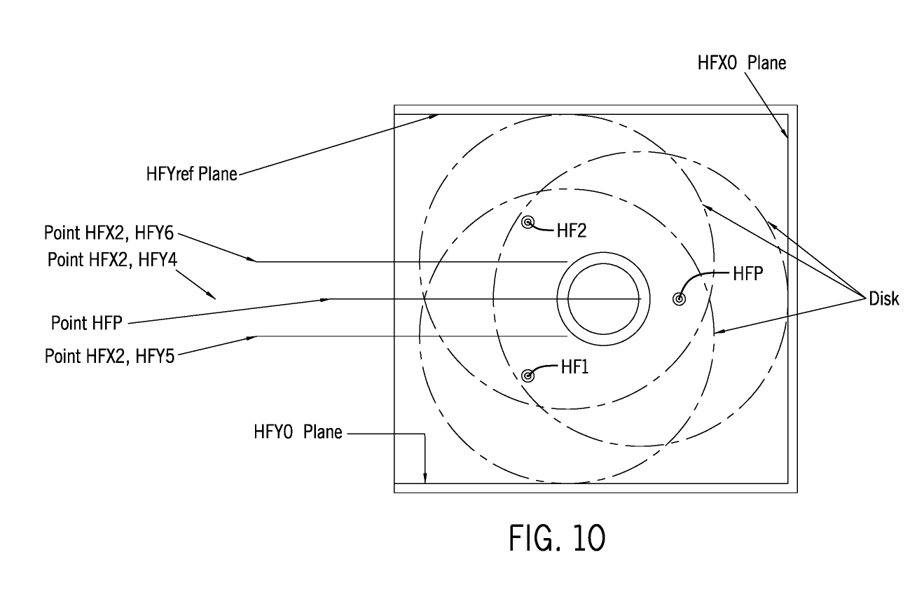

FIG. 10 depicts a top view of horizontal fixed reference frame 134 show in FIG. 6. Robot unit 110 moves to point HFX2, HFY4 where coordinate HFX2 is the same as in point HFX2, HFY2 of FIG. 7 and coordinate HFY4 is the mid-point between the Y coordinates in points HFX2, HFY2 and HFX2, HFY3 of FIG. 9. The robot unit 110 then adjusts its roll axis by the amount θEH to align with the X axis in horizontal (fixed) reference frame 134. The robot unit 110 moves in the −Y direction until the disk is detected at the HFY0 plane. It then moves in the +Y direction until the disk is detected at the HFYref plane. The robot unit 110 then moves to the point HFX2, HFY0 where the coordinate HFY0 is the mid-point between the Y coordinates of the previous two moves. This establishes end effector 112 at the origin of the Y axis of horizontal fixed reference frame 134 and aligned directly along its X axis. Robot unit 110 then moves in the +X direction until disk 126 is detected at the HFX0 plane. This location point HFX0, HFY0, HFZ0 is point HFP and represents the exact center of the fixed reference point within the horizontal fixed reference frame 134 (plane) for disk 126 in the horizontal plane.

Steps 310 and 312 correspond to step 204 in FIG. 2A.

Execution moves to step 312 wherein all coordinates and offsets of horizontal fixed reference frame 134 relative to the robot unit 110's natural coordinates are stored.

This completes steps 300-312. The calibration of end effector 112 and the determination of horizontal fixed reference frame 134 for disk 126 in the horizontal plane are done. All coordinates, offsets and adjustments relative to robot unit 110's natural coordinates are stored.

Now, execution proceeds to steps 314-328 wherein end effector 112 calibration and reference frame coordinates for disk 142 in the vertical down plane are established. The reference frame used is a second fixture, which is vertical fixed reference frame 140 (cassette box describe above). FIG. 11 depicts a perspective-enlarged view of vertical fixed reference frame 140. These steps are performed during initial workcell 102 setup and commissioning and may be repeated any time a change or repair is made to the robot unit 110 or end effector 112 which changes any of the adjustments and calibrations made below. FIG. 11 depicts the second fixture having five sides 140-1, 140-2, 140-3, 140-4, 140-5 (walls), as described above, at right angles to each other. The sides 140-1, 140-2, 140-3, 140-4, 140-5 define reference planes VFXO, VFXref, VFY0, VFYref, and VFZO for the X, Y, Z and θ for the coordinate system of vertical fixed reference frame 140 for disk 142 (disk not shown in this FIG. 11) in the vertical down position (plane).

Steps 314 and 316 correspond to step 206 in FIG. 2A.

Specifically, execution proceeds to step 314 wherein the precise orientation of the yaw axis of end effector 112 (the roll axis of the robot unit 110) in the vertical down position (plane) is established. (In brief, the gripper is translated laterally, the disk is detected by the sensors, and the gripper is moved/adjusted until the disk is detected in parallel by the sensors.)

This corresponds to the roll axis of a SCARA robot unit or multi-axis robot unit and establishes the precise direction of a line originating at the center of the Z axis of robot unit 110 and extending through the center of a disk held in end effector 112 in the vertical down position (plane). This can be a mechanical adjustment of the mounting mechanism attaching end effector 112 to the vertical axis of the robot unit 110, but more typically is a programmed angular offset stored in the robot unit 110 under control of computer system 104. The VFX0 plane is precisely aligned along the Y and Z axes of the vertical fixed reference frame 140. Sensors VF1 and VF2 are located precisely along the Y axis of vertical fixed reference frame 140. Sensor VFP is located at the mid-point of the Y coordinates of VF1 and VF2 and offset along the Z axis of vertical fixed reference frame 140. Sensors VFP, VF1 and VF2 may be a contact or non-contact sensor. For example, the sensors may be proximity sensors, capacitive, inductive, optical, photo or reflective sensors (to name a few).

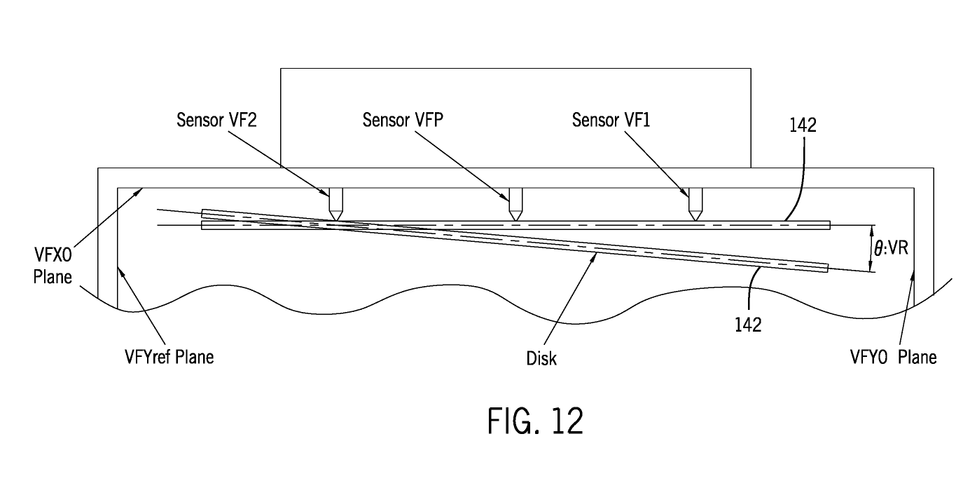

FIG. 12 depicts a cross sectional view of vertical fixed reference frame 140 along line 12-12 in FIG. 11. In FIG. 12, disk 142 is held in end effector 112 in the vertical down position (plane) in front sensors VF1 and VF2. Robot unit 110 moves in front of the two sensors VF1 and VF2 and then forward along the X axis until one or both sensors detects disk 142. In the case where the sensors are direct electrical or mechanical contact or binary optical detection, only the direction of the adjustment is known. In the case where proximity detection or camera pixel detection is used, both the direction and magnitude of the adjustment are known and displayed. Robot unit 110 then moves back, control computer system 104 commands robot unit 110 to rotate the roll axis and the process is repeated until both sensors detect the disk simultaneously. The offset coordinates are stored in robot unit 110 under the control of computer system 104 as part of end effector 112 calibration values for disk 142 in the vertical down position (plane).

Execution proceeds to step 316 wherein the precise orientation of the pitch axis of end effector 112 in the vertical down position (plane) is established. (In brief, the gripper is translated vertically, the disk is detected by the sensors and the gripper is then adjusted until the sensors detect the disk in parallel.)

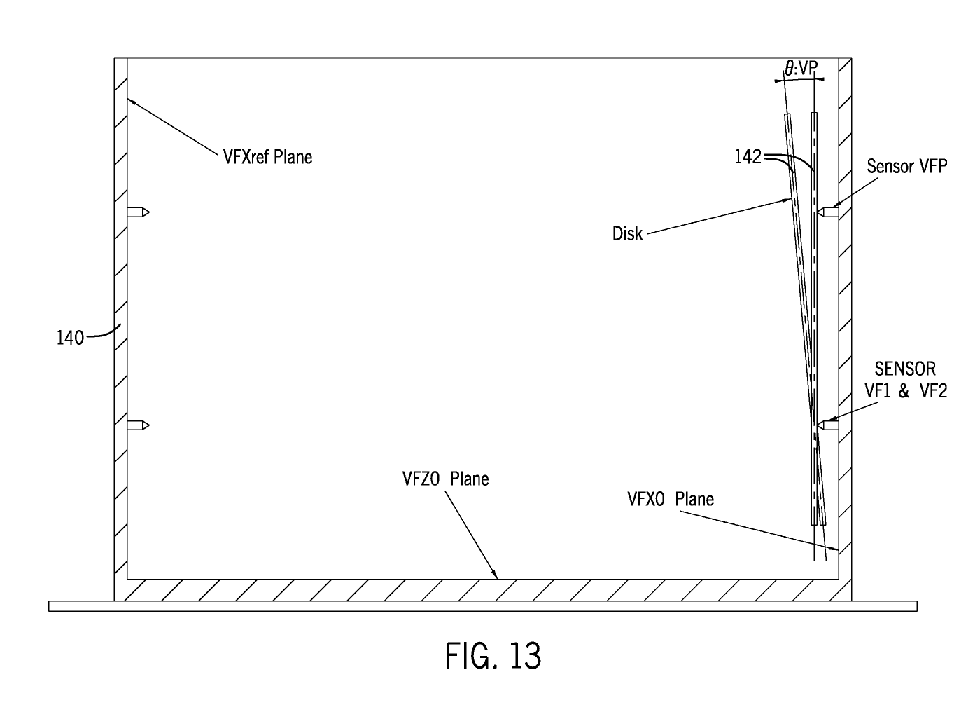

FIG. 13 depicts a cross sectional view of vertical fixed reference frame 140 along line 13-13 in FIG. 11. A side view of disk 142 is held in end effector 112 in the vertical down position (plane) in front of sensors VF1, VF2 and VFP. The sensors are located precisely along the Z axis of the vertical fixed reference frame 140. Robot unit 110 moves along the X axis until either the sensor VFP or the sensors VF1 and VF2 detect disk 142. Robot unit 110 then moves back and the control computer system 104 causes client 106 to display which sensor first detected disk 142. In the case of an end effector 112 with mechanical stops, computer system 104 directs the user to make an adjustment to end effector 112 in a particular direction. In the case where the sensors are direct electrical or mechanical contact or binary optical detection, only the direction of the adjustment is known. In the case where proximity detection or camera pixel detection is used, both the direction and magnitude of the adjustment are known and displayed. The process is repeated until all three sensors detect disk 142 simultaneously. In the manual case the user need not make any further adjustment. In the case of end effector 112 with a pitch axis controller as described above, the offset coordinate is stored in the pitch axis controller and becomes one of end effector 112 calibration values.

Steps 318-328 correspond to steps 208 and 210 in FIG. 2A.

Execution proceeds to step 318 wherein the precise orientation of the X and Y axes of the vertical fixed reference frame 140 for a disk in the vertical down plane is established. (In brief, the true directions for the X and Y axes are found.)

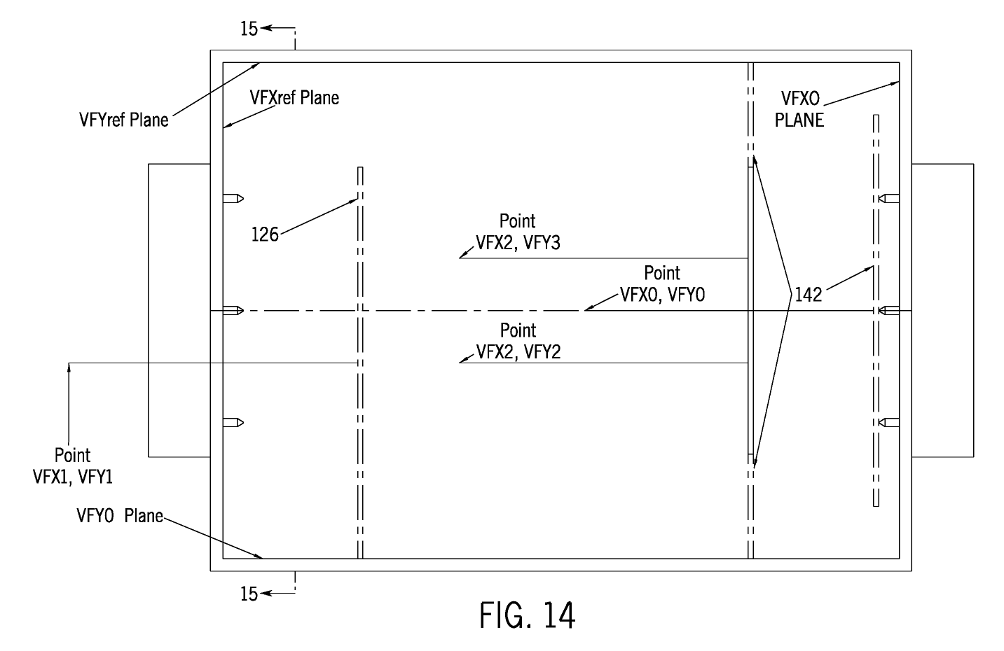

FIG. 14 depicts a top view of vertical fixed reference frame 140 in FIG. 11 wherein the disk 142 held in an end effector 112 in the vertical down position (plane) in three locations. Robot unit 110 moves into the central region of the vertical fixed reference frame 140 and moves to the right until it is detected at the VFY0 plane. This is point VFX1, VFY1. Robot unit 110 moves left by a small amount and then moves up to coordinate VFX2. It moves right until it is detected at the VFY0 plane. This establishes point VFX2, VFY2. The vector difference between point VFX1, VFY1 and VFX2, VFY2 establishes the true X axis in the vertical fixed reference frame 140 for disk 142 in the vertical down plane.

By knowing the orientation of the X axis of vertical fixed reference frame 140, the Y axis is known as well. Robot unit 110 moves along the Y axis until it is otherwise at the VFYref plane. This establishes point VFX2, VFY3. The precise distance between the VFY0 plane and the VFYref plane is known and as is VFYref. The difference between points VFX2, VFY2 and VFX2, VFY3 is the distance VFYref−D where D is the diameter of the disk in end effector 112. Thus the orientation of the X and Y axes of the vertical fixed reference frame 140 relative to native robot unit 110 coordinates as well as the measured value of D for a disk in the vertical down plane are determined. The origin of the Y axis of vertical fixed reference frame 140 for disk 142 in the vertical down position (plane) is also known. It is located at Y coordinate (VFY2+VFY3)/2 and is labeled VFY0.

Execution proceeds to step 320 wherein the origin of the X axis for disk 142 in the vertical down position (plane) is established. (In brief, the front point for the disk in the pitch down position is found.)

In FIG. 14, robot unit 110 moves to point VFX2, VFY0 and moves in the −X direction until it is detected at the VFX0 plane. This establishes the orientation of the X axis in vertical fixed reference frame 140 for disk 142 in the vertical down position (plane) and is labeled VFX0.

Execution proceeds to step 322 wherein the origin of the Z axis of vertical fixed reference frame 140 for disk 142 in the vertical down position (plane) is established. (In brief, the proper elevation (Z) at the location is found.)

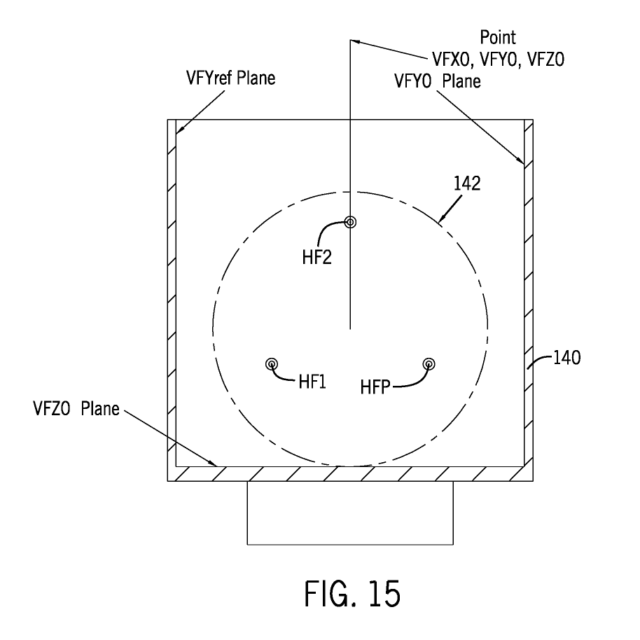

FIG. 15 depicts a cross-sectional view of vertical fixed reference frame 140 in FIG. 11 wherein a face disk 142 is shown in end effector 112 in the vertical down position (plane). Robot unit 110 moves to point VFX0, VFY0 and moves a short distance in the +Y direction. It then moves down until the disk is detected at the Z0 plane. This establishes the origin of the Z axis of the vertical fixed reference frame 140 for a disk in the vertical down plane and is labeled VFZ0. The complete point VFX0, VFY0, VFZ0 corresponds to the origin in vertical fixed reference frame 140 of the first location in an array of pick and place points for disk 142 in the vertical down position (plane).

Execution proceeds to step 324 wherein vertical fixed reference frame 140 coordinates (i.e., VFXref, VFYref and VFZref coordinates) for X, Y, Z for disk 142 in the vertical down position (plane) are established. (In brief, the actual locations of X, Y, Z coordinates are established for the rear location for the disk in the pitch down position.)

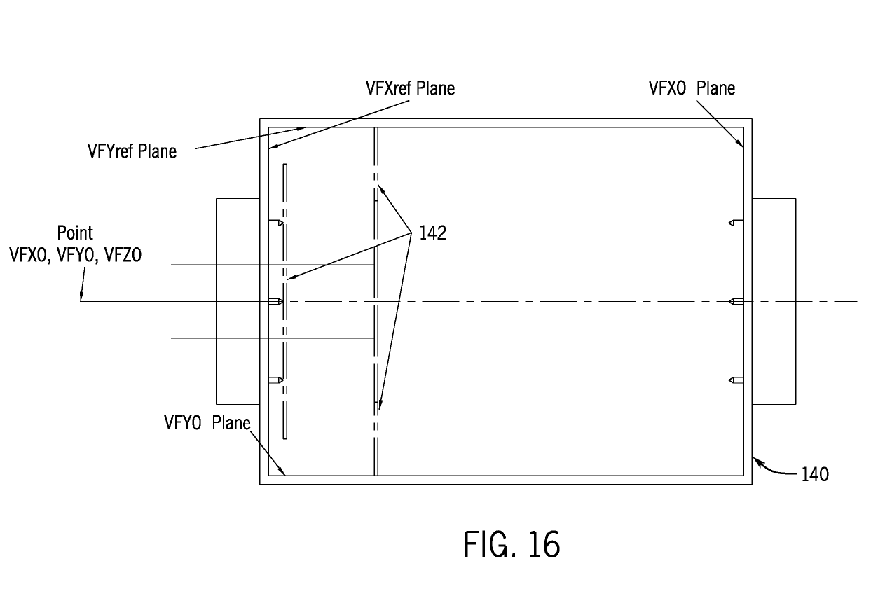

FIG. 16 depicts a top plan view of vertical fixed reference frame 140 in FIG. 11. The precise distance between the VFX0 plane and the VFXref plane is known. Robot unit 110 moves to the Y coordinate VFYref (which is calculated) at a location just short of VFXref (which is also calculated). Robot unit 110 moves in the −Y direction until it is detected at the VFY0 plane. It then moves in the +Y direction until it is detected at the VFYref plane. The midpoint of the two Y coordinates should match precisely the Y coordinate VFYref. If the two Y coordinates differ, then the newly calculated mid-point of the −Y and +Y locations is taken as the correct VFYref.

The robot unit 110 moves to the Y coordinate VFYref and to the X coordinate just short of VFXref. It then moves in the −X direction until the disk is detected at the VFXref plane by sensors VFPref, VF1ref and VF2ref. The X coordinate of this location should match exactly the calculated coordinate VFXref. If the two X coordinates differ, then the newly measured X coordinate is taken as the correct VFXref.

Robot unit 110 moves a short distance in the +X direction and then moves down until disk 142 is detected at the VFZ plane. This sets the VFZref coordinate. The point VFXref, VFYref, VFZref corresponds to the location in vertical fixed reference frame 140 of the last location in an array of pick and place points for a disk in the vertical down position (plane).

Execution proceeds to step 326 wherein end effector 112 calibration and vertical fixed reference frame 140 coordinates for disk 142 in the vertical down position (plane) for reverse pick and place operations is established. Frequently pick and place operations for disk 142 in the vertical down position (plane) must be performed at a roll orientation of 180 degrees from the normal pick and place operations. These are called reverse points. Separate end effector 112 calibrations and reference frames coordinates must be established for these operations. To do this, steps 314 through 316 are repeated, but with end effector 112 rotated 180 degrees around the Z axis.

Execution proceeds to step 328 wherein all end effector 112 calibrations and vertical fixed reference frame 140 coordinates relative to the robot unit 110's natural coordinates are stored. This completes steps 314-328 and the calibration of end effector 112 and the determination of vertical fixed reference frame 140 for a disk in the vertical down plane.

As described above, step 212 in FIG. 2B is executed. That is, steps 200-210 are repeated if there is another disk in a second gripper 124 of end effector 112. Specifically, each of the procedures outlined in steps 200-210 are repeated in the same order for the other gripper 124 in end effector 112. This is necessary since the fabrication and assembly tolerances of the various elements of end effector 112 will result in a different set of end effector 112 calibrations and reference frame coordinates for the two grippers 122, 124.

As described above, step 214 in FIG. 2B is executed. That is, transformation map relating the end effector 112 calibrations and the reference frame coordinates of the dual grippers (two disk holding mechanisms) of end effector 112 are created. Establishing a transform map relating the two sets of end effector 112 calibrations and the two reference frame coordinates can make the process of teaching the various working points in the workcell simpler and faster. Depending on the tolerances required it is often possible to teach one set of working points for one disk holding mechanism of end effector 112 and using the relative transform map to compute the working points for the other gripper (disk holding mechanism).

As described above, steps 220 and 226 are executed if there are additional working points available (established at steps 216 and 222). In step 220, each of the horizontal working points 130 are taught in workcell 102. In step 226, each of the vertical working points 144 are taught in workcell 102.

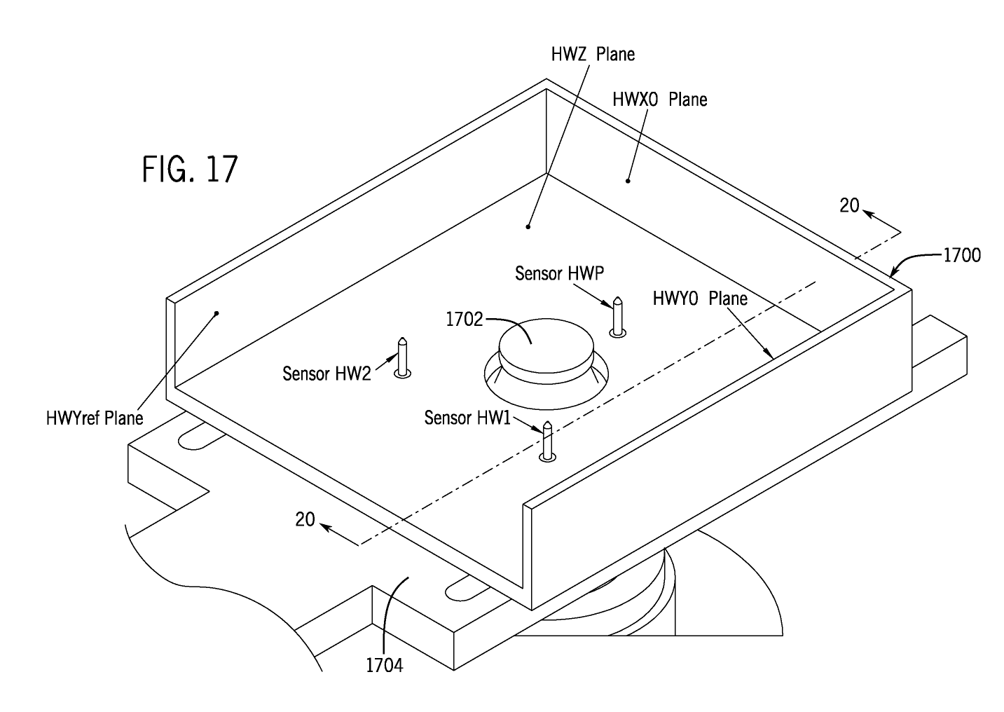

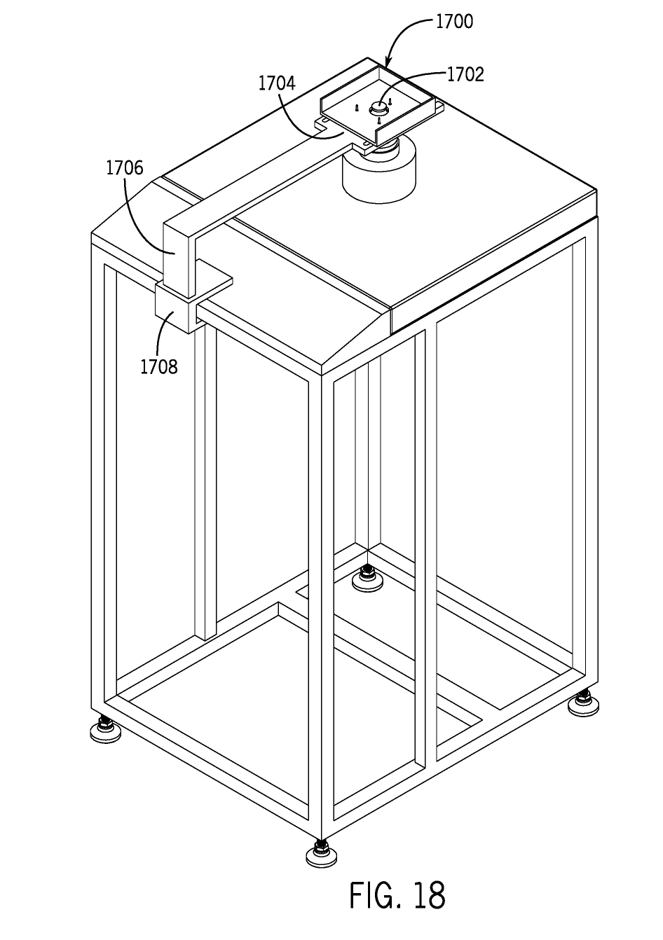

FIG. 17 depicts a perspective view a working point or horizontal working point reference frame (fixture) 1700. Horizontal working point reference frame 1700 may be the same as horizontal fixed reference frame 134 or a different one with the same dimensions as frame 134. In this embodiment, the working point 130 is a spindle 1702 on a test machine or table as shown in FIG. 1. The bottom surface of the fixture is a circular hole of the same diameter as a disk which would rest on or be clamped by the spindle. FIG. 17 also depicts an extension 1704 that engages a part of horizontal working point reference frame 1700 on the test machine or table that aligns frame 1700 (fixture) at the correct access angle to spindle 1702. Extension 1704 is a forked bar with slotted holes in the two forks. Screws in the bottom of the fixture engage the slotted holes and allow for adjustment along the direction of the extension without allowing any rotation in the orientation of the horizontal working point reference frame 1700 (fixture). The other end of the extension 1706 is an L bracket which engages the front lip of the top surface of the test machine. This is best shown in FIG. 18. This bracket is just a reference guide and does not need to bolt to the test machine itself. In this way, the extension 1702 allows for some variation in the location of the spindle on the top of the test machine while maintaining the proper angular orientation of the X and Y axes.

In short, this step 220 is similar to steps 200-204 except that no mechanical adjustments to end effector 112 are made. This exception typically applies to end effector 112 roll adjustments and to end effector 112 pitch adjustments in the case where the pitch adjustment is a mechanical change to end effector 112. If it is determined that any of the values of the coordinates for the horizontal working point reference frame 1700 exceed the allowed tolerances, a user is alerted and advised to adjust the equipment containing that horizontal working point.

Steps 330-342 below correspond to step 220 in FIG. 2B.

Specifically, execution proceeds to step 330 wherein the precise orientation of the roll axis (side-to-side level) of horizontal working point reference frame 1700 coordinates are verified (at a working point 130).

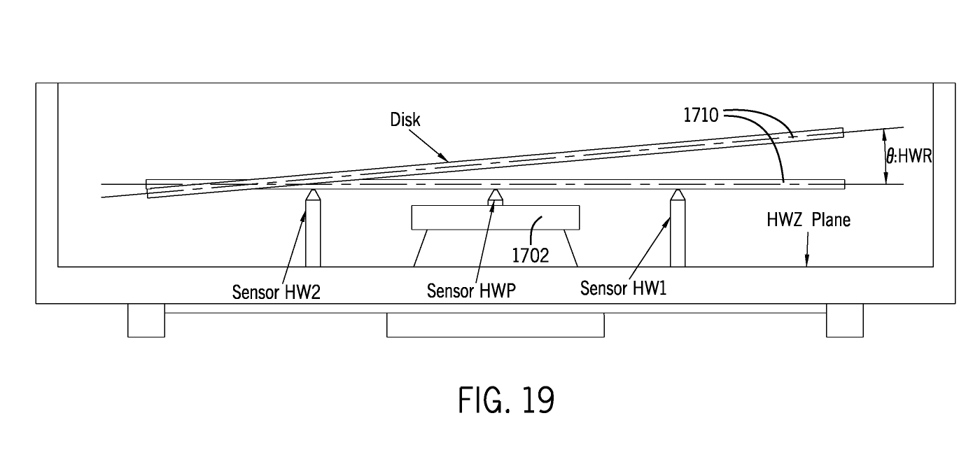

FIG. 19 depicts a front view of horizontal working point reference frame 1700 of FIG. 17 with three sensors HWP, HW1 and HW2 located on the HWZ plane which is precisely parallel to the horizontal plane of spindle. Sensors HW1 and HW2 are located precisely along the Y axis of the horizontal working point reference frame 1700 and establish the horizontal reference for the roll axes for end effector 112. Sensor HWP is at a higher Z coordinate than sensors HW1 and HW2. These three sensors are used to determine the horizontal reference of the pitch axis of the working point in horizontal working point reference frame 1700.

As shown in FIG. 19, disk 1710 is held in end effector 112 in the horizontal plane above the HWZ plane. The precise distance between sensors HW1 and HW2 is known and is larger than the diameter of disk 1710. FIG. 19 specifically depicts the plane of disk 1710 as being at an angle θHW to the HFZ0 plane (the horizontal plane of the frame 1700 (fixed reference fixture)). Robot unit 110 moves above the HW1 sensor and then down until it detects the disk. Robot unit 110 then moves back up and over the HW1 sensor. It moves down until that sensor detects disk 1710. The difference in the Z coordinate of the two detections represents the angle θHW. Computer system 104 (controlling robot unit 110) causes the display of this angle on client 106. If this angle exceeds the allowed tolerance, a user is alerted to make the appropriate adjustment to the equipment housing spindle 1702. The process is repeated until the angle θHW is within the allowed tolerance.

Execution proceeds to step 332 wherein the precise orientation of the pitch axis of the horizontal working point reference frame 1700 (plane) is established.

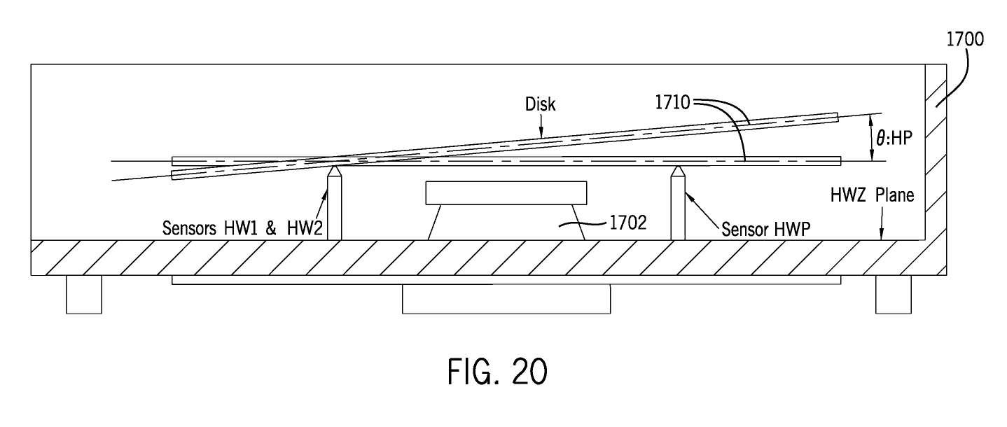

FIG. 20 depicts a cross-sectional view of frame 1700 along line 20-20 in FIG. 17. FIG. 20 shows a side view of disk 1710 held in an end effector 112 in the horizontal plane above sensor HWP and both sensors HW1 and HW2. The precise distance between sensor HWP and the line connecting sensors HW1 and HW2 is known. The Z coordinate of sensor HWP is higher than that of sensors HW1 and HW2. FIG. 20 deliberately depicts the plane of the disk as being at an angle θHP to the HFZ0 plane (the horizontal plane of frame 1700—reference fixture). Robot unit 110 moves above sensor HWP and then down until it detects disk 1710. Robot unit 110 then moves back up and the control computer system 104 causes the display of the calculated angle θHP on client 106. In the case of end effector 112 with mechanical stops, computer system 104 directs a user to make an adjustment to the pitch axis of the spindle. This adjustment may affect the angle θHW. In the case of an end effector 112 with a pitch axis controller, the control computer system 104 simply commands end effector 112 to rotate that axis accordingly. The process is repeated until both angles θHW and θHP are within allowed tolerances.

Execution moves to step 334 wherein the origin of the Z axis of the horizontal working point reference frame 1700 for a working point in the horizontal plane is established. This is a result of completing steps 330 and 332. The Z coordinate of robot unit 110 (when sensor detection occurs) and both angles θHW and θHP are within allowed tolerances. This establishes a precisely known height above the actual Z coordinate of the working point. Therefore, the Z coordinate of the working point can be calculated and is labeled HFZ0.

Execution proceeds to step 336 wherein the precise orientation of the X and Y axes of the horizontal working point reference frame 1700 is established.

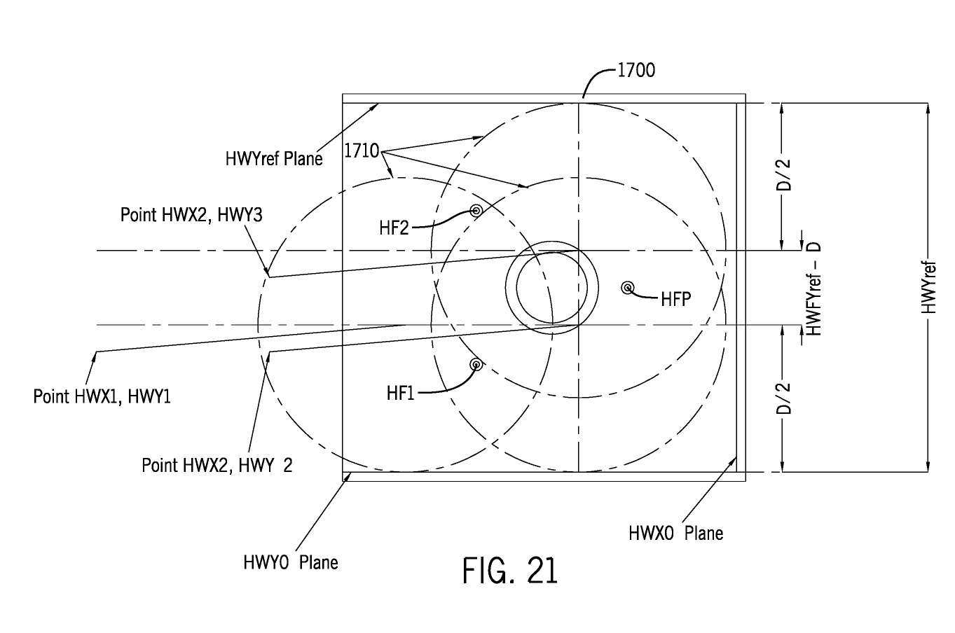

FIG. 21 depicts a top view of horizontal working point reference frame 1700 in FIG. 17 wherein the disk 1700 is shown held in end effector 112 in the horizontal plane in three locations. Robot unit 110 moves into the central region of the fixture and moves to the right until it is detected by sensors at the HWY0 plane. This is point HWX1, HWY1. Robot unit 110 moves left by a small amount and then moves up to coordinate HWX2. It moves right until it is detected by sensors along the HWY0 plane. This establishes point HWX2, HWY2. Points HWX1, HWY1 and HWX2, HWY2 are stored in the control computer system 104. The vector difference between these points establishes the true X axis of the horizontal working point reference frame 1700 relative to robot unit 110's native coordinates for disk 1710 in the horizontal plane.

By knowing the orientation of the X axis of horizontal working point reference frame 1700, the orientation of the Y axis of horizontal working point reference frame 1700 is known as well. Robot unit 110 moves along the Y axis until it is detected by sensors at the HWYref plane. This establishes point HWX2, HWY3. The precise distance between the HWY0 plane and the HWYref plane is known and is HWYref. The difference between points HWX2, HWY2 and HWX2, HWY3 is the distance HWYref−D where D is the diameter of the disk in end effector 112. Thus, the orientation of the X and Y axes of horizontal working point reference frame 1700 for disk 1710 in the horizontal plane relative to the native robot unit 110 coordinates as well as the measured value of D are determined and are stored in control computer system 104. If the difference between the coordinate HWY0 and its design value exceeds the allowed tolerance, a human is directed to make an adjustment to the Z coordinate of spindle 1702.

Execution proceeds to step 338 wherein the precise orientation of the yaw axis of end effector 112 (gripper) for disk 112 in the horizontal position (plane) is established.

The yaw axis of end effector 112 is also the roll axis of a typical SCARA robot unit 110. For the most accurate calculation of working points the precise angular orientation of end effector 112 relative to the X axis of the horizontal working point reference frame 1700 must be known. Since the X axis of the horizontal working point reference frame 1700 is known and the value of θEH from step 308 is known, the yaw axis of end effector 112 (also the roll axis of the robot unit 110) can be calculated. Computer system 104 causes the display of this value on client 106 and if it exceeds the allowed tolerance for the working point a user is directed to make an adjustment to the yaw axis of spindle 1702.

Execution proceeds to step 340 wherein the origin of the XY plane for the horizontal working point reference frame 1700.

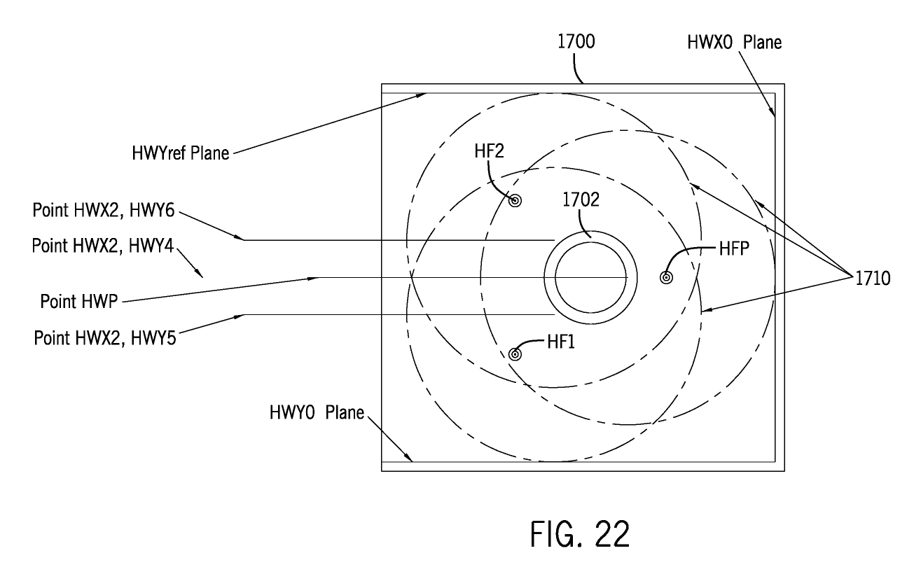

FIG. 22 is another top view of frame 1700 in FIG. 17. Robot unit 110 moves to point HWX2, HWY4 where coordinate HWX2 is the same as in point HWX2, HWY2 of FIG. 21 and coordinate HWY4 is the mid-point between the Y coordinates in points HWX2, HWY2 and HWX2, HWY3 of FIG. 21. Robot unit 110 then moves to the point HWX2, HWY0 where the coordinate HWY0 is the mid-point between the Y coordinates of the previous two moves. Robot unit 110 then moves in the +X direction until the disk is detected at the HWX0 plane. This location point HWX0, HWY0, HWZ0 represents the exact center of the working reference point 130 within the working point reference plane for disk 1710 in the horizontal plane. The offset of this coordinate to the actual working point of spindle 1702 is known and therefore, the actual coordinate of the working point labeled point HWP is calculated and stored.

Execution proceeds to step 342 wherein all coordinates and offsets of the horizontal working point reference frame 1700 relative to horizontal fixed reference frame 134 are stored.

This completes step 220 in FIG. 2B, the determination of the horizontal working point reference frame 1700 and the calculation of the actual working point HWP. All coordinates, offsets and adjustments relative to horizontal fixed reference frame 134 are stored in computer system 104.

Now, as described above, execution proceeds to step 226 wherein each of the vertical working points in workcell 102 are taught. In this step 226, steps 380-392 are performed.

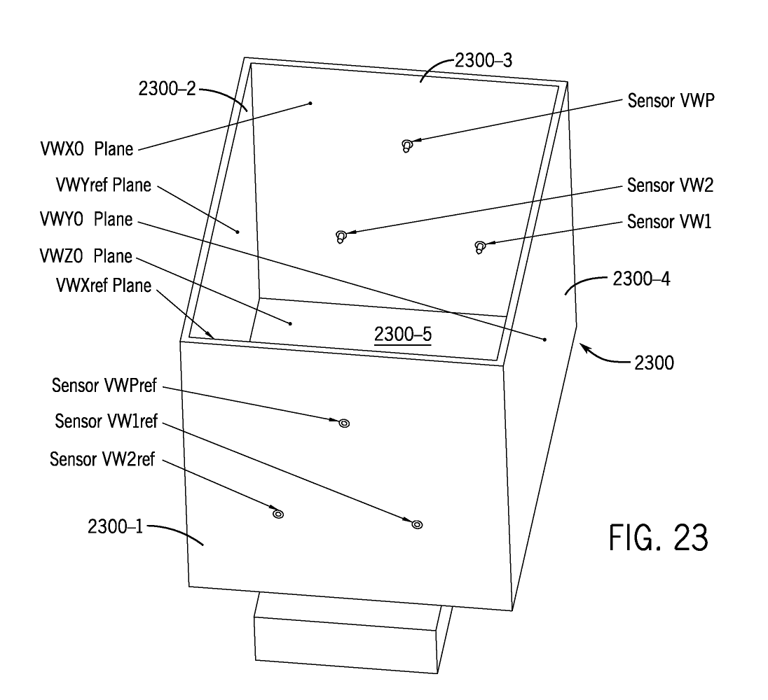

FIG. 23 depicts vertical working point reference frame or fixture 2300 at a vertical working point in FIG. 1. In this embodiment, the vertical working point is a cassette in workcell 102. The bottom of vertical working point reference frame 2300 is configured to have the same profile as an actual cassette 144 used in the workcell 102. The fixture has five sides 2300-1, 2300-2, 2300-3, 2300-4, 2300-5, at right angles to each other. Frame 2300 identifies the reference planes VWX, VWXref, VWY, VWYref and VWZO, for the X, Y, Z and θ and pitch coordinates of vertical working point reference frame 2300.

A process similar to steps 314 and 316 is performed with the exception that no mechanical adjustments to end effector 112 are made. This exception typically applies to end effector 112 pitch adjustments in the case where the pitch adjustment is a mechanical change to end effector 112. If it is determined that any of the values of the coordinates for the vertical working point reference frame exceed the allowed tolerances a user is alerted and advised to adjust the equipment containing that vertical working point. The order of steps below differs from the order of steps 314-328. This is a result of the previous determinate of all of the calibrations and offsets that were previously made in steps 314-328.

In detail, execution proceeds to step 380 wherein the precise orientation of the X, Y and roll axes of the vertical working point reference frame 2300.

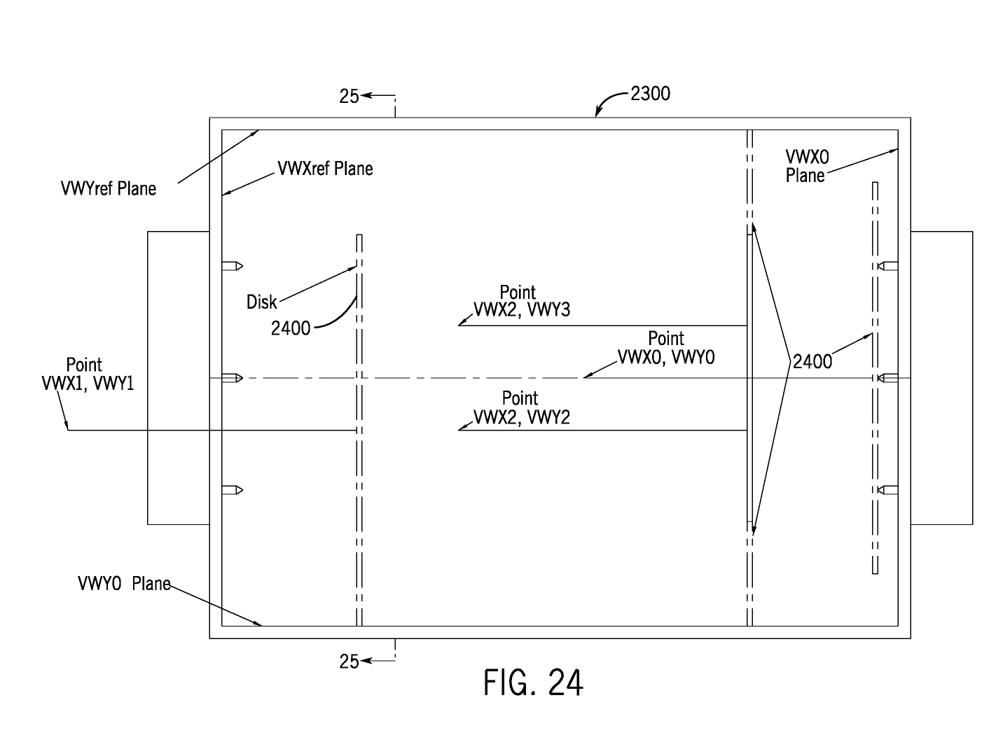

FIG. 24 depicts a top view of vertical working point (fixed) reference frame 2300 in FIG. 23 wherein disk 2400 held in end effector 112 in the vertical down position (plane) in three locations. Frame 2300 is the same or similar in dimensions to vertical working point reference frame 140 in FIG. 1. Robot unit 110 moves into the central region of the fixture and moves to the right until it is detected at the VWY0 plane. This is point VWX1, VWY1. Robot unit 110 moves left by a small amount and then moves up to coordinate VWX2. It moves right until it is detected at the VWY0 plane. This establishes point VWX2, VWY2. The vector difference between point VWX1, VWY1 and VWX2, VWY2 establish the orientation of the X axis in vertical working point reference frame 2300. If the difference between measured X axis and its design specification exceeds the allowed tolerance a user is directed to make an adjustment to the associated cassette or working point fixture. The process is repeated until the alignment of the X axis is within the allowed tolerance.

By knowing the orientation of the X axis of the vertical working point reference frame 2300 both the Y axis and the roll axis are known as well. Robot unit 110 adjusts its roll axis to align end effector 112 parallel to the X axis of the vertical working point reference frame 2300. This can be done by comparing the roll axis of the robot unit 110 in the vertical working point reference frame 2300 to its X axis and making a corresponding adjustment to the roll axis in the vertical working point reference frame 2300. Robot unit 110 now moves back to a point just to the left of point VWX2, VWY2 and then moves right until the disk is detected at the VWY0 plane. Robot unit 110 now moves along the Y axis until it is detected at the VWYref plane. This establishes point VWX2, VWY3. The precise distance between the VWY0 plane and the VWYref plane is known and is VWYref. The difference between points VWX2, VWY2 and VWX2, VWY3 is the distance VWYref−D where D is the diameter of the disk in end effector 112. Thus the orientation of the X and Y axes of the vertical working point reference frame 2300 relative to the vertical fixed reference frame 1700 as well as the measured value of D are determined. The origin of the Y axis of the vertical working point reference frame 2300 is also known. It is located at Y coordinate (VWY2+VWY3)/2 and is labeled VWY0.

Execution proceeds to step 382 wherein the Z axis of the vertical working point reference frame 2300 is established.

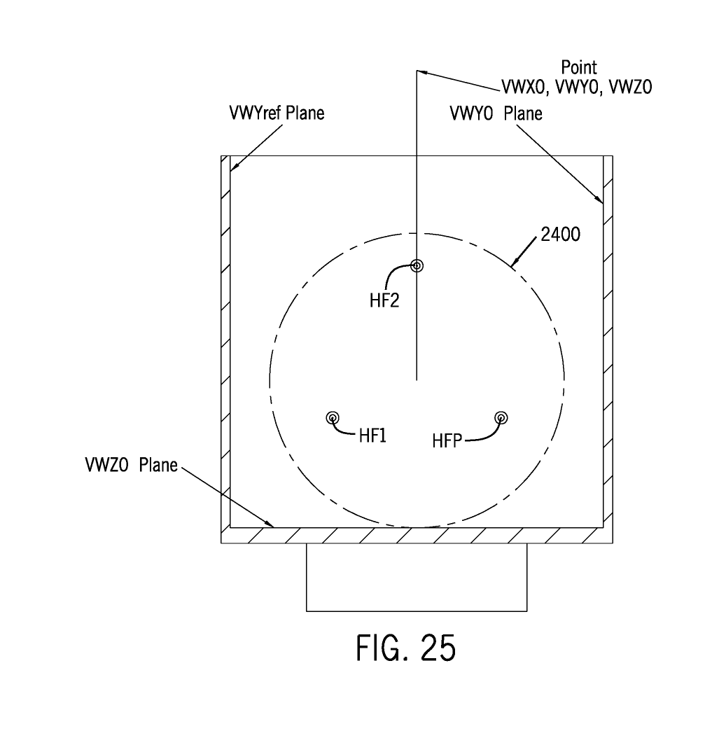

FIG. 25 depicts a cross-sectional view of vertical working point reference frame 2300 along line 25-25 in FIG. 24 wherein disk 2400 is shown in end effector 112 in the vertical down position (plane). Robot unit 110 moves to point VWX2, VWY0. It then moves down until the disk is detected at the VWZ0 plane. Robot unit 110 moves up and then moves to point VWX1, VWY0. It then moves down until the disk is detected at the VWZ0 plane. The distance between the coordinates VWX2 and VWX1 is precisely known. This along with the difference between the two detected Z coordinates establishes the pitch of vertical working point reference frame 2300 from front to back. If the pitch exceeds the allowed tolerance a user is directed to make an adjustment to associated frame 2300 (cassette or working point fixture). The process is repeated until the alignment of the Z axis is within the allowed tolerance.

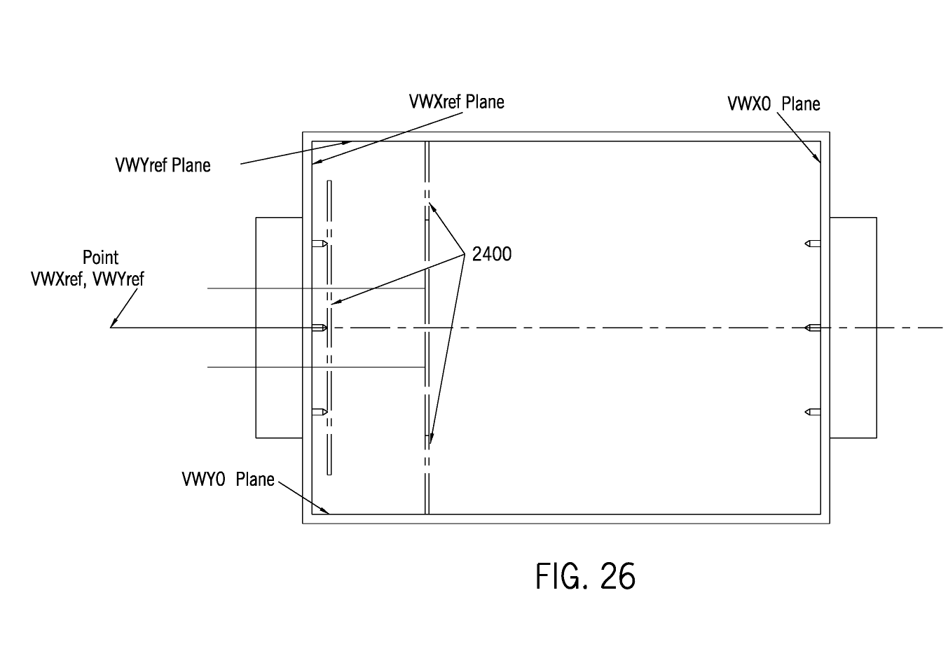

Execution proceeds to step 384 wherein the origin of the X axis is established. FIG. 26 depicts another top view of the frame 2300 in FIG. 23 wherein disk 2400 is shown held in end effector 112 in the vertical down position (plane) in two locations. Knowing the exact orientation of the Z axis of vertical working point reference frame 2300, and knowing the vertical fixed reference frame 2300 pitch axis from step 316, and in the case where end effector 112 has a pitch axis controller, end effector 112 is adjusted so it's vertical pitch axis is exactly parallel to the Z axis of the vertical working point reference frame 2300. In FIG. 24, robot unit 110 moves to point VWX2, VWY0 and moves in the −X direction until it is detected at the VWX0 plane. This establishes the origin of the X axis in vertical working point reference frame 2300 and is labeled VWX0.

Execution proceeds to step 386 wherein the origin of the Z axis of vertical working point reference frame 2300 is established.

In FIG. 26, robot unit 110 moves to point VWX0, VWY0 and moves a short distance in the +X direction. It then moves down until the disk is detected at the VWZ0 plane. This establishes the origin of the Z axis of vertical working point reference frame 2300 and is labeled VWZ0. The complete point VWX0, VWY0, VWZ0 corresponds to the origin in vertical working point reference frame 2300 and is the first location in an array of pick and place points for disk 2400 in the vertical down position (plane).

Execution proceeds to step 388 wherein the VWXref, VWYref and VWZref coordinates of vertical working point reference frame 2300 is established.

FIG. 26 depicts a top view of vertical working point reference frame 2300 in FIG. 23. The precise distance between the VWX0 plane and the VWXref plane is known. Robot unit 110 moves to the Y coordinate VWYref (which is calculated) at a location just short of VWXref (which is also calculated). Robot unit 110 moves in the −Y direction until it is detected at the VWY0 plane. It then moves in the +Y direction until it is detected at the VWYref plane. The midpoint of the two Y coordinates should match precisely the Y coordinate VWYref. If the two Y coordinates differ then the newly calculated mid-point of the −Y and +Y locations is taken as the correct VWYref.

The robot unit 110 moves to the Y coordinate VWYref and to the X coordinate just short of VWXref. It then moves in the −X direction until the disk is detected at the VWXref plane by sensors VWPref, VW1ref and VW2ref. The X coordinate of this location should match exactly the calculated coordinate VWXref. If the two X coordinates differ then the newly measured X coordinate is taken as the correct VWXref.

Robot unit 110 moves a short distance in the +X direction and then moves down until the disk is detected at the VWZ plane. This sets the VWZref coordinate. The point VWXref, VWYref, VWZref corresponds to the location in vertical working point reference frame 2300 of the last location in an array of pick and place points.

Execution proceeds to step 390 wherein end effector 112 calibration and vertical working point reference frame 2300 for reverse pick and place operations are established.

Frequently pick and place operations for a disk in the vertical down plane must be performed at a roll orientation of 180 degrees from the normal pick and place operations. These are called reverse points. Separate end effector 112 calibrations and vertical working point reference frames must be established for these operations. To do this, steps 314-328 are repeated, but with end effector rotated 180 degrees around the Z axis.

Execution proceeds to step 392 wherein all end effector 112 calibrations and vertical working point reference frame 2300 coordinate values relative to the robot unit 110's natural coordinates are stored.

This completes steps 380-392 (step 226 in FIG. 2B), the calibration of end effector 112 and the determination of the vertical working point reference frame 2300.

As indicated above, steps 216 and 222 cause steps 218-220 and steps 224-226 to repeat until all working points have been calibrated.

Then, as indicated above, step 228 is executed. In that step, a working point transform map associating each of the working points in workcell 102 to end effector 112 calibrations and reference frames is created.

Once a complete workcell 102 setup has been completed and the working point transformational map is established, it is then possible to abbreviate the point teaching process that may be needed should an equipment replacement or equipment wear occur.

As indicated above, steps 230-236 in FIG. 2A-2D are executed. In brief, one or more working points are updated if they have changed. If an adjustment is required because one or more working points have changed, then only steps 220, 226 and 228 need be performed and only for the particular working points affected. In addition, end effector 112 calibrations and reference frames coordinates are updated if they have changed. If a change should occur to robot unit 110 or end effector 112 the precise effect of the change can be determined by repeating steps 200-214 and then comparing the new end effector 112 calibrations and reference frame coordinates to the previous ones. The differences can then be used to calculate the appropriate changes to all affected working points without having to re-teach those working points.

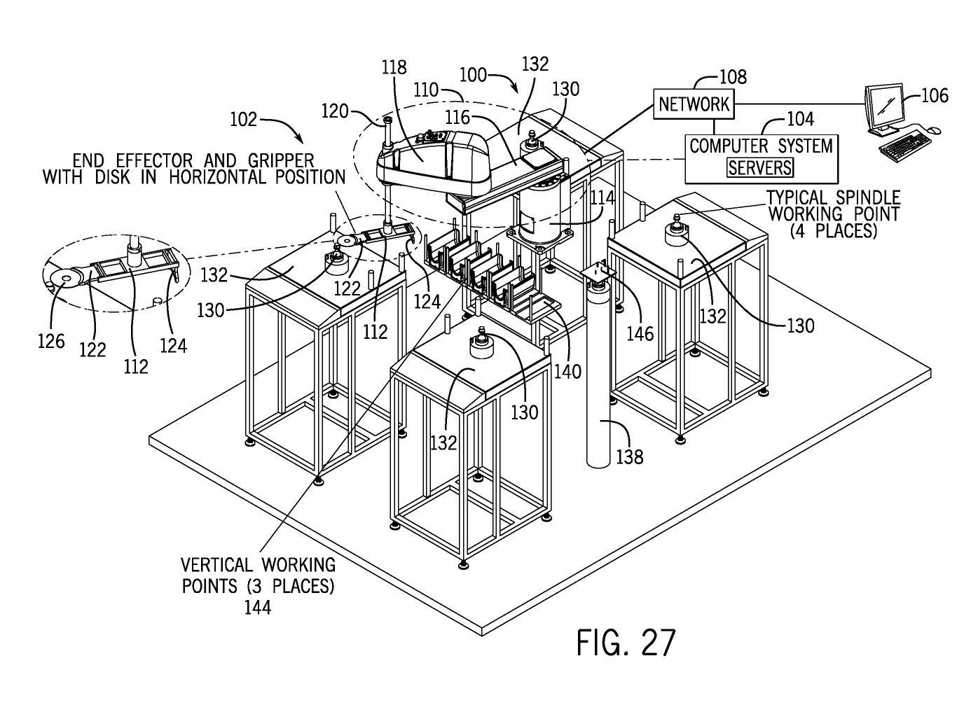

FIG. 27 depicts a perspective view of another example system 100 in which the method for autonomously teaching working points in robotic disk test apparatus 102 operates. The same reference numerals as shown in FIG. 1 and described above will be used for the same components. As described above, robot disk test apparatus 102 is a workcell (hereinafter workcell 102) that is configured for processing disks during manufacture. That is, workcell 102 is designed to handle or transport the disks to and from several working points (described below) within workcell 102. Workcell 102 is described in more detail below. As known to those skilled in the art, disks are storage mechanisms where data are recorded (e.g., hard disk drives or HDD). Disks may also be referred to as disk media, media or substrates as described above.

As described above, the method for autonomously teaching working points in workcell 102 may be employed during initial setup and commissioning of apparatus 102, repair or replacement of one or more components of workcell 102 which changes disk pick or place locations and point drift in which one or more components in apparatus 102 suffers wear or degradation which changes one or more disk pick or place locations.

Similarly shown in FIG. 1, system 100 includes robotic disk test workcell 102, computer system 104 and client 106. Computer system 104 and client 106 may communicate with workcell 102 components directly (line) or via network 106 (dashed line). This is described in more detail below. Network 108 may be a LAN and/or Internet as known to those skilled in the art. The communication may be wired or wireless via WIFI or other wireless protocol.

Computer system 104 comprises a robot control computer and a cell control computer. The robot control computer is typically provided with a commercially available robot unit (described below) and it is designed to communicate with the robot unit (described below) directly or over network 108 (as described above) to control motion and manipulate the robot unit for tasks as known to those skilled in the art. The robot control computer may be a dedicated box or a server incorporating a processor, memory, storage, operating system (e.g., Microsoft Windows, Unix or QNX), interfaces and other components similar to a computer as known to those skilled in the art. The cell control computer is a high level computer that may be employed for controlling the robot control computer and/or performing other operations as known to those skilled in the art. The cell control computer comprises one or one or more servers, each of which typically includes one or more processors, memory, storage, video cards, interfaces, operating systems such as Microsoft Windows, Apple OS, Linux etc. and other components as known to those skilled in the art. The method for autonomously teaching working points in a robotic disk test workcell 102 may be implemented by the robot control computer and/or the cell control unit. For simplicity, computer system 104 will be used hereinafter to refer to the robot control computer and/or the cell control computer.

Client 106 may be a personal computer and a monitor or alternatively a mobile device such as smartphone, cellular telephone, tablet, PDA, or other devices equipped with industry standard (e.g., HTML, HTTP etc.) browsers or any other application having wired (e.g., Ethernet) or wireless access (e.g., cellular, Bluetooth, RF, WIFI such as IEEE 802.11b etc.) via networking (e.g., TCP/IP) to nearby and/or remote computers, peripherals, and appliances, etc. TCP/IP (transfer control protocol/Internet protocol) is the most common means of communication today between clients or between clients and systems (servers), each client having an internal TCP/IP/hardware protocol stack, where the “hardware” portion of the protocol stack could be Ethernet, Token Ring, Bluetooth, IEEE 802.11b, or whatever software protocol is needed to facilitate the transfer of IP packets over a local area network. Each client, i.e., personal computer and mobile device, typically includes a processor, memory, storage, interface, operating systems (e.g., Microsoft Windows, Apple OS, Linux etc. for the personal computer or iOS, Android etc. for a mobile device) and other components as known to those skilled in the art. Client 106 also includes a display.

A user may control the operation of a robot unit 110 (described below) of workcell 102 via client 106 and computer system 104 to move a disk to and from various points in workcell 102. The method for autonomously teaching working points in a robotic disk test workcell 102 is implemented by computer system 104.

As described above with respect to FIG. 1, workcell 102 comprises robot unit 110 that is configured to move end effector 112 to various locations around workcell 102. In brief, robot unit 110 includes fixed base 114, (rotary drive shaft within base 114), upper drive arm 116, outer drive arm 118 and drive rod 120 (also known as a quill). Base 114 is supported by a stand or other framework as known to those skilled in the art (not shown). Upper drive arm 116, at one end thereof, is mounted to rotary drive shaft (at the shoulder of base 116) to enable upper drive arm 116 to move within a large rotation as known to those skilled in the art. Outer drive arm 118 is mounted to the other end of upper drive arm 116. Outer drive arm 118 is configured to move within a large rotation with respect to drive arm 116 as known to those skilled in the art. Drive rod 120 is mounted within a bore or channel in outer drive arm 118 and configured to rotate (roll axis) as well as move vertically (Z axis) with respect to outer drive arm 118 to move end effector 112 in multiple positions and directions. (The measurement from the center of rod 114 and center of disk 126 is known as describe in more detail below.) Robot unit 110 is typically a commercially available robot known as a selective compliance assembly robot arm (SCARA) as known to those skilled in the art. However, those skilled in the art know that any robot unit may be employed to achieve desired results.

As indicated above, workcell 102 further comprises end effector 112 that is used to manipulate and control movement of grippers 122, 124 (e.g., paddle or any other mechanical grasping mechanism) as known to those skilled in the art. Grippers 122 and 124 are attached at the distal ends of end effector 112 and are each adapted to pivot from a horizontal position to a vertical (pitch down) position. Each gripper 122, 124 includes a sensor known to those skilled in the art and described below. As shown in FIG. 27, gripper 122 extends in a horizontal position (with disk) and gripper 124 extends in a vertical (pitch down) position. (As discussed below, end effector may include a pitch axis controller (not shown) as known to those skilled in the art.) For purposes of this disclosure, any commercially end effector may be employed in workcell 102. Examples include Vacuum End-Effector previously marketed and sold by Applied Robotic Technologies, Inc.

As indicated above, end effector 112 includes grippers 122 and 124. Grippers 122 and 124 are each configured to grasp a disk so it can be transported to various points in workcell 102 as known to those skilled in the art. Grippers 122 and 124 each comprise opposing gripper elements adapted to grasp an individual disk as known to those skilled in the art. Vacuum functionality may also be employed to ensure that the disk does not dislodge from the gripper itself as known to those skilled in the art. For purposes of implementing the method for autonomously teaching working points in a robotic disk test workcell 102, any gripper or other grasping mechanism known to those skilled in the art may be employed. Examples include Vacuum Paddle previously marketed and sold by Applied Robotic Technologies, Inc.

Gripper 122 contains a through-beam sensor 122-1. Sensor 122-1 is in the horizontal plane and is at right angles to a line connecting the center of the robot quill 120 to the center of a disk 126 held in gripper 122.

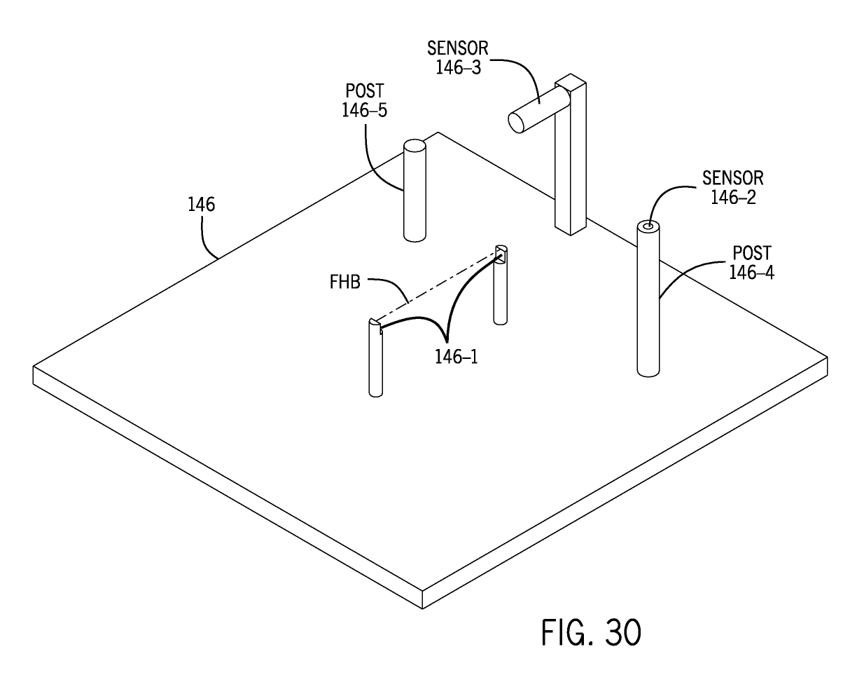

Workcell 102 further comprises a horizontal working point fixed reference frame 146. As shown in FIG. 30 and as described in more detail below, reference frame 146 is (a fixture) used for implementing the method for autonomously teaching points in robotic disk test workcell 102 disclosed herein. The fixed reference frame 146 is mounted to pole 138 at a working level. Fixed reference frame 146 includes a plate with one through-beam sensor 146-1, two proximity sensors 146-2 and 146-3 (integrated) and two fixed vertical posts 146-4 and 146-5. These sensors are configured to sense the movement and position of disk 126. The sensors are connected (wired) to computer system 104 (directly or via network 108) through a commercially available digital I/O board or other means as known to those skilled in the art.

As shown in FIG. 30 (and described in more detail below), sensor 146-1 is mounted in the horizontal plane and is used to detect the position of disk 126 in the vertical (pitch down) position. Specifically, sensor 146-1 comprises dual sensor points (integrated) atop respective posts that create a fixed horizontal beam (FHB) as known to those skilled in the art. Sensor 146-2 is mounted in the vertical plane atop post 146-4 and is used to detect disk 126 in the horizontal position. Sensor 146-3 is mounted in the horizontal plane (atop a rectangular bar) and is used to detect disk 126 in the vertical (pitch down) position. The precise locations and distances between the various sensors and posts are known.

Workcell 102 further comprises several horizontal working points 130 at various locations in the workcell 102 space. Several tables 132 typically support the horizontal working point 130 structures as known to those skilled in the art. In operation, disks are processed and tested at these horizontal working points 130 as known to those skilled in the art. In brief, a typical horizontal working point 130 is a spindle that is sized to snugly fit within a hole in disk 126 for subsequent testing. In the embodiment shown in FIG. 27, there are four horizontal working points 130. However, those skilled in the art know that workcell 102 may incorporate any number of working points (locations) for disk transport and testing.

Workcell 102 further includes vertical working points 144 at various locations in the workcell 102 space. Vertical working points 144 are typically cassettes, each storing one or more disks as known to those skilled in the art. In the example system shown, these vertical working points 144 are positioned adjacent to fixed reference frame 146 and fixed to a stand or other structure (not shown) as known those skilled in the art. In operation, a disk is retrieved from one of the vertical working points 144 (cassettes), processed and tested and returned to the same or different working point 144 (cassette). FIG. 27 also depicts another (fifth) working point 140 that is affixed adjacent vertical working points 144. This working point 140 is shown as a cassette nest, i.e., vertical frame (without the cassette) for illustration purposes and discussion below. In the example depicted in FIG. 27, there are four actual working points 144 (along with a cassette nest 140 as a fifth working point, but the actual box is not shown in FIG. 27). However, those skilled in the art know that workcell 102 may incorporate any number of vertical working points (locations) for disk storage and retrieval.

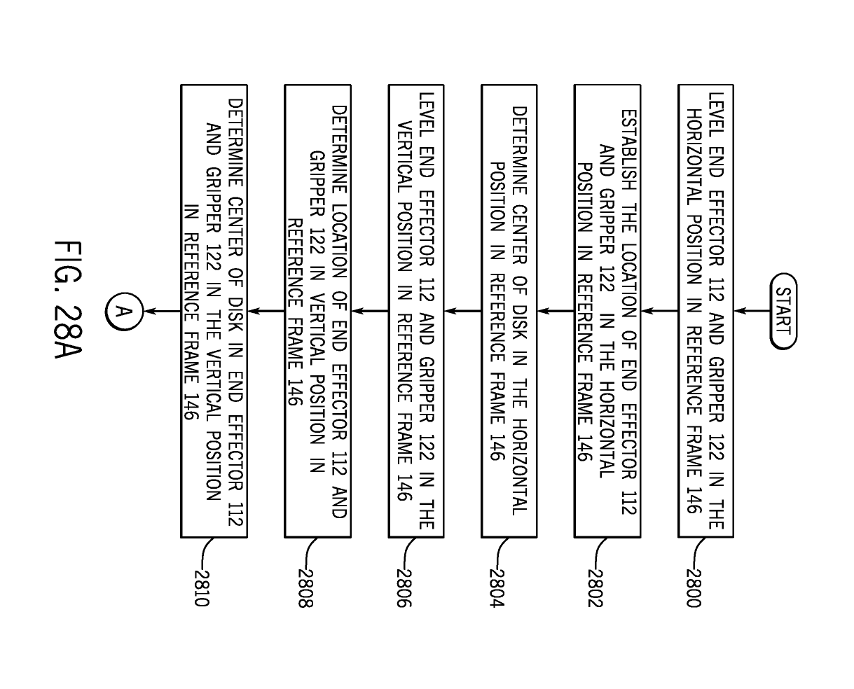

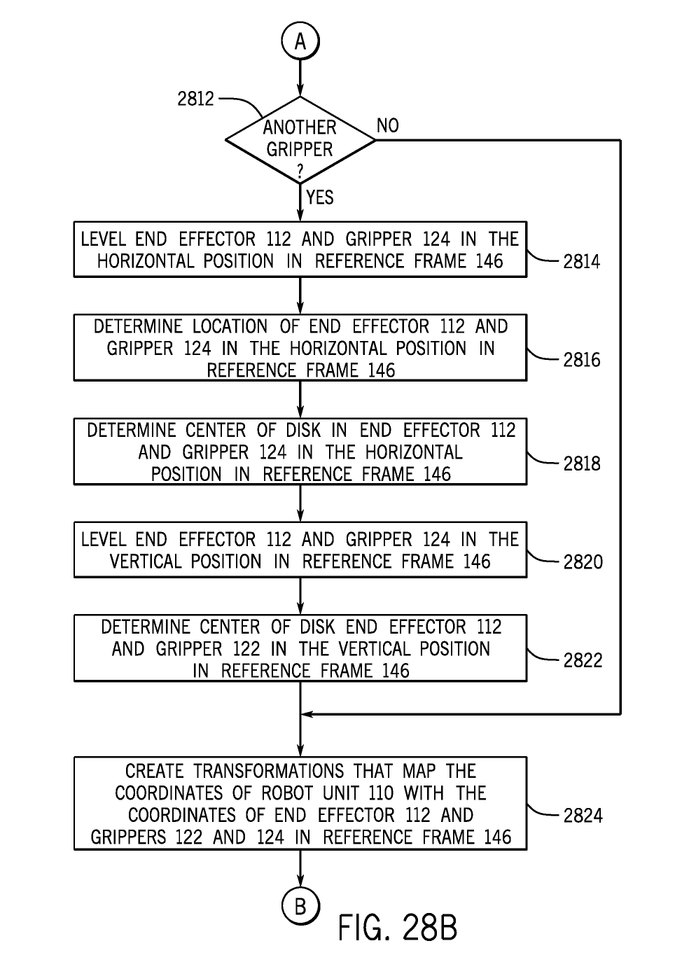

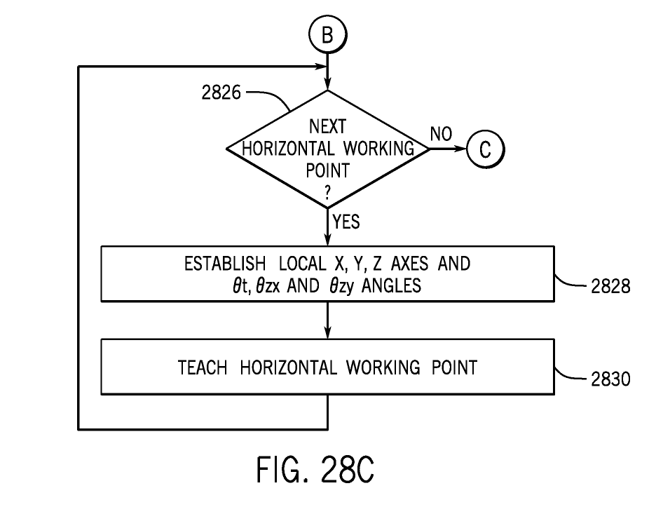

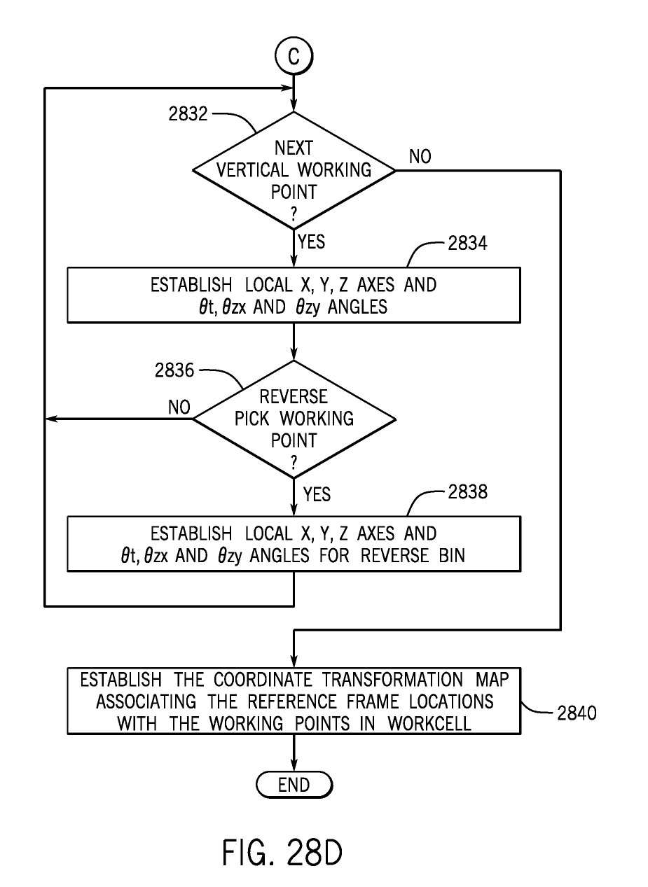

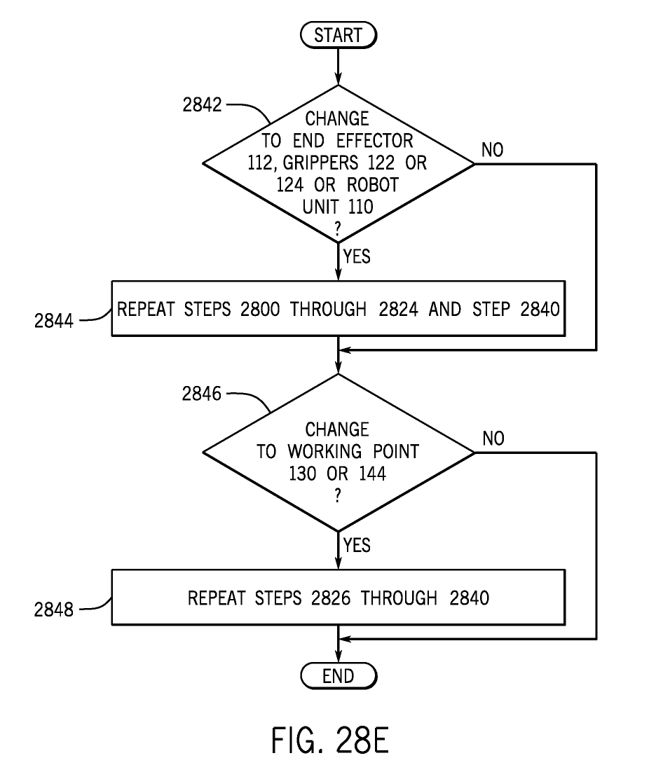

Reference is made to FIGS. 28A-28E. FIGS. 28A-28E depict another high-level example method steps for autonomously teaching working points in a robotic disk test apparatus 102.

Execution begins at step 2800 wherein end effector 112 (gripper 122) is in a horizontal position (true-up) with respect to fixed frame of reference 146 in FIG. 27. In short, end effector 112 and gripper 122 are trued up for disk 126 in the horizontal position. The roll, pitch and yaw angles of disk in end effector 112 (gripper 122) are made plumb and level.

Execution proceeds to step 2802 wherein the location of end effector 112 (gripper 122) in the horizontal position is determined. In short, the true X, Y and Z axes for disk 126 in the horizontal plane are uncovered.

Execution proceeds to step 2804 wherein the center of disk 126 in the horizontal position is determined. At this juncture in the method, robot unit 110 is directed to move around over vertical sensor 146-2. With everything plumb, level and aligned, sensor 146-2 enables robot unit 110 to precisely calculate the exact center of the hole in the of disk 126 in end effector 112 (gripper 122).

In sum, steps 2800-2804 trues up end effector 112, has the robot unit 110 determine the directions and origins of the X, Y and Z axes and then finds the exact center of disk 126 held by end effector 112 and disk's 126 precise location relative to fixed reference frame 146 in workcell 102.

Execution proceeds to step 2806 wherein end effector 112 (gripper 122) is leveled in the pitch down position with respect to fixed reference frame 146. In short, the true X, Y and Z axes for disk 126 in the vertical, pitch down position are determined. (That is, this step trues up disk 126 in a pitch down position in end effector 112.) This makes sure the face of disk 126 is pointing in the correct direction and is truly vertical. (As described in more detail below, robot unit 110 moves disk 126 around until it is perpendicular to sensor 146-3 in both the vertical and horizontal directions within reference frame 146.)

Execution proceeds to step 2808 wherein the location of end effector 112 (gripper 122) in the pitch down position. In short, the true X, Y and Z axes for disk 126 in the vertical, pitch down position are uncovered.

Execution proceeds to step 2810 wherein the center of disk 126 in the pitch down position is determined (similar to step 2804). In this step, the coordinates of the disk are established in the vertical plane.

Execution then proceeds to decision step 2812 wherein it is determined if there is another gripper (with disk), i.e., a second gripper 124. At this stage, second gripper 124 of end effector 112 requires calibration similar to first gripper 122.

If the answer is yes, execution proceeds to step 2814. If the answer is no, execution proceeds to step 2824 wherein transformations are created that map coordinates of robot unit 110 with the coordinates of grippers 122, 124. That is, the step creates the coordinate transformation that relates to the coordinates in the native robot unit 110's coordinate system to the coordinates of the reference frames created in the prior steps.

Execution proceeds to decision step 2826 wherein it is determined if there are any additional horizontal working points 130. If the answer is yes, execution proceeds to step 2828. If the answer is no, execution proceeds to step 2832.

In step 2828, the local axes (X, Y, and Z) and angles (θt, θzx, and θzy) of horizontal working point 130 are determined. If it is determined that any of the axes or angles of a spindle working point 130 lie outside the tolerances established during the design of workcell 102, no adjustment is made to end effector 112. Rather, a user is notified that the working point is out of tolerance and the corresponding spindle requires adjustment, either in its X, Y or Z coordinates or in its angular (θt, θzx, and θzy) orientations. Step 2828 is repeated until all coordinates and angles are within specification.

Execution proceeds to step 2830 wherein end effector 112 in a horizontal position at the first working point 130 is taught.

Execution returns to step 2826 where it is determined if there are any additional horizontal working points 130. If there are, steps 2828 and 2830 are repeated for each additional horizontal working point 130.

If there are no more horizontal working points to be taught, execution proceeds to step 2832 where it is determined if there are any vertical working points to be taught. If the answer is yes, execution proceeds to step 2834. If the answer is no, execution proceeds to step 2838.

In step 2834 the local axes (X, Y, and Z) and angles (θt, θzx, and θzy) of vertical working point 144 are determined. If it is determined that any of the axes or angles of vertical working point 144 lie outside the tolerances established during the design of workcell 102, no adjustment is made to end effector 112. Rather, a user is notified that the working point is out of tolerance and the corresponding cassette nest requires adjustment either in its coordinates (X, Y or Z) or in its angular orientations (θt, θzx, and θzy). Step 2834 is repeated until all coordinates and angles are within specification and the coordinates of vertical working point 144 are stored.

Execution proceeds to step 2836 where it is determined if there is the need to determine reverse pick coordinates. If reverse pick coordinates are needed, execution proceeds to step 2638 where the coordinates for the vertical working point 144 are determined for a reverse pick and place operation.

Execution returns to step 2832 where it is determined if there are any additional vertical working points 144. If there are, steps 2834 through 2838 are repeated for each additional vertical working point 144.

Once all vertical working points have been taught, execution proceeds to step 2840 wherein a coordinate transformation map (table) is established that associates the coordinates of the fixed reference frame locations with the coordinates of working points 130 and 144 in workcell 102. That is, coordinate system transformations between the reference frames and location established in steps 2800 through 2824 and the various working points 130 and 144 established in steps 2828 through 2838 are computed. Robot unit 110 knows the exact six degree of freedom vectors (i.e., X, Y, Z, theta, pitch and roll) between each working point 130 and 144 location and its corresponding reference frame location.

This completes the initial setup of workcell 102 in which all reference frame 146 locations and all working point 130, 144 locations are taught.

During the course of operation or maintenance of workcell 102 one or more locations or calibrations used in workcell 102 may change. If so, the next steps (in FIG. 28E) are executed.

Execution begins at decision step 2842 wherein it is determined if one or more changes have been made to end effector 112, grippers 122 or 124 or to robot unit 110. If so, then execution proceeds to step 2844 wherein steps 2800 through 2824 and step 2840 are repeated.

Execution proceeds to decision step 2846 which determines if one or more changes have occurred to a working point 130 or 144. If so, then execution proceeds to step 2848 wherein steps 2826 through 2840 are repeated and execution ends. If there are no changes, execution also ends.

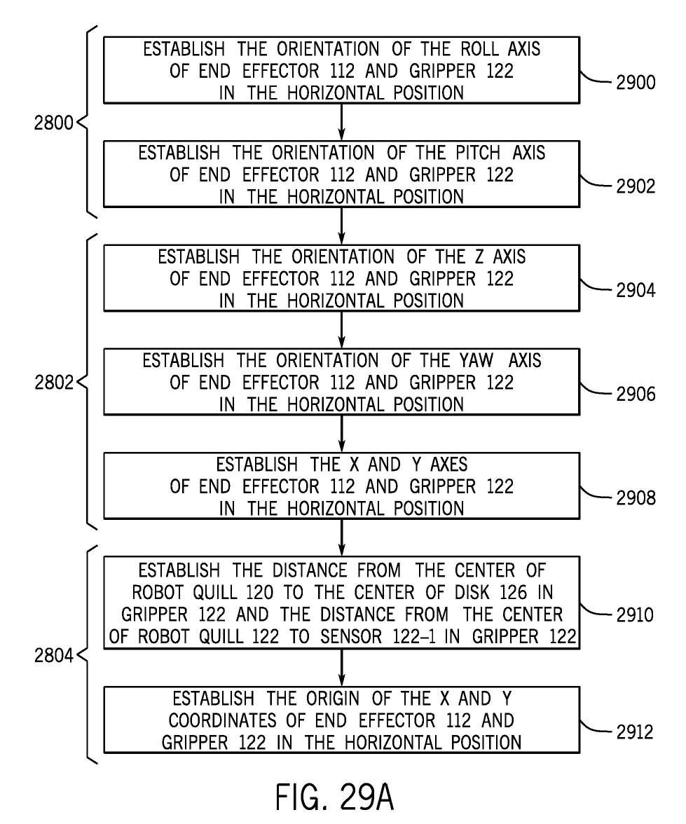

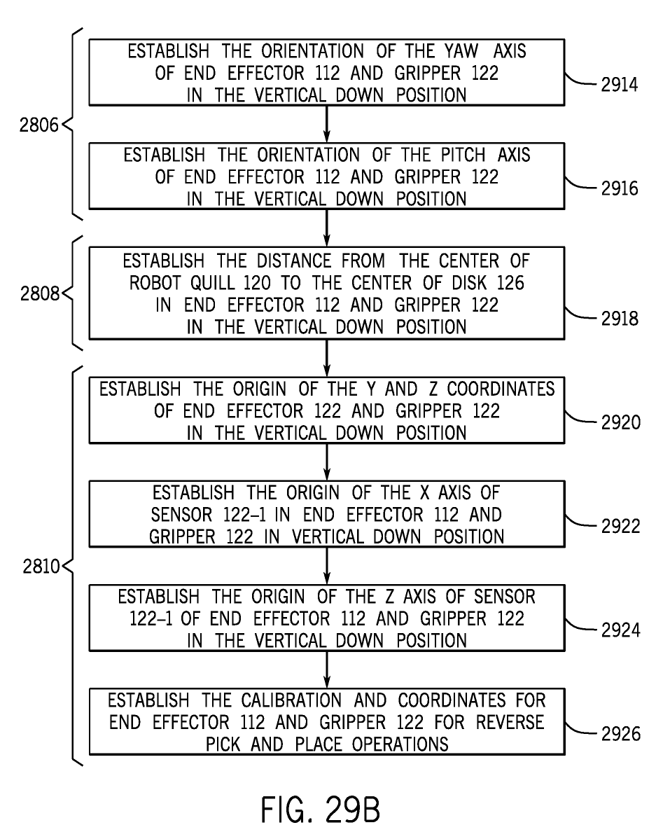

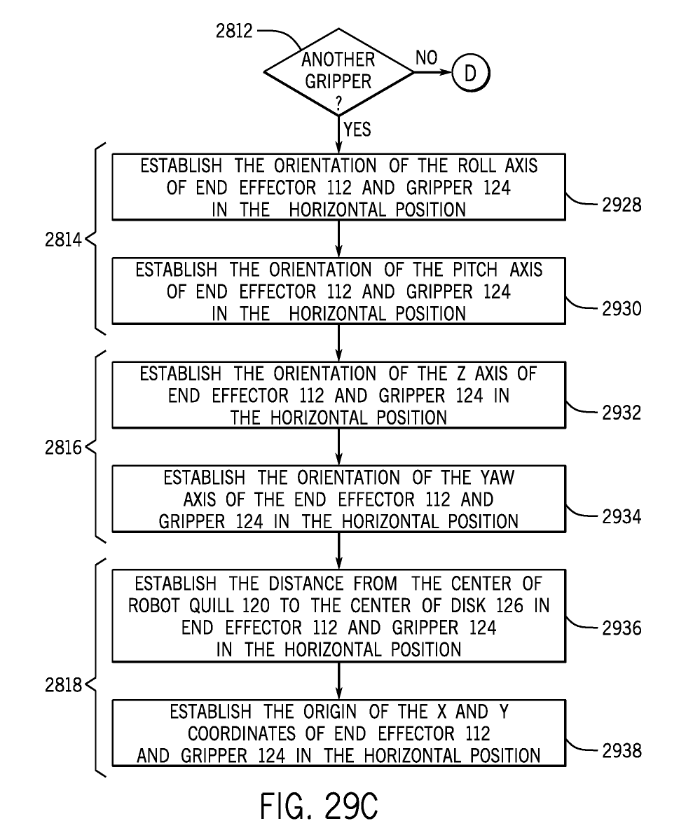

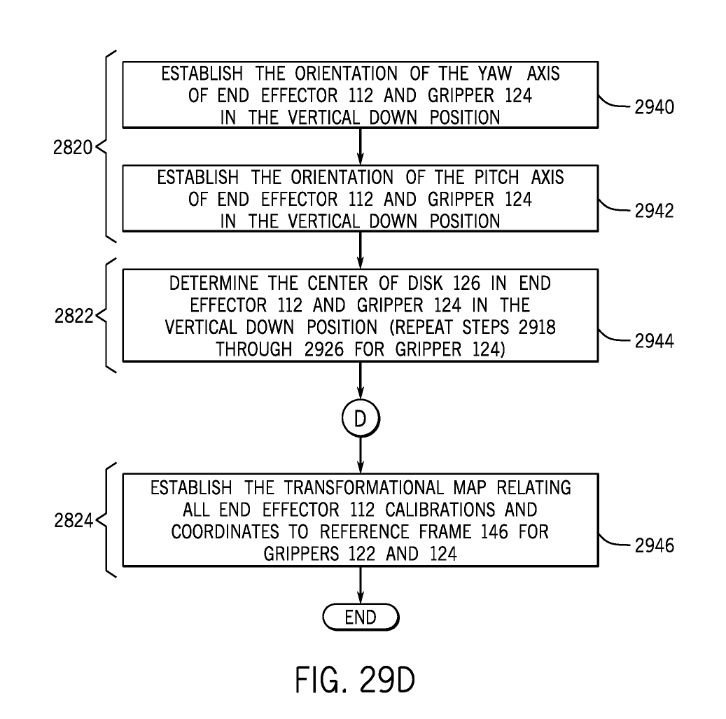

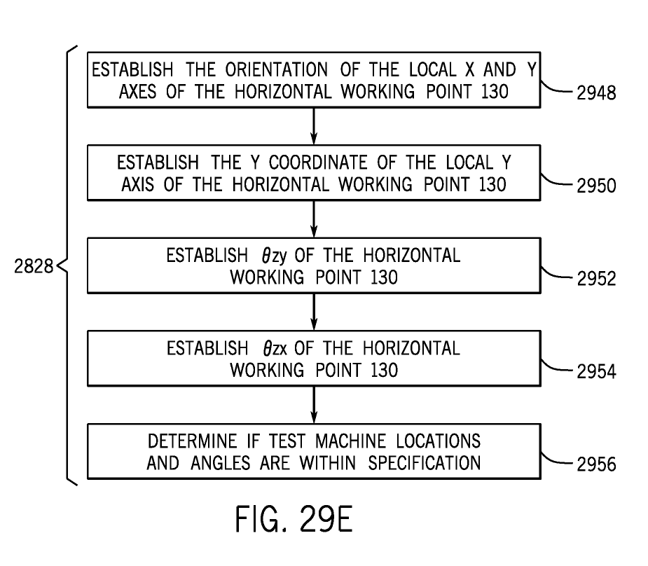

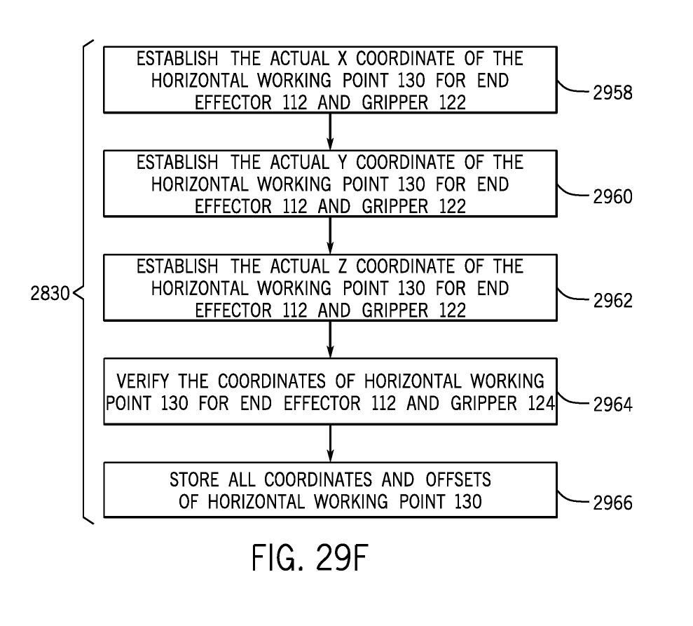

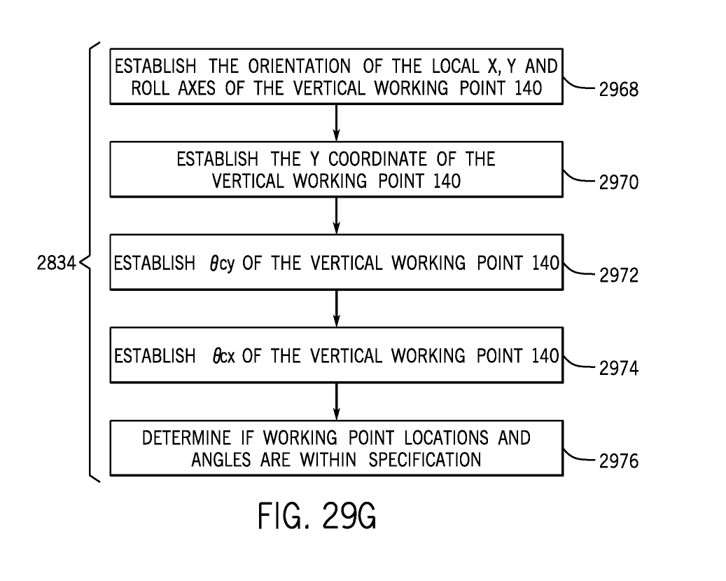

FIGS. 29A-29G depict another detailed-level example method steps for autonomously teaching horizontal working points 130 and vertical working points 144 in robotic disk test workcell 102 (in accordance with the system depicted in FIG. 27). (Note that these steps are detailed steps for (most of) the steps in FIGS. 28A-28E. Therefore, the high level steps in FIGS. 28A-28E will be identified as they correspond to the detailed steps in FIGS. 29A-29G.) Initially, calibration and fixed reference frame 146 coordinates for disk 126 are established. This action (generally refer to steps 2800-2804 in FIG. 28A) is performed during initial workcell 102 setup and commissioning and may be repeated any time a change or repair is made to robot unit 110, end effector 112 or grippers 122 or 124 which changes any of the adjustments and calibrations made below. Horizontal fixed reference frame 146 is shown in detail in FIG. 30 (in perspective).

Reference is now made to FIGS. 29A-29G. Steps 2900 and 2902 correspond to step 2800 in FIG. 28A.

In FIG. 29A in detail, execution begins at step 2900 wherein the precise orientation of the roll axis of end effector 112 in the horizontal position is established. This is typically a mechanical adjustment performed on gripper 122 (disk 126 holding mechanism) of an end effector 112 to level it in the left/right direction. (In brief, the gripper is translated side to side, the disk detected by vertical sensor 146-2 and the gripper is moved/adjusted until the sensor detects the left and right sides of the disk at the same vertical Z coordinate.)

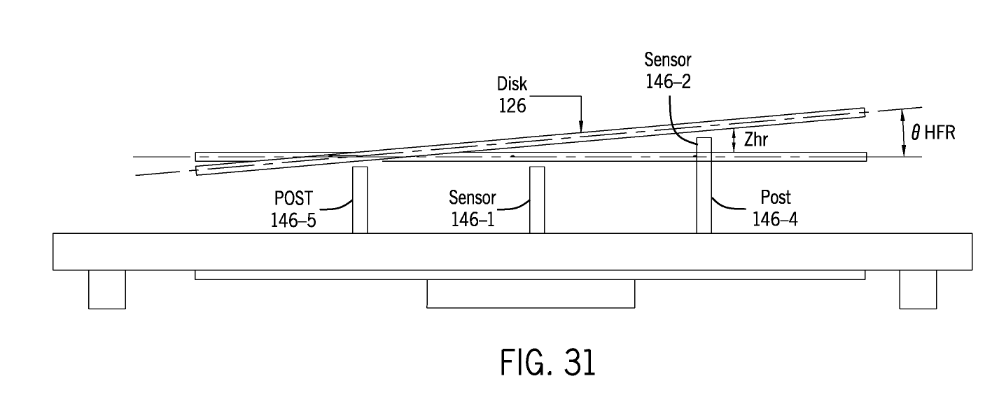

FIG. 31 depicts a front view of horizontal fixed reference frame 146 in FIG. 30 with two vertical posts 146-4 and 146-5, and sensor 146-2 which is embedded in the top of post 146-4 (sensor 146-3 not shown). Sensor 146-2 may be a contact or non-contact sensor as known to those skilled in the art. For example, the sensors may be proximity sensors, capacitive, inductive, optical, photo or reflective sensors (to name a few). The same applies to all sensors disclosed in this disclosure.

In FIG. 31, disk 126 is held (by end effector 112 and gripper 122) above sensor 146-2. FIG. 31 deliberately depicts the plane of disk 126 as being at an angle θHFR to true horizontal.

Except for robot unit 110 with an independent rotating axis in this plane, this operation is typically a manual mechanical adjustment to end effector 112 and/or gripper 122.

Robot unit 110 moves above sensor 146-2 with the right side of disk 126 above the post and then down until sensor 146-2 detects disk 126. Robot unit 110 then moves back up, and to the right by a fixed amount Y until the left side of disk 126 is above sensor 146-2. It then moves down until the sensor again detects disk 126.

The difference in the Z coordinates of the two measurements is Zhr. θHFR is determined by the formula Tan(θHFR)=(Zhr)/Y.

Computer System 104 displays this angle and directs the human to make an adjustment to end effector 112 or gripper 122 in a particular direction and by a particular amount. The process is repeated until Zhr is zero. In the manual case no further adjustment is necessary. In the case of a robot with an independent rotating axis in this plane, the offset coordinate is stored in computer system 104 and becomes one of end effector 112 calibration values.

Execution moves to step 2902 wherein the precise orientation of the pitch axis of end effector 112 in the horizontal position is established. (In brief, the gripper is translated front to back, the disk is detected by opposing sensors and the gripper is moved/adjusted until the disk is level front to back.)

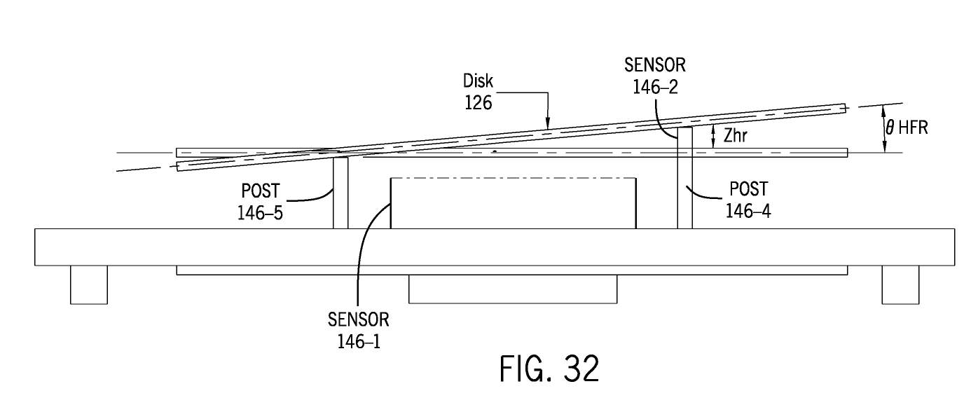

FIG. 32 depicts a side view of horizontal fixed reference frame 146 in FIG. 30. Specifically FIG. 32 shows a side view of an end effector 112 holding disk 126 above sensor 146-2. Robot unit 110 moves above sensor 146-2 and then down until sensor 146-2 detects disk 126. Robot unit 110 then moves back up, along the X axis by a fixed amount X, and then down until sensor 146-2 again detects disk 126. The difference in the Z coordinates is Zhp.

The angle θHFP is determined by the formula Tan(θHFP)=(Zhp)/X.

If end effector 112 does not have a servo pitch axis computer system 104 displays this angle and directs the human to make an adjustment to end effector 112 in a particular direction and by a particular amount.

If end effector 112 does have a servo pitch axis, computer system 104 makes the adjustment automatically. The process is repeated until Zhp is zero.

In the manual case no further adjustment is necessary. In the case of end effector 112 with a servo pitch axis the offset coordinate is stored in computer system 104 and becomes one of end effector 112 calibration values.

Because the raw X and Y axes in steps 2900 and 2902 may not be exactly aligned to the actual X and Y axes, steps 2900 and 2902 are repeated until both Zhr and Zhp are both zero in consecutive iterations.

Steps 2904-2908 correspond to step 2802 in FIG. 28A.

In detail, execution proceeds to step 2904 where the origin of the Z axis of horizontal fixed reference frame 146 for disk 126 in the horizontal position is established. (In brief, the elevation of the disk in the gripper is calculated.)

This is an outcome or result of completing steps 2900 and 2902. The Z coordinate of robot unit 110, when all three sensors Zhr and Zhp are zero simultaneously, establishes the origin of the Z axis of fixed reference frame 146 for disk 126 in gripper 122 in the horizontal position and is labeled HFZ0.

Execution proceeds to step 2906 wherein the precise orientation of the yaw axis of end effector 112 and gripper 122 for a disk in the horizontal position is established.

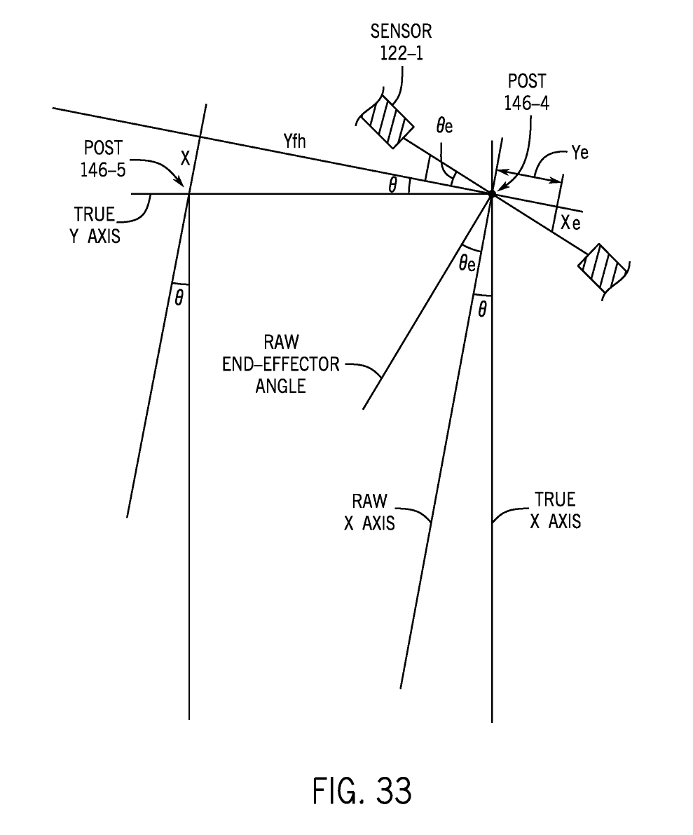

The yaw axis of gripper 122 is also known as the roll axis of a typical SCARA robot. FIG. 33 depicts an idealized schematic of a portion of a plan view of horizontal fixed reference frame 146 in FIG. 30 and depicts the two reference posts 146-4 and 146-5 (no disk shown in FIG. 33). The line connecting these two reference posts defines the Y axis of reference frame 146. The line at right angles to the Y axis at post 146-4 is the X axis of reference frame 146. This step is performed with no disk 126 in end effector 112 and uses sensor 122-1 in gripper 122 for all measurements. (Sensor 122-1 may be embedded in gripper 122 as known to those skilled in the art.)

In FIG. 33 it is assumed that the uncalibrated or raw X axis is at some angle θ to the true X axis of reference frame 146. It is further assumed that the uncalibrated or raw gripper 122 angle is at some non-zero angle θi to θ.

Robot unit 110 moves to the right side of the figure and then moves along its raw X axis until sensor 122-1 just detects post 146-4. It then moves in the +raw Y axis by a fixed amount Ye. It then moves in the raw X axis until sensor 122-1 again just detects post 146-4. It repeats this process moving in the −Raw Y axis a fixed amount Ye and then in the raw X axis until post 146-4 is again just detected. The difference in the X coordinates is Xe.

The difference in the X coordinates is Xe. The angle θe is determined by the equation sin(θe)=Xe/2Ye.

Robot unit 110 adjusts the roll angle of end effector 112 by this amount and repeats the process until Xe=0. End effector 112 and gripper 122 are now aligned along the raw X axis. The X coordinate of post 146-4 is recorded and is HFP1X.

Execution proceeds to step 2908 wherein the precise orientation of the X and Y axes of horizontal fixed reference frame 146 for disk 126 in the horizontal position is established. Robot unit 110 then moves in the raw X axis until post 146-5 is just detected. This X coordinate is HFP2X. The difference in the raw X coordinates HFP1X and HFP2X of the two measurements is X.

The angle θ is determined by the equation tan(θ)=X/Yfh.

Robot unit 110 adjusts its X and Y axes by this amount and also adjusts the roll axis by the same amount. The process is repeated until X=0. Robot unit 110 now knows the true directions of the X and Y axes of horizontal fixed reference frame 146 and the true roll angle of end effector 112 to align it precisely along the X axis.

Again referring to FIG. 33, with gripper 122 aligned to the raw X axis, robot unit 110 moves a precise distance Yfh in the raw Y axis. Yfh is the precise distance between post 146-4 and post 146-5.

The final value of the X coordinate of post 146-4, HFPX is stored. It will be used in a later step to determine the precise length Rhs from the center of robot quill 120 to sensor 122-1.

Steps 2910 and 2912 correspond to step 2804 in FIG. 28A.

Execution proceeds to step 2910 wherein the distance from the center of robot quill 120 to the center of disk 126 in gripper 122 is determined.

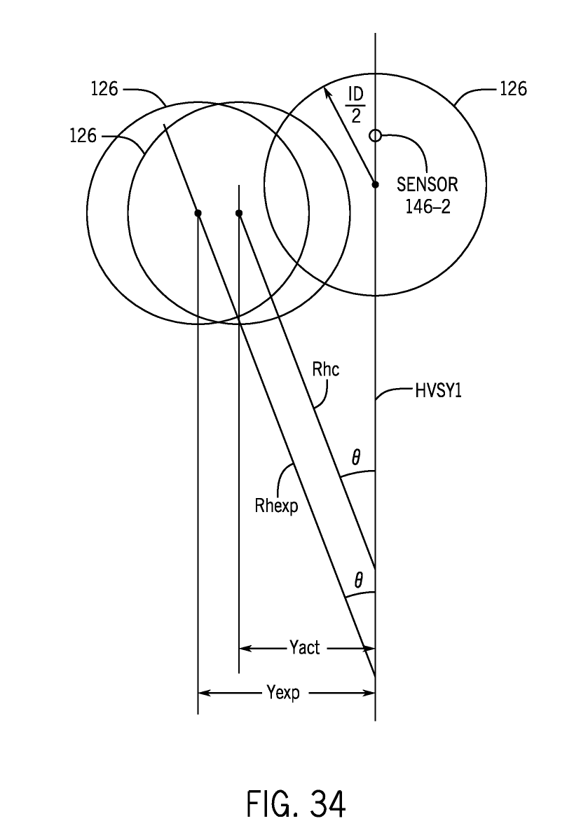

FIG. 34 depicts a plan view of (a part of) horizontal fixed reference frame 146 in FIG. 30 showing sensor 146-2 and disk 126 held in gripper 122. Only the central hole of disk 126 is depicted. At this point robot unit 110 does not know either the X or Y coordinates of the sensor 146-2.

Robot unit 110 moves to the right side of the figure with gripper 122 aligned along the X axis. Since robot unit 110 may be off in the Y direction, it moves left and right until the sensor 146-2 detects the two transitions of disk 126 ID (inner diameter). The average of the Y coordinates represents is HY1, the Y coordinate of sensor 146-2. Robot unit 110 moves along the Y axis to HY1.

With robot unit 110 at this fixed coordinate it rotates end effector 112 by a known angle θ. Based on the engineering designs of end effector 112 and gripper 122, we have an initial estimate for the distance from robot quill 120 to the center of disk 126 in gripper 122−Rhexp.

The amount the center of disk 126 has moved along the Y axis is Yexp is given by the formula Yexp=Rhexp*sin(θ).

Robot unit 110 moves along the Y axis by an amount −Yexp. Then moves back and forth along the Y axis until sensor 146-2 detects the two transitions of the ID of disk 126. The average of these two Y coordinates is HY2.

Let Yact=HY1−HY2. Since this amount is known, as is e, the actual distance from the center of robot quill 120 to the center of disk 126 held in gripper 122 is given by Rhc=Yact/sin(θ).

The precise distance along the X axis from post 146-4 to sensor 146-2 is known. With knowledge of the precise length Rhc and the previously measured X coordinate HFPX, the precise length Rhs from the center of robot quill 120 to sensor 122-1 is also thus now known.

Execution proceeds to step 2912 wherein the origin of the X and Y coordinates of fixed reference frame 146 is established.

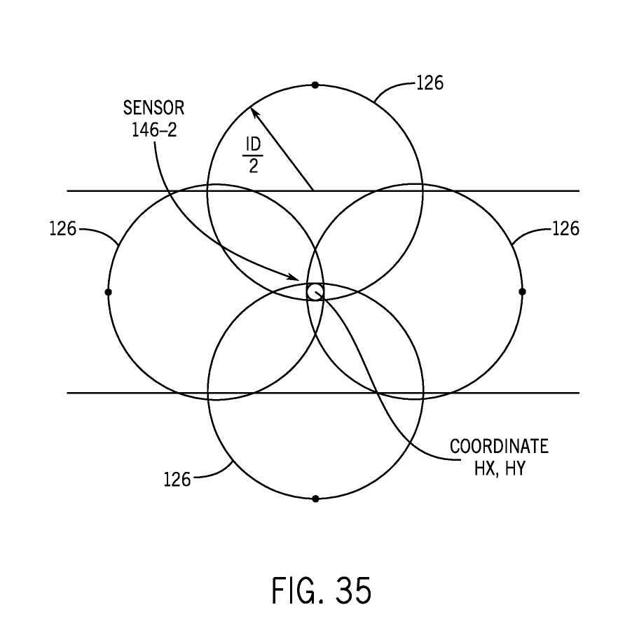

FIG. 35 depicts the top plan view of (a part of) horizontal fixed reference frame 146 in FIG. 30 with disk 126 (in gripper 122, but not shown) in four positions. Robot unit 110 moves to a region around sensor 146-2. It moves in the +X and −X directions until the sensor 146-2 detects the two edges of disk's 126 inner diameter. The average of these two X coordinates represents the X coordinate of sensor 146-2 and is HX.

Robot unit 110 moves to this X coordinate and then moves in the +Y and −Y directions until sensor 146-2 again detects the two edges of disk's 126 inner diameter. The average of these two Y coordinates represents the Y coordinate of sensor 146-2 and is HY.

Thus, the coordinate HX, HY is the true location of sensor 146-2. As an accuracy check, each of the four detection locations should all be the distance (ID-BD)/2 from location HX, HY. The process can be iterated if needed to improve the precision of the measurement HX, HY. (BD is a beam diameter of sensor 146-2 as shown in FIG. 35.)

Now, as discussed above, execution proceeds to step 2806 wherein end effector 112 and gripper 122 calibration and reference frame coordinates for disk 126 in the vertical down plane are established.

Steps 2914 and 2916 correspond to step 2806 in FIG. 28A.

Specifically, execution proceeds to step 2914 wherein the precise orientation of the yaw axis of end effector 112 and gripper 122 (the roll axis of the robot unit 110) in the vertical down position is established. (In brief, the gripper is translated laterally, the disk is detected by a sensor, and the gripper is moved/adjusted until the disk is detected in parallel by the sensor.)

The yaw axis of end effector 112 and gripper 122 typically corresponds to the roll axis of a SCARA or multi-axis robot and establishes the precise direction of a line originating at robot quill 120 and extending through the center of disk 126 held in end effector 112 in the vertical down position. This can be a mechanical adjustment of the mounting mechanism attaching end effector 112 to the vertical axis of robot unit 110, but more typically it is a programmed angular offset stored in computer system 104.

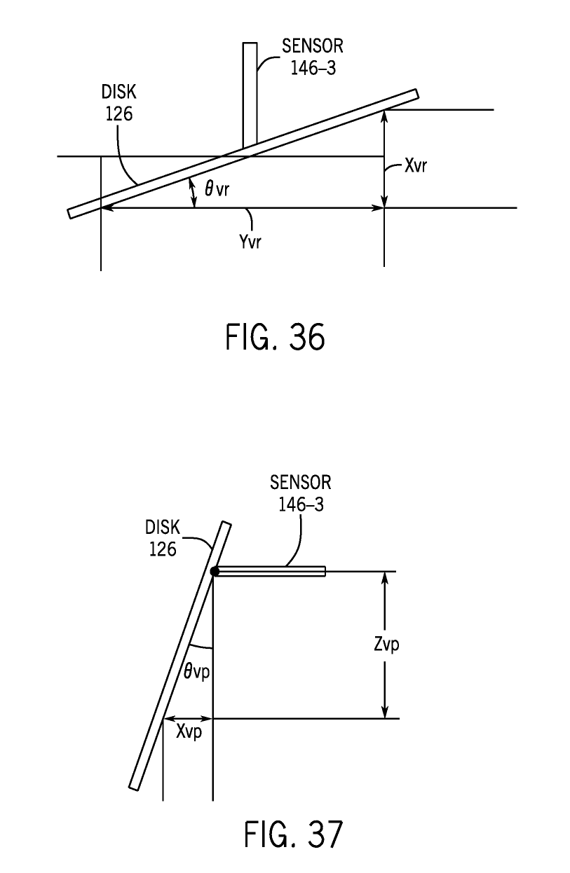

FIG. 36 is an idealized schematic of a portion of a plan view of horizontal fixed reference frame 146 in FIG. 30 showing sensor 146-3 and disk 126 in gripper 122. Disk 126 is deliberately shown at an angle θvr relative to the Y axis.

Robot unit 110 moves in front of sensor 146-3 and then forward along the X axis until sensor 146-3 detects disk 126. Robot unit 110 moves along the Y axis by a known amount Yvr. It then moves along the X axis until sensor 146-3 again detects disk 126. The difference in the X coordinates of the two measurements is Xvr.

The angle θvr is determined by the equation Tan(θvr)=Xvr/Yvr. This step is repeated until Xvr is zero. At this point end effector 112 and gripper 122 are aligned such that the surface of disk 126 is parallel to sensor 146-3 along the Y axis of fixed reference Frame 146.

Execution proceeds to step 2916 wherein the precise orientation of the pitch axis of end effector 112 and gripper 122 in the vertical down position are established.

FIG. 37 depicts an idealized schematic of a portion of side view of horizontal fixed reference frame 146 in FIG. 30. It depicts a side view of disk 126 held in an end effector 112 in the vertical down position in front of sensor 146-3. Robot unit 110 moves along the X axis until sensor 146-3 detects disk 126. Robot unit 110 moves along the Z axis by a known amount Zvp. It then moves along the X axis until sensor 146-3 again detects disk 126.

The difference in the X coordinates is Xvp. The angle θvp is determined by the equation Tan(θvp)=Xvp/Zvp.

In the case of an end effector 112 with mechanical stops, computer system 104 directs the human to make an adjustment to end effector 112 in a particular direction and by a particular amount. In the case of an end effector 112 with a servo pitch axis the offset coordinate is stored in the pitch axis controller and becomes one of end effector 112 calibration values. This step is repeated until the value of Xvp is zero. At this point the surface of disk 126 is parallel to sensor 146-3 along the Z axis of horizontal fixed reference frame 146.

Execution proceeds to step 2918 wherein the location of end effector 112 and gripper 122 are determined for disk 126 in the vertical down position

Step 2918 correspond corresponds to step 2808 in FIG. 28A.

In step 2918 the precise distance from the center of robot quill 120 to the center of disk 126 in the vertical down position is determined.

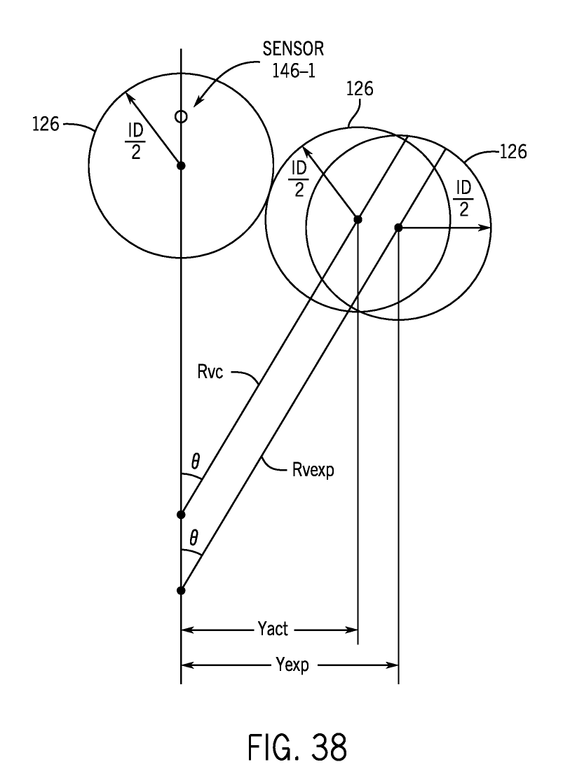

FIG. 38 depicts an idealized schematic of a portion of a plan view of horizontal fixed reference frame 146 in FIG. 30 showing the sensor 146-1 and disk 126 held in gripper 122. Only the central hole of disk 126 is depicted. At this point robot unit 110 does not know either the Y or Z coordinates of sensor 146-1. Thus, robot unit 110 moves to the right side of the figure with gripper 122 aligned along the X axis. It moves left and right along the Y axis until sensor 146-1 detects the two transitions of disk 126 ID (inner diameter). The average of the Y coordinates represents is VY1, the Y coordinate of sensor 146-1. Robot unit 110 moves along the Y axis to VY1.

With robot unit 110 at this fixed coordinate, robot unit 110 rotates end effector 112 by a known angle θ. Based on the engineering designs of end effector 112 and gripper 122, an initial estimate is known for the distance from robot quill 120, Rvexp.

The amount the center of disk 126 has moved along the Y axis is Yexp is given by the formula Yexp=Rvexp*sin(θ).

Robot unit 110 moves along the Y axis by an amount −Yexp. Then moves back and forth along the Y axis until sensor 146-1 detects the two transitions of the ID (inner diameter) of disk 126. The average of these two Y coordinates is VY2.

Let Yact=VY1−VY2. Since this amount is known, as is e, the actual distance from the center of robot quill 120 to the center of disk 126 held in gripper 122 is given by Rvc=Yact/sin(θ).

For improved accuracy and to eliminate any possible hysteresis in the through-beam sensor, this step can be repeated only this time end effector 112 is rotated by −θ.

Execution proceeds to step 2920 wherein the center of disk 126 in the vertical down position is determined in horizontal (fixed) reference frame 146.

Steps 2920 through 2926 correspond to step 2810 in FIG. 28A.

Execution proceeds to step 2920 wherein the origin of the Y and Z axes of the horizontal (fixed) reference frame 146 for a disk in the vertical down plane is established.

FIG. 39 depicts a front view of (part of) horizontal fixed reference frame 146 FIG. 30 with disk 126 in gripper 122 in four positions. Only the central hole of disk 126 is depicted. Robot unit 110 moves to a region around sensor 146-3. It moves in the +Y and −Y directions until sensor 146-3 detects the two edges of disk 126 ID (inner diameter). The average of these two Y coordinates represents the Y coordinate of sensor 146-3 and is VY.

Robot unit 110 moves to this VY coordinate and then moves in the +Z and −Z directions until sensor 146-3 again detects the two edges of disk 126 ID (inner diameter). The average of these two Z coordinates represents the Z coordinate of sensor 146-3 and is VZ. Thus, the coordinate VY, VZ is the true location of the center of sensor 146-3.

As an accuracy check, each of the four detection locations detected above should all be the distance (ID-BD)/2 from location VY, VZ. (BD here is a beam diameter for sensor 146-3 as shown in FIG. 39.) The process can be repeated if desired to improve the precision of the measurement VY, VZ.

Execution proceeds to step 2922 wherein the origin of the X axis of sensor 122-1 in gripper 122 is determined. This is the distance from robot quill 120 to sensor 122-1.

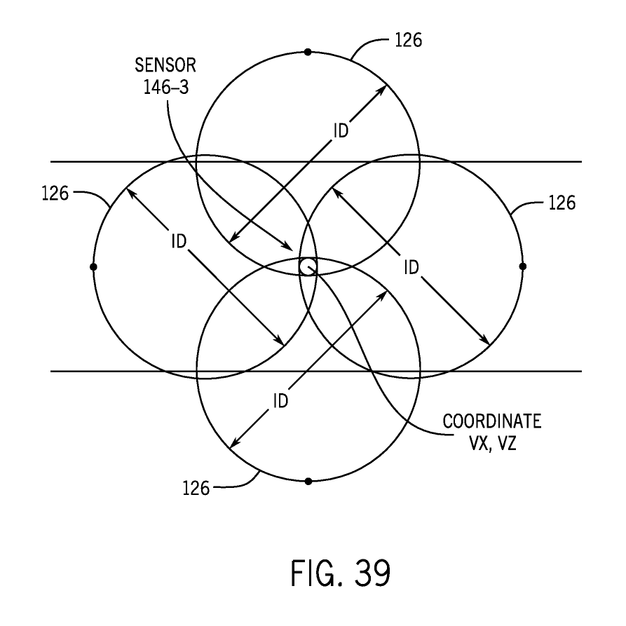

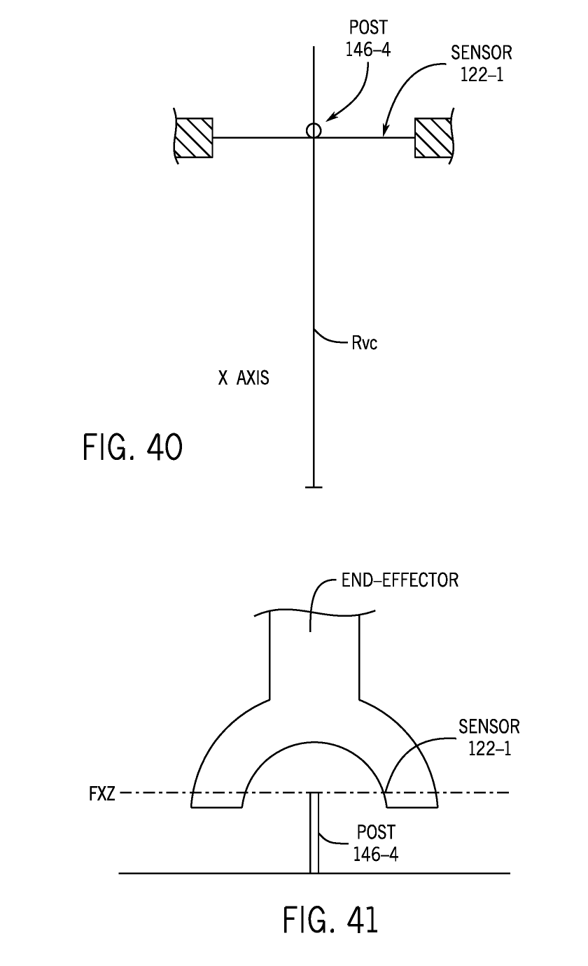

FIG. 40 depicts an idealized schematic of a portion of a plan view of horizontal fixed reference frame 146 in FIG. 30. Sensor 122-1 (in gripper 122) is in the pitch-down position, just detecting post 146-4 along the X axis. The distance along the X axis from post 146-4 to sensor 146-3 is known and is Rvc. Using the X coordinate recorded at the end of step 2916, the precise detection point of the sensor in gripper 122 relative to disk 126 held in gripper 122 is now known, as is the origin of the X axis for disk 126 in the vertical down position.

Execution proceeds to step 2924 wherein the origin of the Z axis of sensor 122-1 in gripper 122 is determined. This establishes the distance in the Z axis from sensor 122-1 to the center of disk 126 in the vertical down position.

FIG. 41 depicts an idealized schematic of a portion of a side view of horizontal fixed reference frame 146 in FIG. 30. Specifically, FIG. 41 shows a face view of gripper 122 with its embedded sensor 122-1 in the pitch down position. Robot unit 110 moves to above post 146-4 and moves down until sensor 122-1 just detects the top of post 146-4. This establishes the origin of the Z axis of reference frame 146 for the sensor in gripper 122.

Execution proceeds to step 2926 which establishes the end effector 112 and gripper 122 calibrations and reference frame coordinates for disk 126 in the pitch down position for reverse pick and place operations.

Frequently pick and place operations for disk 126 in the vertical down position must be performed at a roll orientation of 180 degrees from the normal pick and place operations. These are called reverse points. Separate calibrations and coordinates must be established for these operations. To do this, steps 2914 through 2924 are repeated, but with the end effector is rotated 180 degrees around the Z axis.

This completes all of the calibrations and reference frame coordinates for end effector 112 and gripper 122.

Execution proceeds to step 2812 (in FIG. 28B and shown also in FIG. 29C in this discussion) where it is determined if there is a second gripper 124 on end effector 112. If the answer is yes execution proceeds to step 2928 as described below. If there is not a second gripper 124, then execution proceeds to step 2824.

Steps 2928 and 2930 correspond to step 2814 in FIG. 28B. As indicated, execution proceeds to step 2928 wherein the orientation of the roll axis for gripper 124 in the horizontal position is established. Here, step 2900 is repeated, but for gripper 124.

Execution proceeds to step 2930 where the orientation of the pitch axis for gripper 124 is established. Here, step 2902 is repeated, but for gripper 124.

Execution proceeds to step 2932 where the location of gripper 124 is determined in the horizontal position. (Steps 2932 and 2934 correspond to step 2816 in FIG. 28B.)

Execution proceeds to step 2932 wherein the precise orientation of the Z axis for gripper 124 is established. Here, step 2904 is repeated but for gripper 124.

Execution proceeds to step 2934 where the precise orientation of the yaw axis of gripper 124 is established for gripper 124 in the horizontal position. Here, step 2906 is repeated, but for gripper 124.

Steps 2936 and 2938 correspond to step 2818 in FIG. 28B.

Execution proceeds to step 2936 wherein the distance from the center of robot quill 120 to the center of disk 126 in gripper 124 (in horizontal position) is established. Here, step 2910 is repeated, but for gripper 124.

Execution proceeds to step 2938 wherein the origin of the X and Y coordinates for disk 126 in gripper 124 are established. Here, step 2912 is repeated, but for gripper 124.

Execution proceeds to step 2940. Steps 2940 and 2942 correspond to step 2820 in FIG. 28B.

Execution proceeds to step 2940 which establishes the precise orientation of the yaw axis of gripper 124 in the pitch down position. Here, step 2914 is repeated, but for gripper 124.

Execution proceeds to step 2942 wherein the precise orientation of the pitch axis of gripper 124 in the pitch down position is established. Here, step 2916 is repeated, but for gripper 124.

Execution proceeds to step 2944. Where the center of disk 126 in gripper 124 in the pitch down position is established. Here, steps 2918 through 2926 are repeated, but for gripper 124.

Execution proceeds to step 2946. Step 2946 corresponds to step 2824 in FIG. 28B. All calibrations and coordinates with respect to reference frame 146 have been completed for end effector 112 and grippers 122 and 124 in both the horizontal and pitch down positions and the complete transformation map of these calibrations and coordinates is created and stored in computer system 104. Establishing a transform map relating the end effector 112 calibrations and reference frame 146 can make the process of teaching the various working points in the workcell simpler and faster. Depending on the tolerances required, it is often possible to teach one set of working points for gripper 122 of end effector 112 and using the relative transform map to compute the working points for the other gripper 124.

As described above, steps 2826 through 2840 are executed when there are working points that must be taught. In steps 2826 through 2830 each of the horizontal working points 130 are taught in workcell 102. In step 2832 through 2838, each of the vertical working points 144 are taught in workcell 102.

FIG. 42 depicts a perspective view of a typical test machine in a workcell. It shows spindle 130 and three posts 132-1, 132-2 and 132-3, where the line connecting posts 132-1 and 132-3 is at right angles to the line connecting posts 132-1 and 132-2. In this embodiment, the horizontal working point is spindle 130 on a test machine. All of the posts are in known locations relative to spindle 130. Based on the engineering design of the workcell, the expected positions and angles of spindle 130 and posts are known.

Execution proceeds to step 2826. If there is a horizontal working point to be taught execution proceeds to step 2828. Steps 2948 through 2956 correspond to step 2828 in FIG. 28C. If there are no horizontal working points to teach, then execution proceeds to step 2832.

Execution proceeds to step 2948 wherein the orientation of the local X and Y axes of the horizontal working point 130 is established.

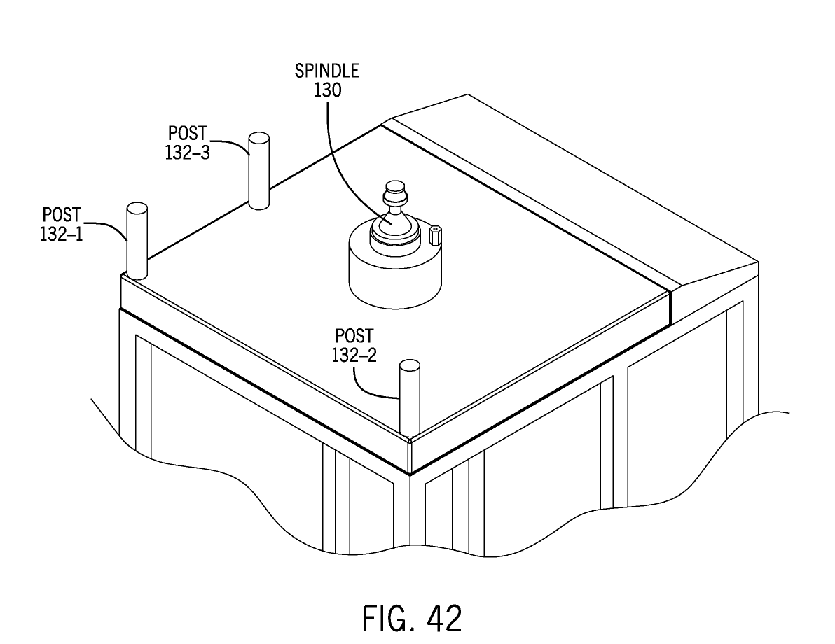

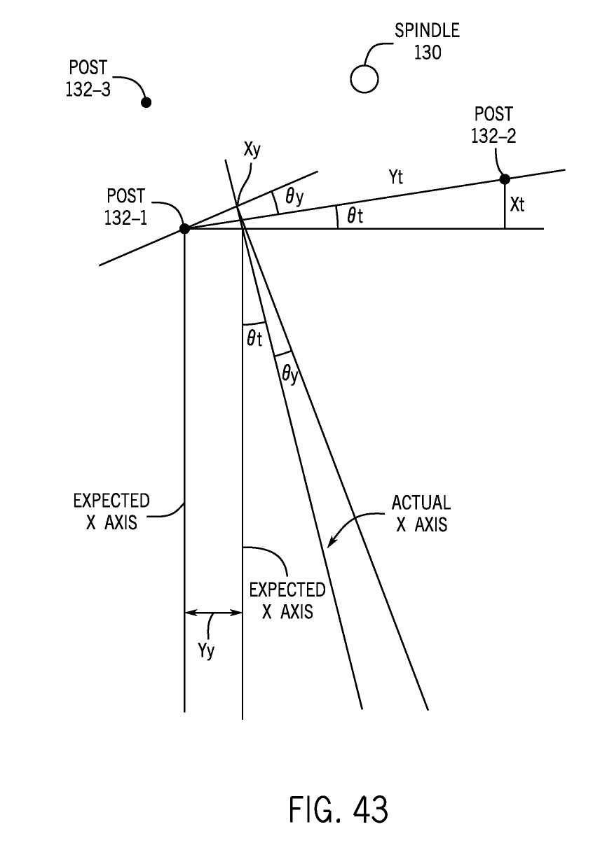

FIG. 43 depicts a plan view of the test machine in FIG. 42. With end effector 112 aligned to the expected X axis, robot unit 110 moves to the left side of the figure and moves in the expected X axis until post 132-1 is just detected by sensor 122-1 in gripper 122. Robot unit 110 moves a precise distance Yt along the expected Y axis. Yt is the precise distance between post 132-1 and 132-2. Robot unit 110 then moves along the expected X axis until 132-2 is just detected by sensor 122-1.

The angle θt is determined by the equation tan(θt)=Xt/Yt.

Robot unit 110 now knows the true directions of the local X and Y axes of the test device and the true roll angle of end effector 112 and gripper 122 to align it precisely along the local X axis.

Execution proceeds to step 2950 wherein the actual Y coordinate of the local horizontal working point 130 is established.

FIG. 43 also depicts the detection of the post 132-1 but with end effector 112 and gripper 122 rotated by an angle θy relative to the local X axis. Robot unit 110 moves along the local X axis until post 132-1 is just detected by sensor 122-1. If the center of sensor 122 is exactly at post 132-1, the X coordinate from this measurement would exactly equal that obtained in step 2948.

If there is a deviation in Y, then its magnitude Yy is determined by the equation Yy=Xy/sin(θy) where Xy is the deviation from the expected X coordinate.

Execution proceeds to step 2952 wherein the deviation (angle θzy) of the Z axis along the local Y axis of the horizontal working point is established.

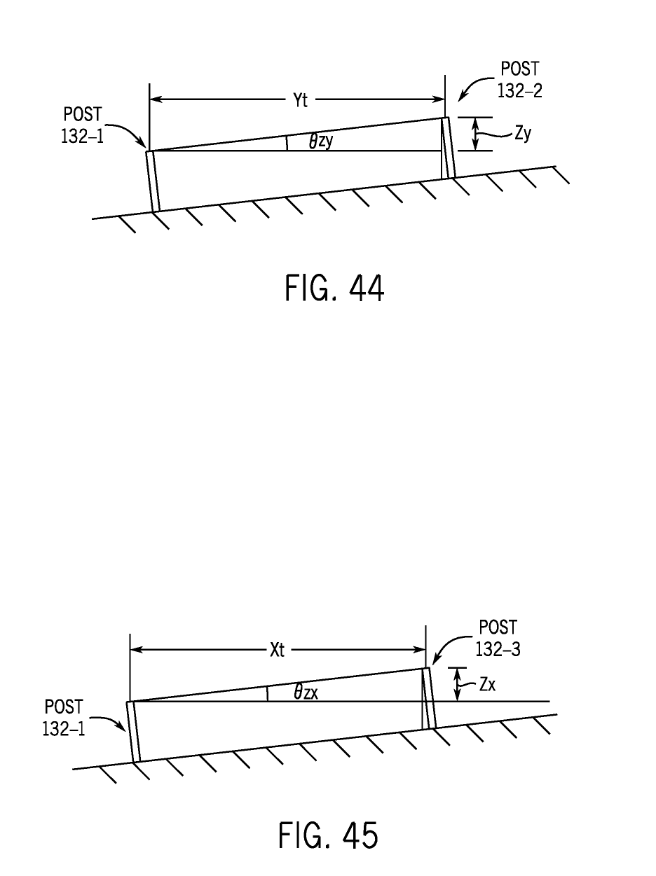

Reference is made to FIG. 44 wherein a front view of the test machine in FIG. 42 is shown. Robot unit 110 moves above post 132-1 and moves down until sensor 122-1 just detects the top of post 132-1. Robot unit 110 then moves above post 132-2 and down until sensor 122-1 again detects the top of post 132-3. The difference in these coordinates, Zy, determines the deviation (as an angular orientation) of the test machine from horizontal along the line connecting post 132-1 and post 132-2. That angle is determined by the equation tan(θzy)=Zy/Yt.

Execution proceeds to step 2954 wherein the deviation (angle θzx) of the Z axis along the local X axis of the horizontal working point is established.

Reference is made to FIG. 45 wherein a side view of the test machine of FIG. 42 is also shown. The Z coordinate of post 132-1 was obtained in step 2952. Robot unit 110 moves to post 132-3 and moves in the Z axis until the top of post 132-3 is just detected. The distance between post 132-1 and post 132-3 is known and is Xt.

The difference between the Z coordinates at post 132-1 and 132-3 is Zx. Angle θzx is determined by the equation tan(θzx)=Zx/Xt.

Execution proceeds to step 2956 wherein it is determined if the location and orientation of the local axes and angles are within specification.

The measured values X, Y, Z, et, θzx and θzy are displayed to the technician. If any of these exceeds the allowed tolerances, then the technician is directed to adjust the test machine accordingly and steps 2948 through 2956 are repeated until the test machine is within allowed tolerances.

Steps 2948 through 2956 are typically only performed when a test machine is first placed, moved or replaced within a workcell.

Execution proceeds to step 2830 (in FIG. 28C) wherein the actual horizontal working point is taught. Steps 2958 through 2966 correspond to step 2830 in FIG. 28C.

Execution proceeds to step 2958 wherein the actual X coordinate of the center of spindle 130 is determined for the horizontal working point.

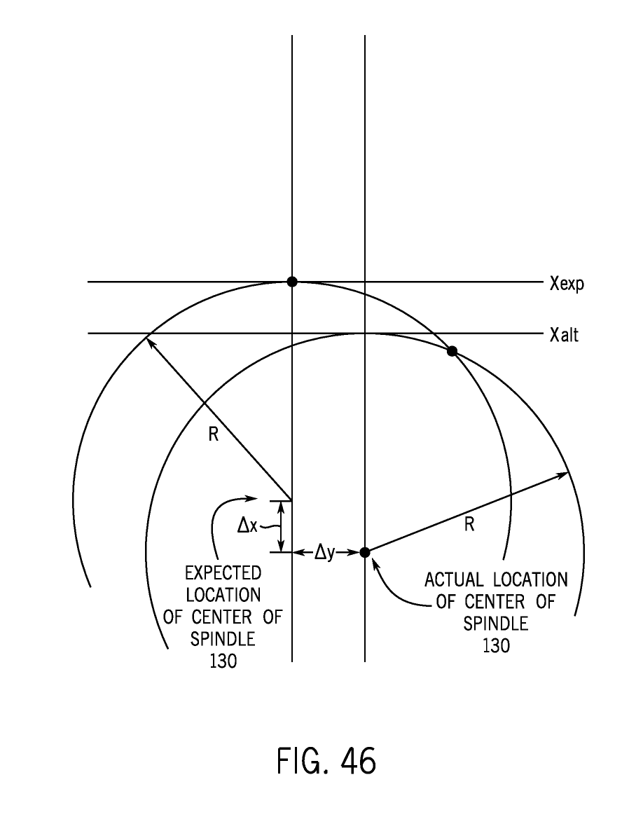

FIG. 46 depicts a plan view of spindle 130 on a test machine with an empty gripper 122 aligned to the expected position and angle of approach to spindle 130. In this depiction gripper 122 is shown at some unknown offset in the Y axis to the center of spindle 130. Robot unit 110 moves along the angle of approach until sensor 122-1 just detects spindle 130. This coordinate, adjusted for the known diameter of spindle 130 and the known distance between sensor 122-1 and robot quill 120 is the X coordinate of the center of spindle 130.

Execution proceeds to step 2960 wherein the actual Y coordinate of the center of spindle 130 (horizontal working point 130) is determined for the horizontal working point.

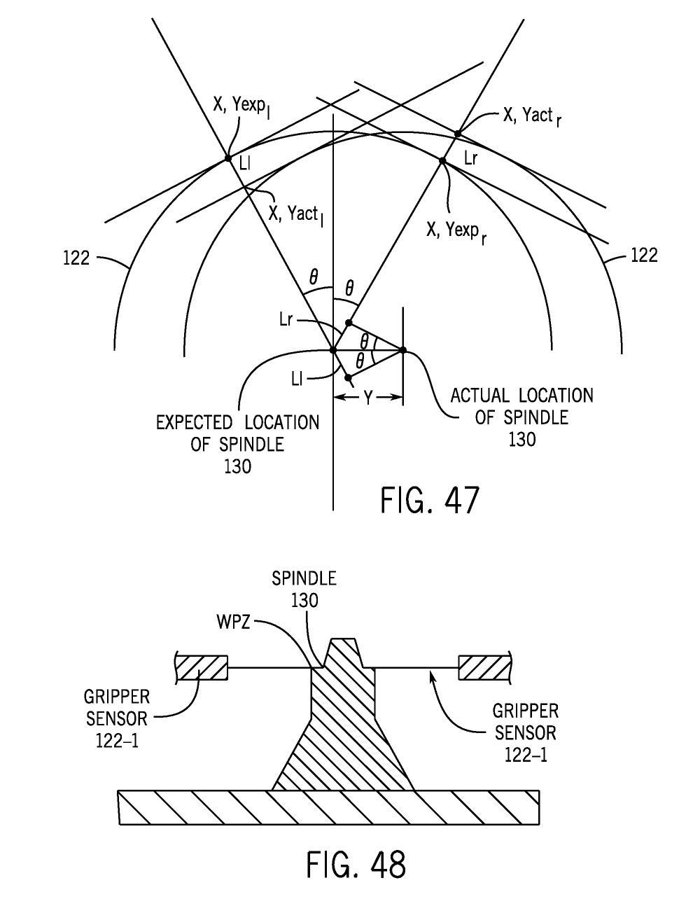

FIG. 47 is a plan view of spindle 130 with an empty gripper 122 (edge) shown in three positions, one directly along the X axis of spindle 130 and one each rotated about the expected center of spindle 130 by known amounts of +θ and −θ. At each of the rotated positions, robot unit 110 approaches spindle 130 along the rotated axis until sensor 122-1 just detects spindle 130. Coming from the right side direction, the distance between the expected point (X, Yexpₗ or X, Yexᵣ) of detection and the actual point (X, Yactₗ or X, Yactᵣ) of detection is Lr. Coming from the left side, this difference is Ll.

As seen in the figure, the Y offset of spindle 130 can be calculated from the formula Y=Lr/sin(θ)=Ll/sin(θ).

Execution proceeds to step 2962 wherein the Z coordinate of spindle 130 (horizontal working point) is determined for the horizontal working point.

FIG. 48 depicts a cross sectional side view of spindle 130 with an empty gripper 122. Robot unit 110 moves above the shoulder of spindle 130 and then moves in the Z direction until the shoulder of spindle 130 is just detected by gripper sensor 122-1. This represents the Z coordinate of the horizontal working point (WPZ).

Execution proceeds to step 2964 wherein all coordinates for gripper 124 are verified for the horizontal working point (frame 146).

Since end effector 112 calibrations have been precisely determined in steps 2814 through 2818, this step is optional. However, steps 2958 through 2964 can be repeated if desired for disk 126 in the other gripper 124.

Execution proceeds to step 2966 wherein all of the coordinates and offsets of the horizontal working point are stored. This completes the determination of the horizontal working point. All coordinates, offsets and adjustments relative to reference horizontal reference frame 146 are stored.

Execution returns to step 2826 wherein it is determined if there are any additional horizontal working points to teach. If there are, execution proceeds to step 2828. If there are no additional horizontal working points to teach execution proceeds to step 2832 wherein it is determined if there are any vertical working points to be determined. If there are, execution proceeds to step 2834. If there are no vertical working points to be taught, execution proceeds to step 2840.

Steps 2968 through 2976 correspond to step 2834 in FIG. 28D.

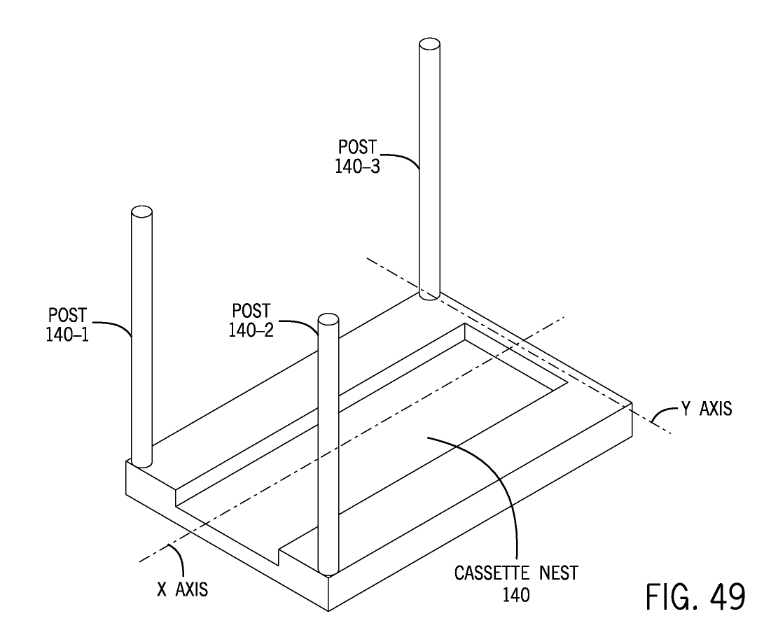

FIG. 49 depicts a typical (empty) cassette nest 140 in workcell 102. In this embodiment, the cassette (fixture) incorporates three vertical posts 140-1, 140-2 and 140-3 (similar to posts 144-1, 144-2 and 144-3 for working points 144 in FIG. 27).

A process similar to steps 2914 through 2926 is performed with the exception that no mechanical adjustments to end effector 112 and gripper 122 are made. If it is determined that any of the values of the coordinates for the vertical working point exceed the allowed tolerances a human is alerted and advised to adjust the cassette nest 144.

Execution proceeds to step 2968 wherein the precise orientation of the X, Y and roll axes of cassette nest 140 are determined (established).

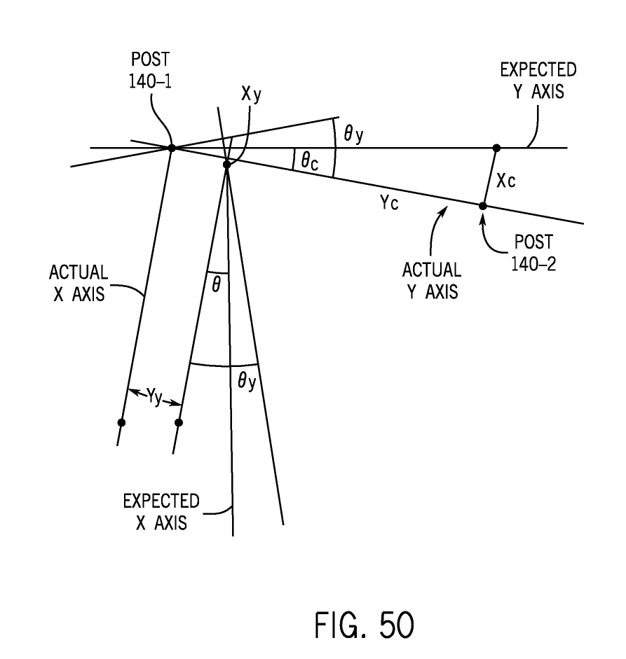

Reference is made to FIG. 50 wherein a plan perspective view of cassette nest 140 in FIG. 49 is depicted. With end effector 112 and gripper 122 aligned to the expected X axis, robot unit 110 moves to the left side of the figure and moves along the expected X axis until post 140-1 is just detected by the sensor in end effector 112. Robot unit 110 moves a precise distance Yc along the expected Y axis. Yc is the precise distance between post 140-1 and post 140-2. Robot unit 110 then moves along the expected X axis until post 140-2 is just detected.

The angle θc is determined by the equation tan(θc)=Xc/Yc.

Robot unit 110 now knows the true directions of the working X and Y axes of the vertical working point for cassette nest 140 and the true roll angle of gripper 122 to align it precisely along the actual X axis. It also knows the actual X coordinate of the vertical working point.

Execution proceeds to step 2970 wherein the Y coordinate of the vertical working point is established.

FIG. 50 also depicts the detection of the post 140-1 but with gripper 122 rotated by an angle θy relative to the actual X axis. Robot unit 110 moves along the X axis until post 140-1 is just detected. If the center of the sensor in gripper 122 is exactly at post 140-1, the X coordinate from this measurement would exactly equal that obtained in step 2968.

If there is a deviation in Y, then its magnitude Yy is determined by the equation Yy=Xy/sin(θy) where Xy is the deviation from the expected X coordinate.

Execution proceeds to step 2972 wherein the deviation of the Z axis along the local Y axis of the vertical working point is established.

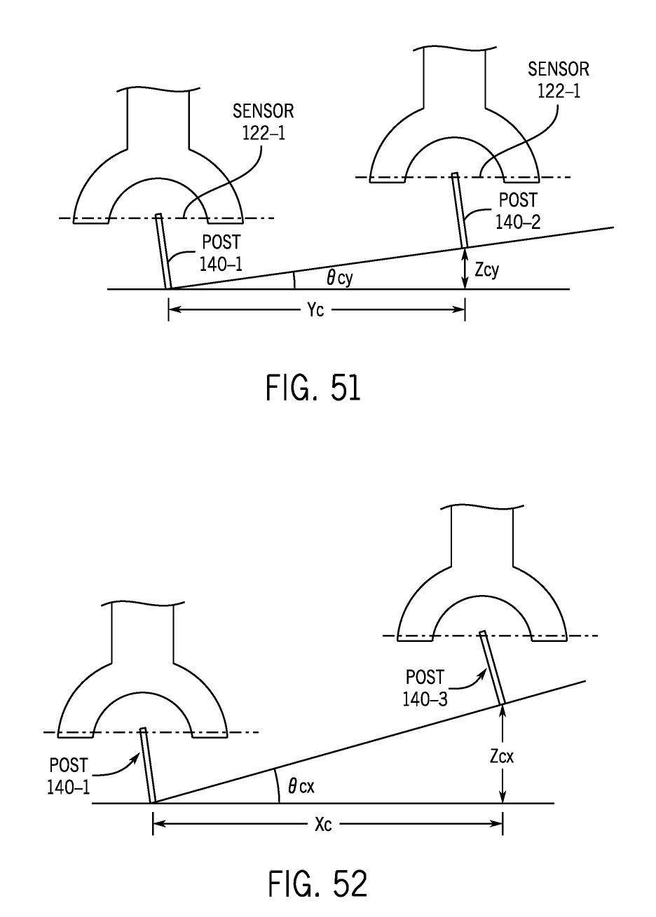

Reference is made to FIG. 51 wherein a front view of cassette nest 140 of FIG. 49 is depicted. Robot unit 110 moves above post 140-1 and moves down until sensor 122-1 just detects the top of the post. Robot unit 110 then moves above post 140-2 and down until sensor 122-1 again detects the top of the post. The difference in these coordinates, Zcy, determines the deviation of the cassette nest from horizontal along the Y axis.

That angle is determined by the equation tan(θcy)=Zcy/Yc.

Execution proceeds to step 2974 wherein the deviation of the Z axis along the local X axis of the vertical working point is established.

Reference is made to FIG. 52 wherein a side view of cassette nest 140 in FIG. 49 is depicted. The Z coordinate of post 140-1 was obtained in step 2972. Robot unit 110 moves to post 140-3 and moves in the Z axis until the top of the post is just detected. The difference the Z coordinates at post 140-1 and 140-3 is Zcx.

Angle θcx is determined by the equation tan(θcx)=Zcx/Xc.

Execution proceeds to step 2976 wherein it is determined if the location and orientation of cassette nest 140 are within specification.

The measured values X, Y, Z, θc, θcx and θcy are displayed to the technician. If any of these exceeds the allowed tolerances, then the technician is directed to adjust the test machine accordingly and steps 2968 through 2976 are repeated until the test machine is within allowed tolerances.

Execution proceeds to step 2836 wherein the locations and orientations of the vertical working point at cassette nest 140 are determined for reverse pick and place operations.

Since end effector 112 calibrations have been precisely determined in steps 2814 through 2822, this step is optional. However, steps 2968 through 2976 can be repeated if desired for disk 126 rotated by 180 degrees.

Execution proceeds to step 2838 wherein the locations and orientations of the vertical working point at cassette nest 144 are determined for gripper 124.

Since end effector 112 calibrations have been precisely determined in steps 2820 and 2822, this step is optional. However, steps 2834 through 2836 can be repeated if desired for disk 126 in gripper 124.

Execution returns to step 2832 (FIG. 28D) wherein it is determined if there are any additional vertical working points to teach. If there are then execution proceeds to step 2834. If there are not, then execution proceeds to step 2840 wherein the complete working point transformation map associating each of the working points in the workcell to the end effector 112 calibrations and coordinates in reference frame are established.

Once a complete workcell 102 setup has been completed and the working point transformational map is established, it is then possible to abbreviate the point teaching process that may be needed should an equipment replacement or equipment wear occur.

As indicated above, steps 2842-2848 in FIG. 28E are executed. In brief, one or more working points are updated if they have changed.

Step 2842 determines if an adjustment is required because one or more working points have changed. If so, execution proceeds to step 2844 for the particular working point or points affected.

Execution then proceeds to step 2840 wherein the complete working point transformation map associating each of the working points in the workcell to the end effector 112 calibrations and coordinates in reference frame (both horizontal and vertical coordinates) is updated.

Execution proceeds to step 2846 wherein it is determined if a change to robot unit 110 or end effector 112 has occurred. If so, the precise effect of the change is determined by executing step 2848 and then comparing the new end effector 112 calibrations and reference frame coordinates to the previous ones. The differences can then be used to calculate the appropriate changes to all affected working points without having to re-teach those working points.

Execution again returns to step 2840 wherein the complete working point transformation map associating each of the working points in the workcell to the end effector 112 calibrations and coordinates in reference frame is updated.

It is to be understood that the disclosure teaches examples of the illustrative embodiments and that many variations of the invention can easily be devised by those skilled in the art after reading this disclosure and that the scope of the present invention is to be determined by the claims below.

What is claimed is:

1. A system for autonomously teaching one or more working points in an apparatus configured to process disks during manufacture, the apparatus including an end effector with a gripper for holding a disk and a robotic unit configured to move the end effector between working points throughout the apparatus, the system comprising one or more servers configured to execute method steps, the method steps comprising:
leveling the gripper in a first position with respect to a first fixture;
determining a location of the gripper in the first position; and
determining a location of a center of the disk in the first position with respect to the first fixture.

2. The system of claim 1 wherein the steps further comprising:
leveling the gripper in a second position with respect to a second fixture;
determining a location of the gripper in the second position; and
determining a center of the disk in the second position with respect to the second fixture.

3. The system of claim 1 wherein leveling the gripper includes establishing an orientation of one or more axes of the gripper in the first position.

4. The system of claim 3 wherein leveling the gripper includes establishing an origin of the one or more axes of the first fixture in the first position.

5. The system of claim 1 wherein determining the location of the gripper includes discovering X, Y, and Z axes of the gripper in the first position.

6. The system of claim 1 wherein determining the center of the disk includes identifying coordinates of the first fixture with respect to the disk in the first position.

7. The system of claim 6 wherein the steps further comprising creating transformations that map coordinates of the robot unit with the coordinates of first fixture relative to the gripper.

8. The system of claim 1 wherein the first position is the horizontal position.

9. The system of claim 2 wherein the first position is the vertical position.

10. The system of claim 7 wherein the steps further comprising establishing a coordinate transformation map associating the first fixture and locations of the working points.

11. The system of claim 2 wherein the first fixture and second fixture are a horizontal working frame and a vertical working frame respectively.

12. The system of claim 2 wherein the first fixture and second fixture are a vertical working frame and a horizontal working frame respectively.

13. A system for autonomously teaching one or more working points in an apparatus configured to process disks during manufacture, the apparatus including an end effector with a first gripper for holding a disk and a robotic unit configured to move the end effector between working points, the system comprising one or more servers comprising one or more processors and memory coupled to the one or more processors, the memory storing computer executable instructions to be executed by the one or more processors to cause the apparatus to:
level the gripper in a first position with respect to a first fixture;
move the gripper to a plurality of positions with respect to the first fixture;
sense the gripper at the plurality of positions to determine one or more orientations of the disk with respect to the first fixture; and
sense the disk at the plurality of positions to determine a center of the disk.

14. The system of claim 13 wherein the memory storing computer executable instructions to be executed by the one or more processors to cause the apparatus to further:
level the gripper to a second position with respect to a second fixture;
move the gripper to a plurality of positions with respect to a second fixture;
sense the gripper at the plurality of positions to determine an orientation of the disk with respect to the second fixture; and
sense the disk at the plurality of positions to determine a center of the disk.

15. The system of claim 13 wherein level the gripper includes establish an origin of the one or more axes of the gripper.

16. The system of claim 13 wherein the memory storing computer executable instructions to be executed by the one or more processors to further cause the apparatus to:
determine the location of the gripper includes identifying X, Y, and Z axes of the gripper in the first position.

17. The system of claim 13 wherein the memory storing computer executable instructions to be executed by the one or more processors to further cause the apparatus to:
determine the center of the disk center includes identifying coordinates of the first fixture with respect to the disk.

18. The system of claim 17 the memory storing computer executable instructions to be executed by the one or more processors to further cause the apparatus to:
create transformations that map coordinates of the robot unit with the coordinates of first fixture relative to the gripper.

19. The system of claim 13 wherein the first position is a horizontal position.

20. The system of claim 13 wherein the first position is a vertical position.

21. The system of claim 18 wherein the memory storing computer executable instructions to be executed by the one or more processors to further cause the apparatus to:
establishing a coordinate transformation map associating the first fixture and locations of the working points.

22. A method for autonomously teaching one or more working points in an apparatus configured to process disks during manufacture, the apparatus including an end effector with a first gripper for holding a disk and a robotic unit configured to move the end effector between working points, the method comprising the steps of:
leveling the gripper to a first position with respect to a first fixture;
moving the gripper to a plurality of positions with respect to the first fixture;
sensing the gripper at the plurality of positions to determine one or more orientations of the disk with respect to the first fixture; and
sensing the disk at the plurality of positions to determine a center of the disk.

23. A system for autonomously teaching one or more working points in an apparatus configured to process a disk during manufacture, the apparatus comprising:
(a) first and second working points upon which the disk may be tested or stored:
(b) an end effector with a gripper for holding a disk and a robotic unit configured to move the end effector between the first and second working points;
(c) a fixture mounted to the third working point and including a plurality of posts; and
(d) a plurality of sensors supported by the plurality of posts, the plurality of sensors configured to sense the location of the disk with respect to the fixture as the disk moves with the gripper.

24. The system of claim 23 wherein the fixture has a first wall and a second wall that that extends perpendicular with respect to the first wall.

25. The system of claim 24 where the first wall includes a hole through which a spindle may protrude.

26. A fixture for use in calibrating a location of disk as it is moved between working points within an apparatus for testing or storing the disk during manufacture, the apparatus including an end effector and gripper supported by the end effector for holding the disk as it is moved between the working points, the fixture comprising:
a first wall fixed to a working point within the apparatus, the first wall including a plurality of posts;
a plurality of sensors supported by the plurality of posts, the plurality of sensors configured to sense the disk in a plurality of positions with respect to the first wall to establish a location of the disk with respect to the first wall.

27. The fixture of claim 26 further comprising a second and third wall extending perpendicularly along the edges of the first wall.

28. The fixture of claim 26 wherein the first wall includes an opening through which a spindle for supporting the disk may extend.

29. The fixture of claim 28 wherein the plurality of sensors includes a sensor positioned adjacent the opening.

30. A fixture for use in calibrating a location of disk as it is moved between working points within an apparatus for testing or storing the disk during manufacture, the apparatus including an end effector and gripper supported by the end effector for holding the disk as it is moved between the working points, the fixture comprising:
a first wall fixed to a working point within the apparatus, the first wall configured to sense the disk in a plurality of positions with respect to the first wall to establish a location of the disk with respect to the first wall.

31. A method for autonomously teaching one or more working points in an apparatus configured to process disks during manufacture, the apparatus including an end effector with a gripper for holding a disk and a robotic unit configured to move the end effector between working points, the method comprising the steps of:
moving the gripper to a plurality of positions with respect to a fixture;
sensing a location of the gripper at the plurality of positions to determine one or more orientations of the gripper with respect to the fixture; and
calibrating the location of the gripper with respect to the fixture based on orientations of the gripper with respect to the fixture.

32. The method of claim 31 wherein the fixture is a horizontal reference frame.

33. The method of claim 31 where the fixture is a vertical reference frame.
